(19) United States
(12) Patent Application Publication
(10) Pub. No.: US 2009/0234710 A1
(43) Pub. Date: Sep. 17, 2009

(54) CUSTOMER CENTRIC REVENUE MANAGEMENT

(76) Inventors: Asma Belgaied Hassine, Paris (FR); Daniel Rueda, Paris (FR)

Correspondence Address: FULBRIGHT & JAWORSKI, LLP, 666 FIFTH AVE, NEW YORK, NY, 10103-3198, US

(21) Appl. No.: 12/309,516

(22) PCT Filed: Jul. 17, 2007
(86) PCT No.: PCT/IB2007/055359

§ 371 Date: Jan. 20, 2009

Related U.S. Application Data
(60) Provisional application No. 60/831,373, filed on Jul. 17, 2006.

(51) Int. Cl. G06Q 10/00; G06Q 30/00; G06F 17/30

(52) U.S. Cl. 705/10; 707/104.1; 707/E17.044

(57) ABSTRACT

CCRM is a business method and computer software system, to be used by Enterprises selling portfolios of products/services, aiming to optimize the expected value of transactions (or contracts) with consumers or business customers. At a transaction level, CCRM estimates the probability of choice of potential offers by the customer. These offers may be presented alone with possible variation of their attributes (such as price), or in combinations/sets, or in sequences. CCRM calculates the probability of consequent conversion and realization of the sale. Probabilities of choice and conversion are forecasted based on a disaggregated customer choice model, taking into account customer characteristics and stated preferences as well as product/service attributes such as price. Offers are then scored and ranked by expected value based on their revenue, cost and choice probability. Finally, CCRM recommends which offer(s) to present to the customer, at which price(s) and in which display/sequence order, to maximize a business objective function such as the expected value of the transaction/contract.

### REFERENCES

### U.S. Patent Documents

[P1] System and Method for Estimating User Ratings from User Behavior and Providing Recommendations. Patent no. US 2006/0041548 A1. Date: Feb. 23, 2006. Assignee: Bereskin and Parr, Toronto, ON (CA)
[P2] Target Pricing System. U.S. Pat. No. 6,963,854 B1. Date: Nov. 8, 2005. Assignee: Manugistics, Inc., Rockville, Md. (US).

### International Patent Documents

[P3] Statistical Personalized Recommendation System. Patent no. WO 2004/017178 A2. Date: Feb. 26, 2004. Assignee: ChoiceStream, Cambridge Mass. (US)

### Other Documents

[R1] S. E Andersson. Passenger Choice Analysis for Seat Capacity Control: A Pilot Project in Scandinavian Airlines. International Transaction in Operational Research, 5: 471-486, 1998.
[R2] M. Ben-Akiva and M. Bierlaire. Discrete choice methods and their applications to short-term travel decisions. In Handbook of Transportation Science, pages 5-33. Kluwer Academic Publishers, USA, r.w. hall (ed.) edition, 1999.
[R3] M. Ben-Akiva and S. R. Lerman. Discret Choice Analysis: Theory and Application to Travel Demand. The MIT Press, Cambridge, Mass., 1985.
[R4] T. Gorin, Revenue Benefits of Sell-up Models, Reservations and Yield Management Study Group annual Meeting Proceedings, New York, 2000 AGIFORS.
[R5] J. Hausman and D. McFadden, 1984, Specification Tests for the Multinomial Logit Model, Econometrica, Vol. 52, No. 5, pp. 1219-1240.
[R6] D. McFadden and K. Train and W. Tye, 1976, An Application of Diagnostic Tests for the Independence from Irrelevant Alternatives Property of the Multinomial Logit Model, Transportation Research Record, No. 637, pp. 39-45.
[R7] T. Nagle, R. Holden. The Strategy and Tactics of Pricing. Prentice Hall (1995)
[R8] K. T Talluri and G. J van Ryzin. Revenue Management under a general discrete choice model of consumer behavior. Management Science, January 2004.
[R9] K. T Talluri and G. J van Ryzin. The Theory and Practice of Revenue Management. Springer, 2005.
[R10] W3C Recommendation. Mathematical Markup Language (MathML) Version 2.0 (Second Edition). 21 Oct. 2003. Link: http://www.w3.org/TR/MathML2/

### DRAWINGS

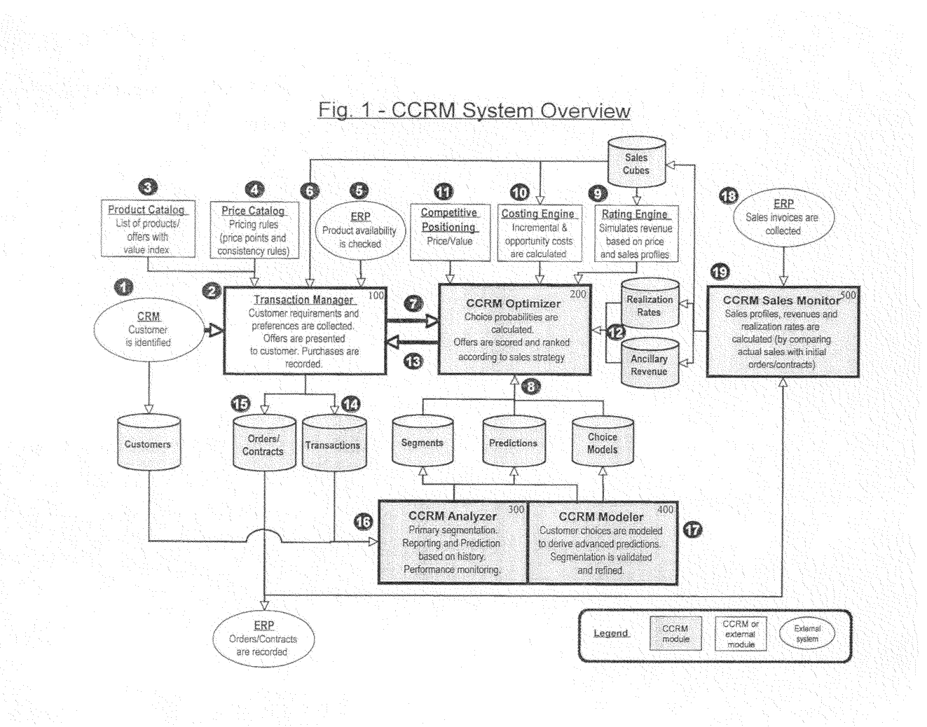

The drawings (FIGS. 1 to 7 herewith enclosed) illustrate important features of the invention.

### DESCRIPTION

### Field of the Invention

This invention relates to a computer software system and business method referred to as “Customer Centric Revenue Management” (CCRM) meant to optimize the commercial offers of Enterprises selling portfolios of products and services, on a customer by customer and transaction by transaction basis. CCRM recommends for a particular customer and a list of eligible products, the right product(s) with the right attribute(s) (such as price) able to maximize a predefined objective function (expected profit, expected revenue, conversion probability . . . ).

CCRM enables to optimize the sale of a large set of products and services in different business environments, including:
B2B recurring contracts in industries such as Transport & Logistics, Utilities, Telecoms, Travel & Tourism, Advertising & Media and Industrial Services.
B2C or B2B “spot” transactions in industries such as: e-Retail, Travel & Tourism, Transport & Logistics, Bank and Insurance.

CCRM enables to optimize sale transactions through different channels:
e-Retail or other media of electronic distribution such as Global Distribution Systems (GDS) which are used by travel agents to sell the offers of travel providers,
Call centers and Telesales,
Sales Field: direct face-to-face negotiations between Enterprise representatives or partners and the customers or their purchasing agents.

CCRM requires that the sale process be assisted by an electronic system permitting to collect and process (1) customer characteristics, stated preferences and order profiles; (2) the sequence of offers proposed/quoted to the customer and (3) the outcome of the transaction: offer selected (if any) or “loss” (no choice).

### BACKGROUND OF THE INVENTION

Enterprises consider three elements when defining and pricing their commercial offers: (1) costs, (2) competition and (3) customer value/preferences.
Costs. Many enterprises focus on costs when pricing their products and services. They calculate their incremental/variable cost (i.e. the cost occurring when an additional unit of product is sold) and then define the “contribution margin” which shall be added on top of the incremental cost in order to cover fixed costs and generate a profit.

To reflect local market conditions, the relative appeal of offers to different customer segments or the power of negotiation of key customers, different levels of contribution margin are often defined by market segment, thus leading to “differential pricing”.

However, incremental costs merely provide the “floor price” for the transaction, but do not indicate which price point above this bottom level is optimal. Indeed, the profit extracted from a sale increases in function of price, up to a point (the “optimal price”) where the increase in revenue generated by a higher price is offset by the decrease in the probability of closing the sale.
Competition. In practice many enterprises align their price with competition and consider that they have limited control on that variable that is “given by the market”. Even in sectors of application of differential pricing (such as airlines) the matching of competitive prices is often a basic strategy (for example airlines use competitive monitoring tools to that end).
Customer Value/Preferences. Enterprises also use Market Research for analyzing the value positioning of their offers versus competition and customers willingness to pay. Different methods permit to derive the “attractiveness” and “market response curves” for products and services attributes (including price). These methods may be based on interviews of a panel of customers: from simple ones (ref: Van Westendorp) to more complex ones (ref: Conjoint Analysis). However, Market Research techniques have important limitations: (1) they may be biased because they rely on declarative data and not on actual sales data, (2) they work well with a reduced set of products but do not provide guidance for pricing large sets of products or services, (3) their implementation cost is directly related to the number of respondents to the survey and for this reason they are only applicable to a reduced sample of customers (typically a couple of hundreds), which is not enough to take into account heterogeneity in preferences and choice behavior across thousands/millions of customers.

The precedent approaches do not capitalize on the knowledge of demand behavior that can be derived from the analysis of actual sales data. Moreover, they cannot take into account the change in buying behaviors that results from ever evolving market conditions. Hence a new approach known as “Revenue Management” (or “Yield Management”) has emerged in the last 20 years to assist Enterprises in optimizing their offers.

### 1—Revenue Management

Revenue Management is the process of periodically reviewing transactions for goods or services already supplied and to forecast future demand behavior in order to adjust prices and products/services availability at a market micro segment level.

The most advanced industry in the application of Revenue Management is the travel industry (airlines, hotels, car rentals, railways, tour-operators, cruise lines, travel agencies) that apply variations in price by season, day of week, reservation lead time and customer segment. In these industries capacity is constrained whereas demand is variable and may sometimes exceed capacity. In situations of capacity shortage and “constrained demand”, it is important to consider the “opportunity cost” of a sale, which reflects the loss of future revenue in case of anticipated capacity shortage. To give a simple example: if a hotel has only one room left available and the probability of renting this room in the future at a price of $100 is 80%, then the opportunity cost of selling this room today is $100*80%=$80 (also called the “bid-price”). A sale below this opportunity cost does not compensate for the expected displacement of future revenue and is not worth considering for the hotel. Opportunity costs must also be considered in other industries with limited capacity (such as Advertising or Industrial Services) or facing replenishment constraints.

[R9] provides a comprehensive description of the state-of-the-art of Revenue Management techniques. Key limitations of Revenue Management mentioned in this reference are:
The non-optimality of bid prices. In multi-product environments (example: competing airline flights or fare products), the bid-price does not provide a correct estimation of the opportunity cost. This leads in practice to applying sub-optimal (too restrictive) availability controls.
Cannibalization effects are not correctly estimated. In many cases it is interesting to restrict the availability of certain products in order to “up-sell”.

The precedent approaches, based on Costing, Competitive Prices, Market Research and traditional Revenue Management are “Product Centric”. Prices are set in order to maximize the profit generated at a product level, taking into account possible constraints of limited inventory. These methods view demand in aggregated terms (“how many customers will buy this product at this price”) but do not consider a customer's specific characteristics and stated preferences to calculate the acceptance (probability of choice) of a given offer at a given price by this customer and to derive the optimal offer(s) for this customer.

Moreover, when the Enterprise sells a portfolio of products (that indeed “compete” with each other for the sale), these methods do not provide guidance in defining the best offer set or offer sequence that will optimize profit for a given customer transaction.

[R8] provides a framework for the improvement of Revenue Management with consideration of a general discrete choice model of consumer behavior. However the proposed models are impractical due to computability issues.

The current invention provides an alternative and practical method to improve the use of the bid-price recommendations provided by a Revenue Management system by consideration of a substitution model based on Discrete Choice Analysis.

### 2—Personalization Systems

Enterprises have recently adopted “Customer Relationship Management” (CRM) systems that permit to identify customers and store related data such as address, demographics and history of interaction/sale. Enterprises have also implemented systems to help collect customer requests and preferences and present offers. These modules, that will be referred in this document as “Transaction Managers”, access the Product Catalog to retrieve offers matching customer requests and preferences. In many cases this search process could retrieve hundreds or even thousands of possible offers from the product catalog. Indeed, most Enterprises still propose offers to the customers with limited consideration of their characteristics and preferences and without implementing a systematic optimization process. In electronic distribution environments (e-Retail, GDS . . . ), usual responses to customer queries often consist in long lists of offers that the customer can order by basic attributes (for example price, product tier, departure time). These lists most of the times do not include indicators able to optimize the order of presentation of the offers to a given customer.

Transaction Management systems are sometimes complemented by “Personalization” modules that assist in selecting the right products matching customer preferences and likely to maximize sale conversion. These systems are useful to help the customer navigate within a rich product catalog and find quickly the products that match his preferences. For example they are used in e-Retail for “rich content” products such as books, music, electronic goods or products with many configuration possibilities and constraints (such as computers).

However in most cases, configuration systems are based on rules. They reduce complexity but do not propose an optimal offer for each customer.

Some personalization systems are based on choice analytics, but they only aim to find the product(s) that best match customer preferences and are able to maximize the conversion rate. They do not consider the economics of the transaction in terms of price, cost and expected profit for the Enterprise.

The two inventions [P1] and [P3] mentioned in reference are personalization systems of the previous type. They recommend items to the customer from an electronic store. They both use historical ratings made by the customer on the whole set of items or on a part of it, in order to recommend items with the highest rating to the customer. The rating represents the propensity to buy of the customer. In the two cases the rating methodologies are different but none of them takes into account the concepts of price elasticity, revenue generated by the sale, cost incurred and profit. Their domain of application is limited to rich content products such as music, games or books. They are not applicable in business environments with pricing flexibility. Limitations of these personalization strategies are the following: (1) they do not model customer behavior based on past transactions history but only consider stated preferences (items ranking), (2) they aim to maximize conversion probability and not expected profit.

Invention [P2] mentioned in reference was a first tentative to personalize pricing in order to optimize the expected profitability of a bid. The system permits to generate a “target price” at a product level (the product being a good or service) that maximizes the expected contribution to profit based on a market response model, a competitive model and a cost model. The market response model is based on historical win/loss data and uses the methodology of logistic regression. The output of the model is a probability of winning the bid depending on the price of the product. The domain of application of this invention is limited to negotiated transactions (bids) with a unique product and there is no way to apply it to transactions involving a portfolio of products. In the case of a customer having requirements or preferences that can be satisfied by a set of different offers/offer instances, this system only permits to evaluate the offers one by one. It does not take into account the substitution effects and cross-elasticity occurring when the customer has the choice among a set of possible offers.

### SUMMARY OF THE INVENTION

Customer Centric Revenue Management (CCRM) enables an Enterprise to optimize the transactions and contracts with consumers or business customers and more specifically, depending on its embodiment: (1) Find the right offer(s) for each customer within a portfolio of possible offers to be presented alone, in combinations/sets or in sequences; (2) Optimize contracts—notably in B2B but also in B2C environments—for which there are “negotiation variables” such as price, purchased quantities or order profiles; and (3) Optimize prices for a set of products with possible substitution effects in dynamic pricing environments.

CCRM is based on an holistic methodology that takes into account the following factors affecting the optimization of sales transactions and contracts:
Customer Characteristics,
Customer Requirements and Stated Preferences,
Transaction context (such as lead time, competitors . . . ),
Offers prices and products/services attributes,
Incremental costs to serve the customer,
Opportunity costs (in case of constrained inventories),
Substitution effects between products,
Realization rates,
Ancillary revenues.

Key aspects of the current invention are the following:
The collection and storage of large datasets of transaction data (customer level historical interactions and sales) to derive predictions/forecasts of choice probabilities by offer;
The application of Discrete Choice Analysis to these transaction datasets. CCRM capitalizes on Discrete Choice Analysis to generate a customer choice model for each sale transaction and derive choice probabilities for each possible offer. Discrete Choice Analysis is a methodology widely used for the analysis of individual choice behavior, initially developed by researchers in psychology. It has been extended to apply to choice problems in many fields, notably travel decisions and marketing research. It is very adequate for our problem because it is a disaggregated methodology used at the customer level;
The segmentation of customers according to their choice behavior: a procedure aimed to identify customer characteristics that have the highest influence on the observed choices;
A learning system: the outcome of past transactions and the test of new offers are systematically used to improve choice models and Enterprise offering overtime;
A real-time value based optimization (and not only a maximization of the conversion probability) with a performance and incentive indicator (the “Score”) for the sales staff and sales partners;
A method for the calculation of the opportunity cost taking into account substitution effects (recapture and buy-up), which improves the recommendations of traditional Revenue Management system in multiple products environments;
Rating and Costing procedures based on Sales Profiles and Sales Cubes, providing precise estimation of the anticipated Revenue, Cost and Profitability of a negotiated contract governing recurring sale orders.

This invention mainly consists in a computer based CCRM system for generating recommendations. CCRM uses data from the CRM and the ERP to optimize the sale process, customer by customer and transaction by transaction.

This invention also consists in a method for implementing a CCRM system, setting and improving CCRM processes and training Enterprise staff (CCRM Analyst and sales people) and distribution partners.

The implementation of a CCRM system typically involves the following steps:
a Gather and store transaction data (customer characteristics and preferences, context, offers presented, customer choices . . . ) for each customer interaction;
a Produce reports (such as historical exposure and choice rates by offer and customer segment) to help define predictions of choice probability for future transactions;
Adapt the Transaction Management system to be “CCRM compliant” in terms of customer data collection, sales screen displays and sales process logic;
Define Business Rules for the optimization of transactions: objective function (expected revenue, expected margin, conversion rate), constraints and system parameters (such as “Value of Learning”);
Integrate CCRM Optimizer with the Transaction Manager system and other Enterprise systems (such as Costing . . . ) in order to score offers according to their choice probability and expected value;
Adjust sales procedures and define the right incentives for the sales agents and partners to improve the use of the system;
Identify the characteristics influencing customer choices and build segments grouping customers showing consistent choice behavior;
Define choice models and calibrate the models on a sample of historical data. Apply the choice model to predict choice probabilities;
Monitor the success of the CCRM and continually refine the system. The system refinement process includes monitoring the accuracy of the forecasts, periodic updating of the choice models and predictions to reflect new offers;
Identify new factors influencing the choice model and incorporate such factors in the model;
Use CCRM to improve the definition of offerings and their price.

CCRM is applicable to a wide range of industries and sales environments (goods and services, B2B and B2C). It can handle different offering logics including:
Instantiated offers with variance in attribute values such as price,

Sequenced offers, presented one at a time,

Simultaneous offers, presented in combination/sets.

The following drawings illustrate key features of the invention that are commented in the detailed description here-after:

FIG. 1 is a Block Diagram Overview of the structure of CCRM and its principal components;

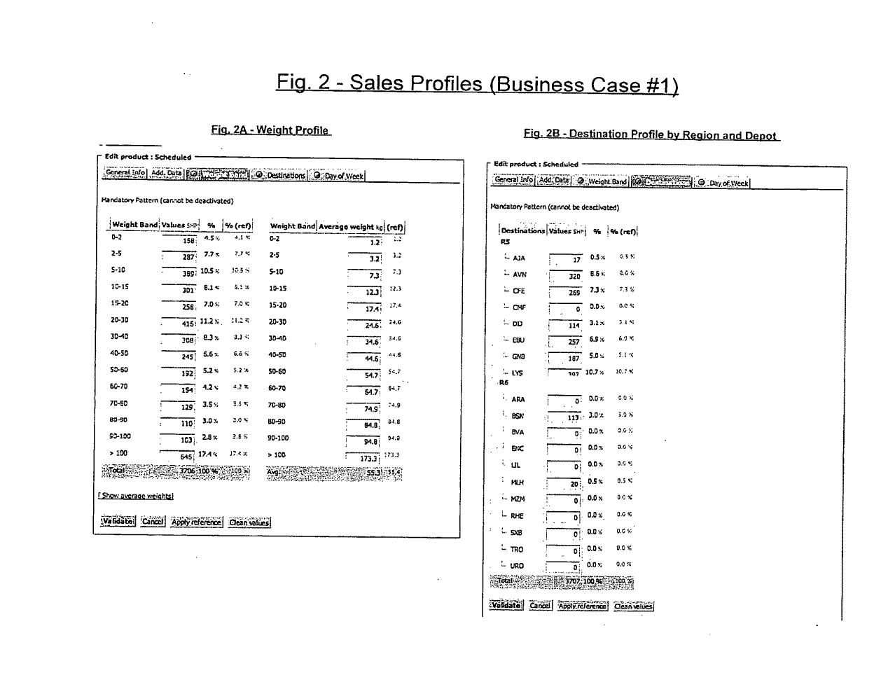

FIG. 2 provides examples of Sales Profiles for Business Case #1 (Parcel Transport Operator);

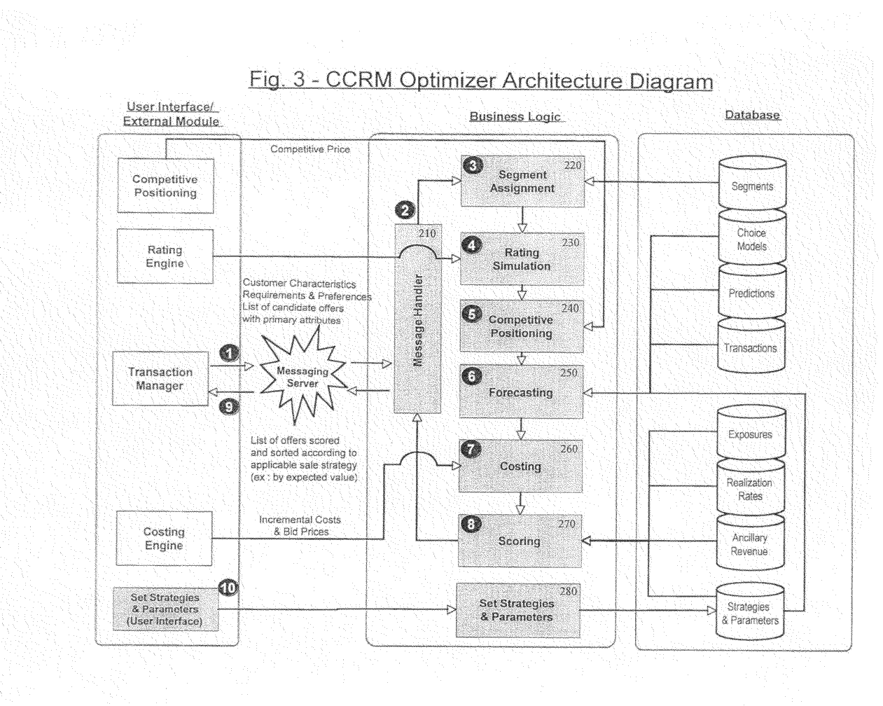

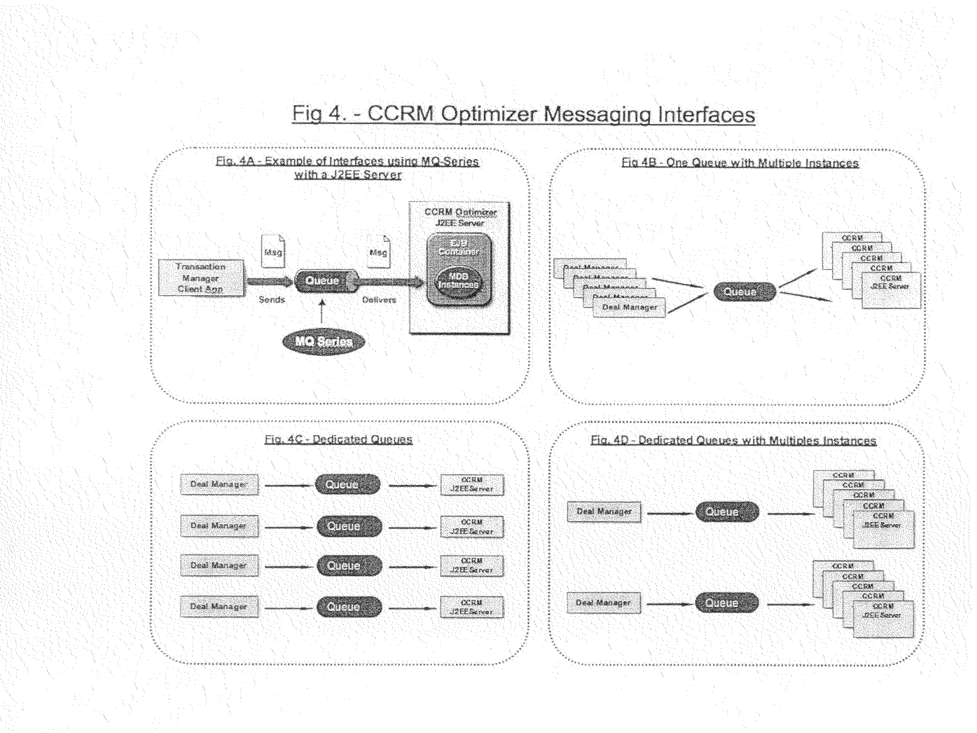

FIG. 3 is a Block Diagram of the architecture and process of CCRM Optimizer 200;

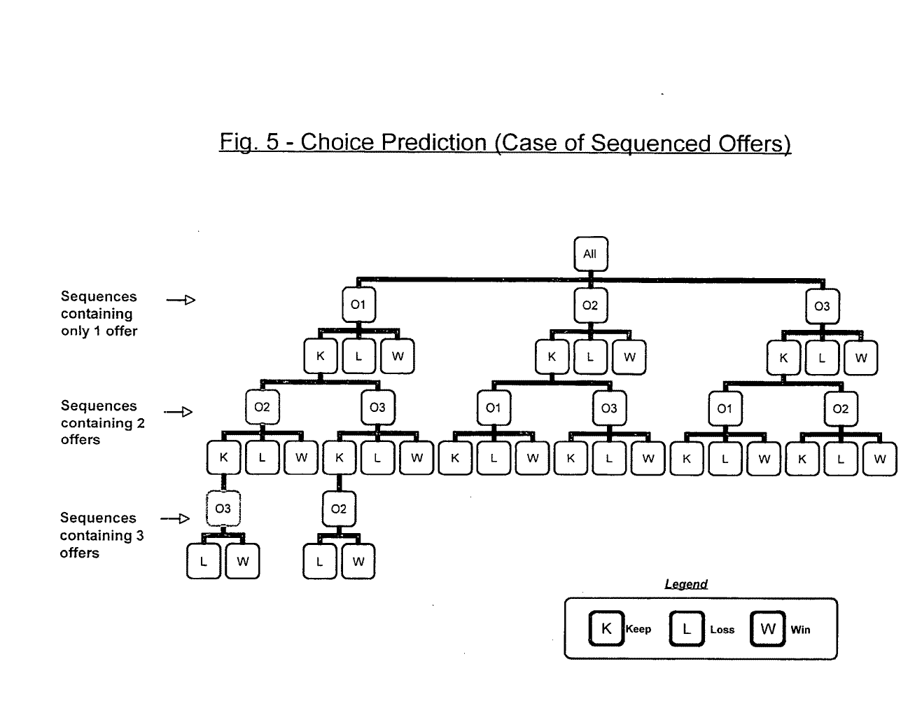

FIG. 4 provides examples of CCRM Optimizer 200 Messaging Interfaces;

FIG. 5 is an example of Choice Predictions made in the case of a sequenced sales mode;

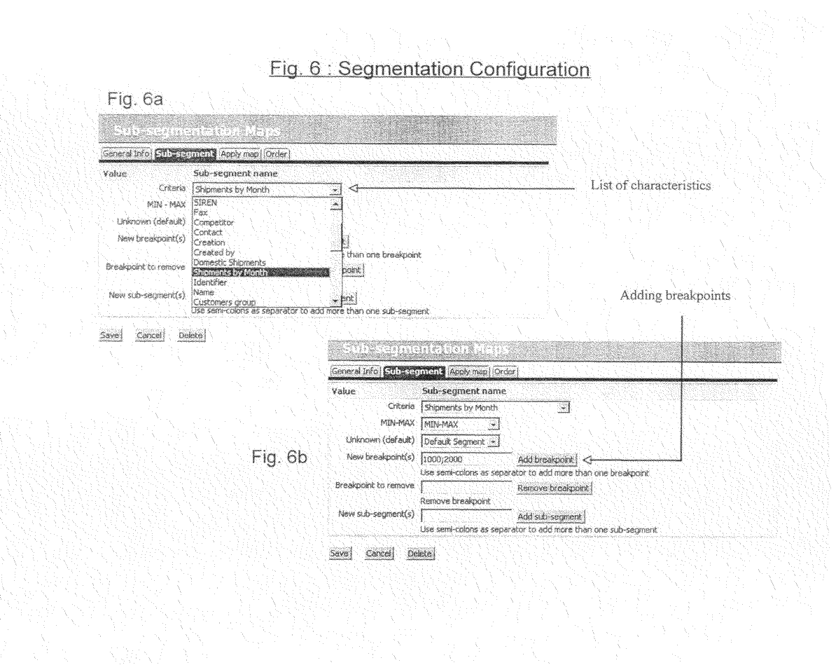

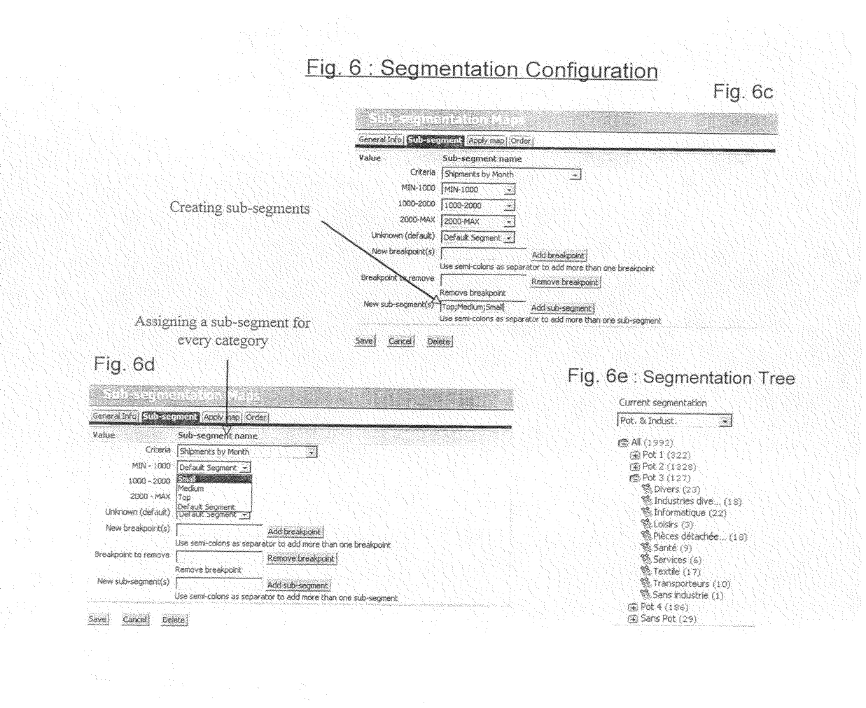

FIG. 6 provides examples of Segmentation configuration screen-slots of the CCRM system;

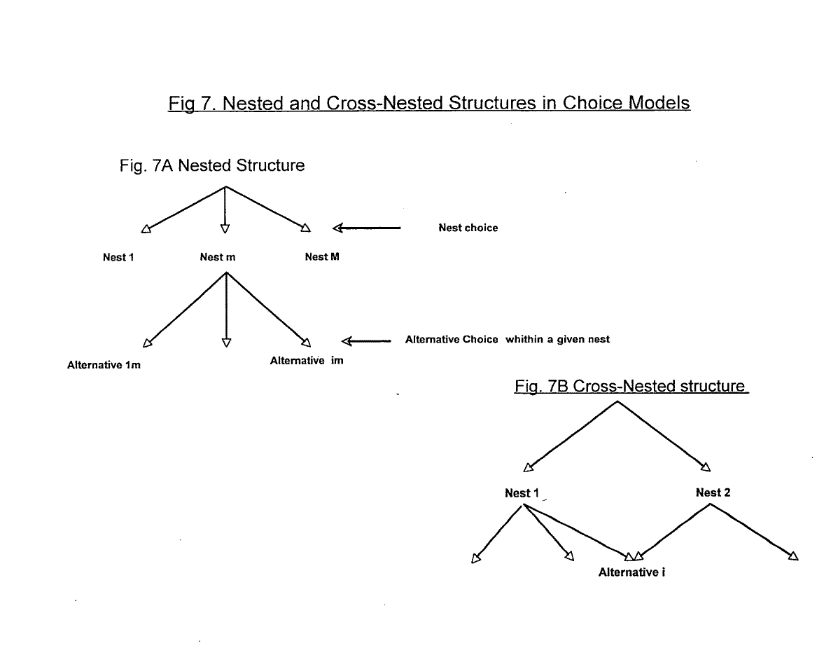

FIG. 7 is an illustration of Nested and Cross-Nested Structures used in CCRM models.

### DETAILED DESCRIPTION

The terms used in the drawings and the specification for this invention are defined as follows:

Actual Sales Cube (Customer): the observed Sales Cube of the customer over a period of time. See Sales Cube.

Alternative: during a transaction, the Customer has the choice between one or more offers. He may also choose not to buy (“Loss” alternative) or—in case of sequenced offers—wait for another offer (“Keep” alternative). All these possibilities including “Loss” and “Keep” are alternatives available to the Customer during the transaction.

Analyst: user of the CCRM system. The analyst configures the CCRM system by setting parameters, strategies according to Enterprise business rules. He validates its recommendations and monitors its results.

Ancillary Revenue: extra-revenue generated by optional services not included in the initial offer at transaction time, but purchased later as a complement to the initial offer.

Attributes (Offer): an offer is characterized by a set of attributes. Some attributes may be generic to all offers, and some may be offer-specific. One of the major attributes of an offer is its price (if simple price) or its pricing parameters (in case of a pricing structure). The other attributes of the offer are dependent upon the type of product/service. Example of attributes of the offer:
In the case of an airline: departure date/time, travel duration, number of stops, class of service, price per seat.
In the case of a tour operator: destination, type of travel, hotel category, room type, view, price per room.
In the case of a parcel transport operator: collection time, collection location, delivery time, price per shipment and price per Kg (two pricing parameters).

Availability (Product): if the offer is based on resources whose inventories may face shortage, availability relates to the fact that there is at least one item remaining that can be sold to the customer at the time of the request. Example: a tour operator sells packaged offers that comprise three type of components:
travel (airline, train . . . ),
hotel/resort accommodation,
excursion/entertainment/events.

A given offer may not be available due to shortage of airline seats or hotel rooms for specific travel dates. It is possible to distinguish between “real availability” (number of items remaining available in the “physical inventory”) and “virtual availability” corresponding to the number of items remaining available for a given type of offer, at a given price for a given type of customer.

B2B: business to business market. All transactions and exchanges between enterprises.

B2C: business to consumer market. All transactions between an enterprise and an individual consumer.

Bid Price: the expected marginal revenue generated by the last unit (resource/product) of a constrained and perishable inventory. It is equal to the price at which the unit could be sold in the future multiplied by the probability to sell this unit. The bid price indicates the minimum price at which the resource may be sold at a given point in time. Example in case of a room inventory (hotel):
At a given point in time, there is a probability of 60% to sell the last room at $100 in the future and a probability of 80% to sell this last room at $80. The bid price is then $64 which is the greatest of ($100*60% and $80*80%). If a customer requests the room at that time, the minimum price to quote is $64.

The bid price of an offer composed of elementary components (resources) is equal to the sum of the bid prices of the different components.

Example: a tour operator sells packaged offers that comprise three types of components:
travel (airline or train),
hotel/resort accommodation,
excursion/entertainment/events.

A bid price may be defined for each offer as the sum of bid prices of constrained components (flight seats and hotel rooms). For example if a given offer involves two flights segments (outbound flight Fo and return flight Fr and a 7 days accommodation in a given room type R1 to R7), then the bid-price of the offer is equal to the sum of components bid prices:

BP(Offer)=BP(Fo)+BP(Fr)+BP(R1)+BP(R2)+ . . . +BP(R7)

Call Center Sales: sales made at the call center of the Enterprise. We may distinguish between <<inbound calls>> (when the customer calls) and <<outbound calls>> (when, for example in the case of marketing campaigns, the Enterprise agents call the customer).

Capacity: in the case of resources/products with constrained inventory, it relates to the maximum number of available items.

Characteristic (Customer): in order to handle heterogeneity of choices between Customers, each Customer is described by a set of variables/attributes named “characteristics”. Examples of characteristics: gender, income, zip code (in B2C) and industry, sales region, purchase volume (in B2B). By extension characteristics may include customer stated preferences and interaction context (period, lead time . . . ). See Stated Preferences.

Choice Model: model describing the choice behavior of the Customer. For each customer and every offer, it gives the relationship between the characteristics of the Customer, the attributes of the offers (price . . . ) and their choice probability by the customer.

Choice Probability (Offer): probability of choice of a given offer by a given customer (when this offer is proposed to the customer alone or within an offer set/sequence).

Choice Rate (Offer): the observed number of times a given offer has been purchased by the customer divided by the number of times it has been exposed/presented to the customer. Choice Rate is related to a given period of time and to a given customer segment. Example: two offers A, B may be proposed and the customer has a no-choice (“Loss”) alternative. The transactions are the following:

| | Offers | |
|---|---|---|
| Transaction # | Proposed | Outcome |
| 1 | A, B | A |
| 2 | A | A |
| 3 | A | Loss |
| 4 | A, B | Loss |
| 5 | A, B | B |

The Choice Rates in our example are: 40% (⅖) for A and 33% (⅓) for B.

Choice Set: all potential alternatives available to a customer during a given transaction.

Choice Variables/Predictors: offer attributes and customer characteristics used to build a Choice Model.

Contract: in B2B markets, most transactions are structured as contracts governing a set of future orders between the Enterprise and the customer. The terms of the contract are revised periodically (ex: once a year) and the price of the related product(s) is fixed at signature/renewal of the contract for the contract period. A contract may not precisely specify the orders but only pricing terms. Each order done under a contract umbrella will inherit those pricing terms and other general conditions agreed between the seller and the buyer. Example: volume and Sales Cube commitments over a period of time. See Sales Cube.

Conversion Probability (Offer Set, Offer Sequence): probability that a given set/sequence of offers will convert to an order/booking if proposed to a customer.

Conversion Rate (Offer Set, Offer Sequence): the observed number of times a given set/sequence of offers has converted into a purchase divided by the number of times this set/sequence has been proposed. The conversion rate is related to a given period of time and to a given customer segment. Example: two offers A, B have been proposed and the customer had a no-choice (“Loss”) alternative. The observed transactions have been:

| | Offers | |
|---|---|---|
| Transaction # | Proposed | Outcome |
| 1 | A, B | A |
| 2 | A | A |
| 3 | A | Loss |
| 4 | A, B | Loss |
| 5 | A, B | B |

The conversion rates in our example are: 50% (½) for set/sequence “A” and 67% (⅔) for set/sequence “A,B”. Offer set/sequence “B” was never proposed and conversion rate is unknown.

Cost Variable/Predictor: a variable used in the calculation of costs and whose value is aggregated for each customer in elementary cells of the Sales Cubes for different time periods (week, months . . . ). See Sales Cubes.

CRM (Customer Relationship Management): management information system entailing different aspects of interaction an Enterprise has with its customer, whether it is sales or service related. In the scope of the CCRM system, CRM is used to identify the Customer and collect its Characteristics. See Characteristics.

Customer: business customer (B2B) or consumer (B2C). Entity requesting for a product or service and making a choice decision during the transaction.

Display Order: order of display of offers to a customer on a computer/Internet screen. The screen can be a page of a selling Web site or the interface screen of the CCRM system.

Dynamic Pricing: business environment in which the prices of the different offers are adapted over time to reflect the level of demand versus capacity. This type of environment is typical of Low Cost Airlines that increase the fare on flights until time of departure depending on load factor and lead-time.

Electronic Distribution: sale of products or services through an electronic media such as the Internet or an industry specific computer network (ex: Global Travel Distribution System).

Enterprise: provider or seller of the products and services. User of the CCRM system.

ERP (Enterprise Resources Planning): management information systems that integrate and automate business processes associated with the operations or production aspects of the Enterprise (such as order processing, purchasing, production, delivery, invoicing and accounting). ERP are often called “back-office systems”.

Expected Value: a key CCRM performance indicator. In general terms the concept is related to “Value (of an offer)” multiplied by its “Sale Probability”. It has different possible formulations depending on how the concepts of Value and Sale Probability are defined. See Value and Sales Probability.

Exposure Rate (Offer, Offer Sequence, Offer Set): percentage of exposures of an offer during a given period of time for a given customer segment. It is equal to the ratio of the number of times the offer was proposed/presented to customers in a given segment, to the total number of offers proposed to customers in the segment.

Forecast: Estimation of the Choice probability of a given offer/offer instance/offer set/offer sequence for a particular customer generated by CCRM Optimizer.

Forecast Mode There are two modes of forecast. In the “Simple Forecast Mode” the forecast is made by offer/offer instance whereas in the “Expert Prediction Mode” the forecast is made by offer set or offer sequence.

GDS (Global Distribution System): a computerized system used to store and retrieve information and conduct transactions related to travel.

Incremental Cost: the additional (or variable) cost incurring when an additional order of a product/service is executed. Different from “sunk”/fixed costs.

Keep (Alternative): in the case of sequenced offers (ex: at a call center), after each offer proposition, the customer may choose this offer, hang up (“Loss”) or wait for another offer, which is called the “Keep” alternative.

Lead Time (Transaction): the number of days in advance of product delivery when the transaction is made.

Loss (Alternative): the result of a transaction is a loss when the Customer decides not to buy any offer presented to him.

Negotiated Sales Cube (Customer): the planned Sales Cube of the customer over a period of time (defined at transaction time). See Sales Cubes.

Negotiation Variable: price or non price variable that may be changed within a pre-defined range of possible values to optimize a transaction/contract. Example of price variables used by a parcel transportation operator: Price per shipment, Price adder per Kg, Hour of collection of shipments, Minimum number of shipments per month . . .

Observation: The elementary choice data recorded in the CCRM system corresponding to an offer/offer set/offer sequence and related to a customer's choice (offer selected, “loss” or “keep”). A sales session may involve different observations.

Offer: product, service or combination of product and/or service components with associated price structure proposed by the Enterprise to the Customer during the transaction. Each offer is characterized by a set of attributes (including price parameters).

Offer Instance: a possible variation of an offer whose attributes (such as price or other product/service attributes) may be customized.

Offer Sequence: an ordered combination of offers presented to the customer, one by one. Ex: if A, B and C are three offers; the possible offer sequences are A, B, C, A→B, B→A, A→C, C→A, B→C, C→B, A→B→C, A→C→B, B→A→C, B→C→A, C→A→B, C→B→A. A sequence is considered “complete” and it is assumed that no other offer than those included in the sequence has been presented to the customer.

Offer Set: a combination of offers presented/exposed to the customer. Ex: if A, B and C are three offers, the possible offer sets are {A}, {B}, {C}, {A,B}, {A,C}, {B,C}, {A,B,C}.

Opportunity Cost: the expected loss in future revenue from selling a unit of product now rather than reserving it for a future sale. Apply only to products/services with limited inventory or replenishment constraints.

Optimization: the process of finding the offer/offer instance/offer set/offer sequence that maximizes a pre-defined objective function of the transaction (such as the expected value or the conversion probability) given different constraints (such as for example: minimum exposure, minimum conversion, minimum value).

Option: a product/service feature that can be acquired for an additional payment only in complement to a main product/service.

Order: an arrangement by which the customer secures in advance the availability of a product or service. Depending on the policy, the order may be secured with payment and the customer keeps a cancellation option. Also referred to as “Booking”.

Override: influence of the Analyst who can change system calculated choice rates or choice probabilities.

Preference Index (Offer, Customer): a measure of the satisfaction gained by a given customer when buying a specific offer.

Price Band: range of price allowed for an offer during a Transaction (depends upon the Pricing Policy).

Price Plan: (also referred to as Rate Plan) formula describing how the price of an offer is calculated according to price variables.

Prediction: estimation of the Choice probability of a given offer/offer instance/offer set/offer sequence for a particular customer segment made by the Analyst.

Price Variable: a variable used in the calculation of revenue (Rating) and whose value is aggregated for each customer in elementary cells of the Sales Cubes for different time periods (week, months . . . ). See Sales Cubes.

Ranking (Offer): order of presentation of the offer to the customer during the transaction. CCRM recommends the optimal ranking of offers. Other (non-optimal) criteria of ranking/sorting offers are: by price, by attribute values (example in the case of an airline web site: display flights by departure time).

Realization Rate (Offer): the number of final invoiced sales recorded for a given offer divided by the number of orders recorded for that given offer. The Realization Rate may be inferior to 100% due to cancellations and modifications of orders. In the case of Contract Agreements it may also be superior to 100%, when actual sales/orders exceed initial expectations.

Request: part of a sale session corresponding to a given presentation of offers based on a given statement of customer requirements/preferences and a given sales strategy. A sales session may be composed of 1 to n Requests. See Session.

Revenue Management (RM): the process of periodically reviewing transactions for goods or services already supplied and to forecast future demand behavior in order to adjust prices and products/services availability by market micro segment. Also known as “Yield Management”.

RMS (Revenue Management System): system used to support Revenue Management decisions.

Sales Cube (Customer): Sales Cubes are the most refined multidimensional crossings of elementary Sales Profiles. Each cell of the Sales Cube contains aggregated values of price and cost variables for different units of time (month, week . . . ). See also Sales Profile.

Sales Monitoring: the process of comparing the initial orders with the actual order invoiced in terms of quantities of product sold, revenue or Sales Cubes.

Sales Profiles (Customer): represent the distribution of sales/orders to a given customer. They are built as tree data structures whose nodes correspond to order lines attribute values and contain aggregates of price variables and/or cost variables for different units of time (month, week . . . ). For example in the case of a Parcel Transport Operator, Sales Profiles may be built using shipment origin, shipment destination, weight, delivery month and aggregate such price/cost variables as number of shipments, kgs . . . . Several Sales Profiles may be defined (ex: collection, line-haul, delivery profiles). Customer actual Sales Profiles are populated by an aggregation of order/invoice lines. Customer negotiated Sales Profiles are populated either by reference to profiles of equivalent customers or by user input (manual or through Excel files). See also Sales Cube.

Score (Offer): performance indicator of an offer for a given transaction, expressed from 0 to 100 or through a simplified system (ex: star system from “*” to “*****”) indicating the relative value of the offer for the Enterprise (independently of its choice probability by the customer). The score may be based either on revenue (“price score”) or on margin (“profitability score”).

Segment (Customer): For prediction purpose, CCRM groups customers having similar choice behaviors into segments. Segments are defined using a Segmentation Tree.

Sale Probability: probability that an offer is chosen and not cancelled or modified later-on. It is equal to the Choice Probability multiplied by the Realization Rate.

Sequence Associated Choice Set List (SACSL): for every sub-sequence, contained in the complete sequence, there is an associated choice set containing the offers in the sub-sequence, the Loss alternative and eventually (if it is not the final sub-sequence) the Keep alternative. The list of all these choice sets (as many choice sets as the number of sub-sequences), is called the SACSL.

Sequence Final Choice Set (Offer Set) (SFCS): choice set associated to the final sub-sequence. This choice set contains all the offers of the sequence and the Loss alternative.

Sequenced Sale Mode: a method of sale in which offers are presented one by one in a sequence to the customer. By opposition to “display of offers”, in which offers are displayed in a screen with an order (“Simultaneous Sales Method”).

Session (Sale): elementary part of a transaction corresponding to a given interaction between the enterprise and the customer. A transaction may contain 1 to N sessions. Example of sessions are: a telephone call to a call center, an Internet session or a given quote in B2B. Different types of sessions are for example: Inquiry, Sale, Payment, Modification, Cancellation. See also “Transaction”.

Sub-Sequence (Offer Sequence): Any sequence included in a given (complete) sequence.

Sub-Sequence (Final): longest sub-sequence related to a given sequence.

Substitution: the fact that a customer request, turned-away due to lack of availability of a given product, will transform in buying another product. Also called Recapture (or Buy-up).

Super Sequences (Offer Sequence): Refers to the set of all sequences including a given sequence as their initial part. By convention, super-sequences are noted with a final arrow sign. For example, super-sequence “O1”contains the complete sequences “O1”, “O1→O2” . . .

Subset (Offer Set): Any set included in a given set.

Superset (Offer Set): Any set including the current set.

Stated Preferences: responses to preference questions that permit the query of candidate offers for that customer and the segmentation of Customers.

Strategy: a business goal with related constraints set for the optimization of offers within a given customer segment. Examples: “Minimum Choice Rate”, “Maximum Contribution Margin”, “Minimum Exposure Rate” . . . .

Status (Transaction/Contract): example of statuses are “under construction”, “internal approval pending”, “customer decision pending”, “ordered”, “paid”, “lost”, “realized”, “cancelled”, “modified” . . . .

Transaction: Interaction between the Enterprise and a Customer for the purpose of the purchase/sale of product(s) or service(s) or the negotiation of a contract. Also referred to as “sales opportunity”. A transaction may correspond to 1 to N different Sessions. It may or not result in an order/sale/contract.

Value (Offer): net financial contribution of the offer sold to a given customer for the Enterprise (in terms of revenue or profit). This concept is different from the concept of “Preference” which estimates the value of an offer for a given customer in terms of utility.

Value of Learning: a monetary value adder or multiplier reflecting the importance given by the Enterprise to acquiring knowledge related to the choice behavior of customers when new offers or offers with low historical exposures are presented to them.

Weight (Attribute): coefficient of the customer choice model associated to the related attribute.

Win: the result of a transaction is a “Win” when the Customer purchases any offer among the offers proposed.

### CCRM Components

At a high level, the CCRM system can be envisioned as depicted in FIG. 1. The system includes five main components: a core module, CCRM Optimizer 200 communicating with Transaction Manager 100 (which may be an internal or an external module depending on the embodiment) and three “support” modules—CCRM Analyzer 300, CCRM Modeler 400 and CCRM Sales Monitor 500. CCRM components communicate together and with external systems: CRM, ERP . . . . It shall be noted that certain modules are optional. For example the following embodiments are possible:
a CCRM Optimizer 200 alone integrated with an external Transaction Manager module;
CCRM Optimizer 200 working with CCRM Analyzer 300;
CCRM Optimizer 200 working with CCRM Analyzer 300 and CCRM Modeler 400.

### Database

A key aspect of this invention is a Database Model permitting to store for future analysis and modeling a full set of data necessary to optimize business transactions. FIG. 1 presents the most important categories of tables of the CCRM Database. As shown in this diagram, CCRM pulls a significant amount of data from the CRM (Customer data) and the ERP (Product/Offer Catalog, Prices, Product Availability, Sales Orders/Invoices). However, the most fundamental source of information is Transaction Manager 100 which provides the “Transaction” tables containing detailed data related to the interaction between the Enterprise and its Customers (i.e. requirements and preferences collected, offers presented and transaction outcome). Follows a high level description of the main blocks of the CCRM Database.

### 1—Transaction (Interaction) Tables

These tables use the following keys:
Transaction id;
Session id (N1 sessions may be associated to a given Transaction);
Request id (N2 Requests may be associated to a given Session: a Request corresponding to a given statement of customer needs and a given Strategy.

The following information is stored at the Request level:
Request start date/time stamp permitting to define its chronological order in the Session
Description of customer needs (requirements and preferences) collected through Transaction Manager 100—refer to this section;
Offers that were presented to the customer with, for each offer:
   Date/time stamp of presentation;
   Description of the offer in term of attributes (including its price and product/service components);
   Order in sequence (in case of sequenced offers) or the ranking in the display (in case of simultaneous offers) with the page number and the position in the page (if relevant);
   Matrix of compliance¹ of the offer with customer stated needs and the resulting compliance index (if any); ¹Include in glossary?
   Indicators calculated by CCRM Optimizer 200 (if this module is implemented) such as offer value, probability of choice/conversion, realization rate, expected value, score . . . ;
   Status/Outcome (“presented”, “ordered/booked”, “paid”, “cancelled” . . . ).

The following information is stored at the Transaction Level:
Customer id (foreign key of the Customer tables).

### 2—Customers Tables

These tables contain the different customer characteristics used by CCRM to segment customers, analyze their buying behavior and model their choices. These characteristics vary depending upon CCRM embodiment (refer to Business Cases hereafter for some examples of customer characteristics).

CCRM maintains different customer tables with relationships to reflect the fact that different customer concepts must to considered. For example:
In B2B environments (ex—Business Case #1): a customer account may be part of a group. It is then necessary to define a hierarchical relation between customers and attributes permitting to define the “point of negotiation”, the “point of invoice” . . . .
In B2C environments: there are different concepts of “customers” (ex in Business Case #2: “travel party” could be a sub-set of “household party”. In this case it is necessary to distinguish different customer tables.

### 3—Orders and Contracts Tables

These tables contain a copy of the offers ordered/booked or the contract structure with the estimated negotiated quantities and the negotiated Sales Profiles. They are the input of CCRM Sales Monitor 500—refer to this section.

### 4—Segments Tables

These internal tables contain the definition of the segmentation tree structure that permits to assign a segment to a customer. More specifically, it contains the list of all the nodes and for every node, the following information: (1) the reference of the father and (2) the definition of the splitting rule. This definition is given by the reference of the related splitting characteristic and the different categories of this variable. In the case of a categorical variable, the categories are defined by set of values and in the case of a continuous variable by breakpoints.

These tables are an output of Tree Based Segmentation 310 and Choice Based Segmentation 420.

### 5—Predictions Tables

These internal tables contain the definition of analyst predictions/overrides. They are an output of Prediction Management 330 and Choice Modeler 420.

### 6—Choice Models Tables

These internal tables contain the definition of choice models by customer segment. They contain all information needed to retrieve the expression of utilities. The first information is the type of the model: logit, nested or cross-nested.

In the case of a logit formulation, it contains also:
the number of alternatives in the universal choice set
the list of the references of the used customer characteristics and offers attributes
the values of every alternative's specific constants
for every customer characteristic used in the model: the related Weights by alternative
for every offer attribute used in the model:
a Boolean variable equal to one if the related Weight is alternative specific and zero else
the reference of the related attribute and alternative (if alternative specific)
the value of the related Weight (or Weights in case of alternative-specific Weights)

In the case of a nested or cross-nested model:
the nesting structure containing the list of nests and for every nest the list of alternatives belonging to this nest. An alternative belongs to only one nest in the case of a nested model but can belong to more than one nest in the case of a cross-nested model.
for every offer attribute used in the model:
a Boolean variable equal to one if the related Weight is alternative specific and zero else
the related part of the utility (nest part or alternative part)
the reference of the related attribute and alternative (if alternative specific)
the value of the related Weight (or Weights in case of alternative-specific Weights)
the values the different scale parameters and degrees of freedom by nest

Remark: The loss alternative is always the alternative that has the alternative specific constant equal to zero for identification.

These tables are an output of Choice Modeler 420.

### 7—Exposures Tables

These internal tables are used by different CCRM procedures including Alerts 340 and “Value of Learning” (refer to CCRM Optimizer 200). Once offers data is written to the Transaction Tables, the Exposures Tables are updated with cumulated number of exposures over analyst defined periods of time (ex: last week, year to date . . . ).

### 8—Alerts Tables

These internal tables contain the analyst alerts on exposure rates and choice rates. They are generated by a periodical batch process—refer to Alerts 340 and Choice Modeler 410.

### 9—Realization Rates Tables

These internal tables contain the Realization Rates. They are an output of CCRM Sales Monitor 500 (periodical batch process)—refer to this section.

### 10—Ancillary Revenue Tables

These internal tables contain Ancillary Revenue. They are an output of CCRM Sales Monitor 500 (periodical batch process)—refer to this section.

### 11—Sales Cubes Tables

These internal tables contain the Sales Cubes. They are an output of CCRM Sales Monitor 500 (periodical batch process)—refer to this section.

### 12—Parameters & Strategies Tables

These tables contain the different parameters and strategies defined by the Analysts that are used in the CCRM system.

The previous CCRM Database scheme is generic and could support custom design and physical architecture embodiments notably depending on specific definitions of products/offerings or different type of customer characteristics and relationship.

### CCRM Processes

There are three types of CCRM processes.
The Real Time Optimization Process: driven by CCRM Optimizer 200 which handles the requests transmitted by Transaction Manager 100 to provide offer recommendations.
Analyst Server Processes: launched on Analyst request, they permit to set system parameters and business rules (strategies and constraints), set predictions, control the results of the system through reports and alerts and monitor its performance.
Support Batch Processes: necessary to support the main CCRM processes and build the required tables. These support processes can be scheduled or launched on Analyst request.

These different processes are presented in detail hereafter within the description of each CCRM component.

### Transaction Manager 100

Transaction Manager 100 (also referred to as “Deal Manager”) enables to identify the customer, collect needs/preferences, present relevant offers and record the order/contract. In this description, reference is made to FIG. 1 for the steps of the process.

### 1—Customer is Identified. Session/Transaction are Initiated

First of all, a customer enters in interaction with the Enterprise. This may be when meeting a sales representative or partner, through the call center or by accessing the Enterprise Web site.

1A. A Session is created and is associated to a new Transaction or an existing Transaction (if the purpose of the current interaction is to validate, modify or cancel an existing transaction).

1B. The customer is identified in the CRM (if he is already recorded) or a new record is created. Customer characteristics which are retrieved from the CRM may at this stage be validated/supplemented in Transaction Manager 100.

1C. Information describing the context of the transaction may also be entered in Transaction Manager 100 such as for example:
Expected decision date/time,
Intensity of competition,
Name of competitor(s) . . . .

Remark: step 1B may be skipped if there is a need to simplify the sales process and gain time in the interaction with the customer. In this case the customer is only identified at the end of the session, if the sale succeeds. The drawback of skipping step 1B is to limit the knowledge of customer characteristics that may be predictive of its choice. In such a case, CCRM will only rely on stated needs/preferences and/or context information to predict customer choice.

### 2—Customer Needs/Preferences are Collected

Then, customer needs/preferences are collected in Transaction Manager 100. This collection is used to retrieve from the Product Catalog most adapted offers (see step 3). Moreover, needs/preferences can be used as predictors in the modeling of choices (see CCRM Modeler). This collection is done using question & answer (Q&A) script(s). Each type of business context may require specific Q&A script(s) to collect customer needs and preferences. Moreover, for a given enterprise, Q&A scripts may be customized depending on the product categories and/or customer segments. CCRM approach is generic and applicable/transposable to a wide range of situations. It relies on the following steps to collect customer needs and preferences:

2A. Select the required product or product categories. This may be done by navigating within a tree-based product catalog and/or by defining requirements in terms of selected values (or range of values) for offer attributes. The values of offer attributes may either be:
Categorical (a discrete list of possible values). Ex: Origin airport of a Flight.
Binary (“True”/“False”). Ex: Direct Flight vs. Flight with Stop-over
Continuous (numerical values): Ex: Date, Time . . . A special type of continuous attributes are Metrics of Performance. Ex: The speed of a CPU for a computer product.

For each attribute it is possible to enter in Transaction Manager 100 the list of selected values (or range of values) for the attribute or indicate that the customer has “No Preference” regarding this attribute. For Continuous attributes it is also possible to select the range of possible values in terms of conditions such as “Value of attribute>MIN_VALUE and/or “Value of attribute<MAX_VALUE”.

Remark: “No preference” is the default selection for attributes.

2B. Define the Attributes Preference Weights (APW) of the customer for different offer attributes. The attribute preference weights specify the relative importance that the customer gives to one attribute of the offer versus another attribute. They can be entered in Transaction Manager 100 using a variety of user interface devices including for example:
Drop-down lists or radio buttons with different values. Example: a system of three possible choices: “Very Important”, “Important”, “Not Important” (these entries are then converted to Weights from 2 to 0 for each attribute);
Number of stars to be selected for each attribute. Example: a system of six possible choices: “----”,“*----”,“**---”,“****-”,“*****” (each selection is then converted to a value from 0 to 5);
Gauges (from 0. to 10.) for each attribute;
Combination of the precedent devices and check boxes associated to each attribute. The “un-checked” value corresponds to a preference Weight of 0% for the attribute and the “checked” value triggers a default value for the preferences (for example: Drop-down list=“Important”, Staring=“** . . . ” or Gauge=5./10.), that can then be changed.

The different selections entered are converted into a set of Attribute Preference Weight for each attribute adding up to 100%. An attribute with APW=0% is considered “Not important” at all for the customer. This concept is similar to “No preference”.

The entry devices could depend on the type of business and the type of sales channel. For example in B2B environments, the Sales Executives select offers in “back-office” mode, then a Gauge system should be preferred because it allows a greater precision in the definition of attribute preference weights. In “front-office” environments (ex: a call center) when offers must be submitted in almost real-time to the customer, check-boxes and radio buttons with limited number of choices should be the preferred devices to capture user preferences, even if the level of precision in the estimation of preference weights is lower. It is also possible (in order to limit the required data entries) to pre-define default preferences by customer segment or product category and permit adjustments for each customer if required. For “regular” customers, it is also possible to enter a persistent profile of preferences to be used in future transactions.

2C. It is also required for the different selected values of categorical or binary attributes, to enter customer Value Preference Weights (VPW). For continuous attributes it is required to provide VPW for the minimum and for the maximum possible values of the attribute and a transformation function (for example a linear interpolation or another type of transformation) is then performed to determine the VPW between these two extreme values.

VPW are entered using the same type of user interface devices that are used to enter APW, i.e.: drop-down lists, radio buttons, stars selection or gauges.

Value Preference Weights are scaled in order to obtain for each attribute k, maximum VPW equal to 100%:

∀kMaxₗ[VPW(k,l)]=100%. (1)

where k is an attribute and l a possible value of this attribute.

Once VPW(k,l) are calculated, Attribute Value Preference Weight can be calculated using the following formula for each attribute k and each selected value l

AVPW(k,l)=VPW(k,l)*APW(k) (2)

This formula means that the Preference Weight for a particular selected value (l) of attribute (k) is equal to the Attribute Preference Weight multiplied by the Value Preference Weight.

Needs and preferences entered through the Q&A script are converted by Transaction Manager 100 into a Table of Needs with the following lay-out for attributes and value/range of values:
Attribute (k)−key
Value/Range of values (l)-key
Attribute Preference Weight APW(k). APW(k) sum up to 100% for all attributes.
Selected (1/0): AVS(k,l)=1 means that the corresponding attribute value for the offer has been pre-selected as a possible choice by the customer.
Value Preference Weight VPW(k,l) with maximum value equal to 100% for a given attribute (k)
Attribute Value Preference Weights AVPW(k,l)=VPW(k,l)*APW(k)

Each line with a Selected field AVS(k,l)=1 could serve as a selection condition to find relevant offers in the Product Catalog (see step 3 here-below).

Examples of Q&A scripts allowing to define customers needs are presented in the Business Cases presented at the end of this document.

### 3—Candidate Offers are Retrieved

Transaction Manager 100 makes a request to the Product Catalog component to retrieve offers matching the Table of Needs. A maximum number of offers to retrieve (MAX_OFFERS) as Well as a minimum number of offers to retrieve (MrN_OFFERS) may be specified.

In the product catalog, each offer (i) is defined with its corresponding attribute values (i,k,l).

The offer selection process is as follows:

3A. Search offers (i) matching all Attribute Value Selected conditions “AVS(k,l)=1”. The number of offers retrieved is Ni.

3B. For each selected offer (i), the Preference Index PI(i) is calculated as the sum across attributes of Attribute Values Preference Weights, for this customer

PI(i)=SUMₖ[AVPW(k,val(i,k))] (3)
where val(i,k) is the value of attribute (k) for offer (i)

3C. If Ni>MAX_OFFERS, the Ni offers are ranked by decreasing Preference Index PI(i) and the MAX_OFFERS first offers are transmitted to Transaction Manager 100. If Ni<MIN_OFFERS, there is a need to enlarge the offer set. This is done by “relaxing” the Select conditions for the attribute(s) which have the lowest Attribute Preference Weight APW(k) and then, for each relaxed attribute, by ranking the selected offers by decreasing Preference Index PI(i) until the number of offers MIN_OFFERS is reached.

Negotiation Variables: in B2B sales contexts some offer attributes may have different possible values. For example in the case of a Parcel Transport Operator it could be possible to change the hour of collection of the shipments as well as collection point. These attributes of the offer that may be adjusted during the negotiation are called negotiation variables. The combination of different possible values of negotiation variables create a possible instance for each offer. All possible instances of offers are retrieved from the product catalog according to the previous process.

### 4—Pricing Rules are Retrieved

The Pricing Catalog is then accessed to retrieve the applicable price(s) for each offer selected at step 3. The pricing catalog may contain a variety of rules to calculate the price of offers depending on product features, quantity of product sold, time of sale, bundling with other products and customer characteristics (segment, geography . . . ). Refer to [R7] for details on pricing formulas used in different business contexts that may be supported by CCRM. Additionally, CCRM distinguishes two type of pricing schemes:
Fixed pricing (usual in B2C contexts): in this case the price catalog contains “strict” rules to calculate the price based on customer characteristics and context information (date of transaction . . . ).
Pricing with negotiation bands (usual in B2B contexts): in this case the price catalog will contain rules to calculate a “target price” based on customer characteristics, context information and, additionally, a price band for negotiation (for example expressed in percentage of discount applicable to the “target price”). Alternatively, the Price Catalog could also contain different possible price points. In this case, CCRM Optimizer 200 will recommend which price point to apply to a given transaction within the negotiation band or the set of possible price points.

See Business Cases here-after for examples of Pricing Data transmitted to Transaction Manager 100 from the Product Catalog.

### 5—Product Availability is Checked

The ERP is then accessed to verify the availability of offers selected at step 3. Some offers may not be available and could not be proposed to the customer, so they must be withdrawn from the list of possible offers and, if the number of offers available is inferior to the defined limit, the process shall resume at step 3 to gather additional offers. CCRM distinguishes two reasons of availability restriction for an offer.
“Real Availability Restriction”: in this case the offer cannot be proposed due to lack of corresponding resources (an example is an airline fare product that cannot be proposed to the customer when capacity of the flight is sold out).
“Virtual Availability Restriction”: in this case the resources (ex: the airline seats) are still available, but the offer (e.g. fare product) cannot be proposed due to management rules aimed to protect highest yield offers (see bid price rule).

In case of virtual availability restriction, the offer will not be withdrawn but will be marked with the tag (VAR) “Virtual Availability Restriction”.

### 6—Sales Profiles are Defined

This step is only executed in the case of B2B contracts with recurring sales (ex: Business Case #1). In other cases this step is skipped. Refer to CCRM Sales Monitor 500 for the definition and calculation of Sales Profiles and Sales Cubes based on actual customer sales orders/invoices recorded in the ERP. Transaction Manager 100 enables the analyst to configure different types of Sales Profiles (mandatory or optional) depending on customer characteristics.

In general, more detailed Sales Profiles will be defined for top tier customers, whereas only simplified Sales Profiles will be defined for lower tier customers. The analyst also defines the References for the calculation of the Sales Profiles and Sales Cubes:
The Reference Period defined in rolling months (ex: last month, last 3 months, last 6 months, last 12 months);
The Segmentation to be considered to find equivalent customers (used for customers without or with insufficient historical sales).

When a transaction is initiated, Transaction Manager 100 makes a request to the Sales Cubes tables in order to calculate and retrieve the Sales Cube corresponding of the current customer, for the requested product(s) and the reference period. If the customer is not recorded in the Sales Cubes tables or if the history recorded in insufficient for the considered product and period, the Sales Cube of the Reference Segment or, else, of upper segments in the segmentation tree or of the upper product category in the Product Catalog are retrieved. The Sales Cubes are then aggregated for the different Sales Profiles configured for the customer and are displayed in the User Interface. The mandatory Sales Profiles can be edited and modified by the Sales Executive. He may also activate other optional Sales Profiles and in this case a new request is sent to the Sales Cubes tables to populate these profiles.

FIG. 2 presents two examples of Sales Profiles in the context of Business Case #1:
FIG. 2A shows a Weight Profile with the number and percentage of shipments by weight band (0-2 kg, 2-5 kg.) with comparison with the reference. The right table displays the average weight for each band. For example the first line can be read: “168 shipments are forecasted in the band [0,2[kg with an average weight of 1.2 kg for this band”. These shipments represent 4.5% of the total number of shipments of this customer”.
FIG. 2B shows a Destination Profile by Region and Depot. For example the first line can be read: “17 shipments (representing 0.5% of the shipments) are forecasted to be sent to the AJA depot in Region R5”.

The Sales Profiles, once updated and validated by the Sales Executive, are disaggregated by Sales Cube cell at the prorate of the corresponding quantities recorded in each cell. If no quantities are found for the corresponding cells, then the equivalent segment or upper segments in the Segmentation Tree or upper level of product in the Product Catalog are used to provide quantities. Sales Cubes will then be used for Rating Simulation and Costing Simulation (see CCRM Optimizer 200).

### Remarks:

Transaction Manager 100 can also handle multidimensional Sales Profiles defined as a tree-structure as for example a profile by Destination and then by Weight Band.
Transaction Manager 100 includes a functionality meant to generate Sales Cubes from a list of invoiced sales order records available in different formats (such as an Excel file). Transaction Manager 100 aggregates this data, populates the Sales Cubes and displays the Sales Profiles in the User Interface.

### 7—Request is Sent to CCRM Optimizer

In order to obtain the optimal ranking and sequencing for the candidate offers selected at Step 3, Transaction Manager 100 transmits to CCRM Optimizer 200 the list of candidate offers, customer characteristics and transaction context information.

Communication between Transaction Manager 100 and CCRM Optimizer 200 can be based on direct calls or rely on messages. In this last case, Transaction Manager 100 sends an “Optimization Request” message to the Messaging Server. In preferred embodiments of the CCRM system, the Request Message is an XLM message. Messaging contracts/structures may be specific to each CCRM embodiment. The Messaging Server could be based on MQ Series or other messaging servers of the market.

The Request Message contains the following data collected by Transaction Manager 100, directly (through its own user interface) or indirectly (by accessing other systems such as CRM, Offer Catalog, Price Catalog and ERP).
Optimization Request Id: the unique reference to the request message. Generated by Transaction Manager 100.
Session Id: the unique reference to the sale session. Generated by Transaction Manager. Note: several request messages may be sent to CCRM Optimizer during a given sales session (ex: in case of change in customer needs or sale strategy in the course of the session).
Transaction Id: the unique reference to the sale transaction. A transaction is assigned to each sale session. A given transaction may cover different sessions corresponding for example to shopping, sale, modification, payment, cancellation sessions.
Customer Id: for identified customers already recorded in the CRM or ERP.
Type of Interaction: the type of interaction with the customer gives the purpose of the request to CCRM Optimizer. Typical types of interaction include:
Shopping: the customer is only looking for a product or price information—pre-sale stage;
Sale: session aiming to buy a product;
Cross-sell/Up-sell: the sale is already closed and the objective is to sell complementary or higher value products to the customer—for example at the end of the sale session or during a payment interaction. It shall be noted that CCRM enables to manage cross-sell/up-sell interactions and define the best products candidates for cross-sell/up-sell and the optimal additional price to charge. In this case CCRM could use additional attributes of the transaction such as the transaction basket value;
“Save the Sale”: at the end of a session, when the probability of closing decreases, it is sometimes useful to save the sale with a better offering—the beginning of the “save the sale” type of interaction can be indicated by the sales representation/agent to CCRM or scheduled based on number of offers presented or session duration;
Cancellation Recovery: customer initiates an interaction with the goal to cancel the sale.

Specific strategies may be associated to these different types of sessions/interactions. See Set Strategies and Parameters 280. It shall be noted that Type of Interaction could also change during the course of a Sale Session (from “Sale”, to “Cross/up-sell” or “Save the Sale”).
Characteristics: the attributes of the customer discovered and entered in Transaction Manager 100 during the dialog with the Customer or retrieved from the CRM. In the case of consumers, typical characteristics include “Geography” (country, region, zip code), “Age”, “Gender”, “Income level”, “Marital status”, “Number of children”, “Age of children”, “Number in party”, “Affiliation” (granting access to special offers or discounts), “Frequency of Purchase” (ex: Initiators, Repeaters . . . ), “Value Tier”. In the case of Business Customers typical characteristics include “Geography” (ex: country, region . . . ), “Industry” (ex: IT, Chemicals, Transportation . . . ), “Business Tier” (ex: key account, medium size, small account . . . ), “Yearly Turnover”, “Business Mix” . . . It shall be noted that relevant Customer Characteristics may vary depending on CCRM embodiment and that the previous characteristics may be completed based on data available in the CRM or collected during the interaction with the Customer. The list of Customer Characteristics used by CCRM shall be set at installation time. Thus, the Optimization Request shall contain the list of predefined Customer Characteristics with eventual blank fields if the corresponding characteristic is “unknown” for that customer at the time of the optimization request.
Needs: Correspond to customer preferences and requirements collected by specific Q&A scripts implemented in Transaction Manager 100. These script(s) may vary depending on the industry and the embodiment of the CCRM system. The objective of this collection of information is (1) to select products/offerings that match customer's requirements (2) to evaluate the value given by that particular customer to different offer attributes or values of these attributes and (3) to evaluate the cost of serving the customer (notably in the case of B2B contracts where there is uncertainty related to the purchasing behavior (see CCRM Sales Monitor 500). Refer to Business Cases here-below for examples of Needs that may be collected in different embodiments of the CCRM system.
Context: Description of different information useful to evaluate the importance of the transaction for the customer and the competitive environment, such as: the closing date (which gives an estimate of the urgency of the request), intensity of competition, name of competitors for that particular transaction with their status “Supplier” (if customer is already using the services of the competitor) or “Active” (competitor competing for this transaction). . . .
Candidate Offers: (list) with their attributes (i.e. all attributes pre-defined at system setting time that may be used in the definition of the Choice Models) as well as possible Price Points, Negotiation Variables Values as defined by the company policy and set in the “Product Catalog” and “Price Catalog” and availability statuses (VAR) from the ERP.

Transaction Manager 100 assembles and organizes the previous data into a formatted “Optimization Request” message that will be read, decoded and processed by CCRM Optimizer 200. The format of the message shall be defined at CCRM implementation time.

See examples of messages in the Business Cases hereafter. Remark: certain data are omitted in these description for the sake of simplicity.

### 8 to 12—Offer Optimization

See procedure of CCRM Optimizer 200.

### 13—Offers are Presented to the Customer

At this stage Transaction Manager 100 receives the response from CCRM Optimizer 200. In case of a communication between the two modules through a messaging server, the response comes in the form of an “Optimization Response Message” which makes reference to the corresponding Optimization Request Message. The response can also come through an object in case of use of remote method calls or Web services. Basically, the Optimization Response. Message contains a header with the request id, the session id, the transaction id, the customer id, the segment, the applicable strategy; and then, the list of recommended offers with indication of their value, probability of choice, expected value, score and sequencing/ranking recommendation.

In cases where an offer was sent to CCRM Optimizer 200 with different possible values for negotiation variables or price points, the response message contains the previous values (value, probability of choice, expected value, score and sequencing/ranking recommendation) for each possible combination of price points and negotiation variables.

Transaction Manager 100 processes the Optimization Response Message and displays recommendations to the user (Sales Executive, Call Center Agent, Partner or Customer) in different formats that will depend upon the Sales Mode (Instantiated offers, Simultaneous offers, Sequenced offers) and the type of user (internal user, partner or customer).

Follows some examples of recommendation displays for typical CCRM embodiments corresponding to Business Cases #1 and #2.

### Business Case #1: Negotiated B2B Contracts (Parcel Transport Operator)

The user of Transaction Manager 100 is the Sales Executive negotiating the contract with the Customer. Transaction Manager provides recommendations regarding best offer instances as shown in Table 1.

### Comments:

The Sales Exec can select the negotiation variables related to the product “Domestic Overnight before 10:00 am” and the variable (here Price First Kg) that will vary in the analysis table).
The analysis table shows for the variable selected how different deal parameters vary accordingly. In the case of this CCRM embodiment, these parameters are: “Price per shipment”, “Revenue per Month”, “Margin $”, “Margin %”, “Score” (here from 0 to 100), “Approval Level” (“S” if Sales Exec is entitled to close the offer, “M” if Manager approval is required and “A” if Analyst approval is required) “Win Probability”, “Expected Margin”.
Transaction Manager 100 highlights the line corresponding to the optimal value of “Price per Kg” (here $ 9.40). The Sales Exec may then fix the value of the variable and review another negotiation variable.

### Business Case #2: Call Center Sales (Tour Operator)

The Call Center Agent receives offer recommendations to be presented to the customer as shown in Table 2.

### Comments

The Call Center Agent receives an ordered list of recommended offers. In our case, each offer is described by (1) a period—here the week, (2) the Destination, (3) the Room Type, (4) the Travel field: Yes/No), (5) the Score indicating—here through a staring system from “*” to “*****”—the relative profitability of the offer, (6) “Quote”, “Info” and “Buy” action buttons and (7) the Total Price of the offer.
Initially the price is only displayed for the first ranked offer #1. The agent submits this first offer to the customer. Then, he has the possibility to submit other offers: by clicking on the “Quote” button, the price of the corresponding offer is displayed to the agent who can communicate it to the customer. In our example, the sales agent clicked on the “Q” button of offer #2 and is currently submitting this offer to the customer (second step in the sequence). When the “Q” button is clicked, CCRM assumes that the offer has been presented to the Customer.
The “I” (Info) button is clicked when the agent wants to get additional information on a selected offer. Then Transaction Manager 100 displays a compliance matrix showing flow customer requirements and preferences (such as “Week of Stay”, “Preferred Destination” . . . ) are covered by the current offer.
The “B” (Buy) button is clicked when the agent makes a booking for the selected offer.
Offers are displayed to the agent in the optimal order defined by CCRM Optimizer 200 according to the applicable strategy (maximize expected value . . . ).
The scoring system can serve as a basis of incentive for the sales agents and may be included in their compensation plan. In our example, the sales agent may then be interested in trying to push offer #5 in priority to offer #4 (if during the conversation with the customer he feels that the customer could be interested by a travel option) because it has a better profitability score (even though the optimal sequence is offer #4→offer #5).
The fields displayed to the Sales Agent as well as the general logic of the display may vary depending on CCRM embodiment. For example it could be possible to add the field “Choice Probability” as a complement to the Score for Sales Agent information. As well it could be possible to display offers one at a time to the agent.

### 14—Interaction (Proposals and Choices) are Stored

Refer to section 3.3.2. (CCRM Database) for the description of information stored at the Request, Session and Transaction levels.

### 15—Record of Order/Contract

Refer to section 3.3.2. (CCRM Database) for the description of information (if any) stored at the order or contract level.

### CCRM Optimizer 200

FIG. 3 provides the architecture diagram of CCRM Optimizer 200. The architecture diagram distinguishes three levels:
user interfaces and communication with external modules,
business logic,
databases.

These different components can run on the same physical server or on different servers depending on the implementation.

CCRM Optimizer 200 communicates with Transaction Manager 100, the Rating Engine module, the Costing Engine module and the Competitive Positioning module in real time.

It uses the results of CCRM Analyzer 300, CCRM Modeler 400 and CCRM Sales Monitor 500 that are stored in the CCRM Database.

The analyst can set Strategies and Parameters using a specific user interface. In a preferred embodiment of the system, the analyst interacts with the system through a Web browser but other embodiments of the User Interface may also be possible (for example: a custom client user interface running on personal computers Linder Windows, Unix, Linux or MacOS operating systems).

CCRM Optimizer 200 is invoked by Transaction Manager 100 during each sale session. It may be invoked several times during a given sale session, for example if customer changes its requirements and/or preferences, Transaction Manager 100 will re-submit a request to CCRM Optimizer 200.

The interface between Transaction Manager 100 and CCRM Optimizer 200 described in this document consists in a communication through a messaging server as indicated in FIG. 4. However other embodiments could be based on direct calls from Transaction Manager 100 to CCRM Optimizer 200 using specific API (Application Program Interfaces) or using Web Services that can be provided by CCRM Optimizer 200. Direct calls will be the preferred embodiment when there is a need to minimize response time in particular for CCRM systems dealing with an important number of transactions per second.

FIG. 4A “Messaging Interface” presents a possible implementation of a messaging interface using MQ Series and the J2EE platform. The steps of the process are as follows:

(1) The application client (Transaction Manager) sends messages to the Queue;
(2) The application server takes the Request Messages from the JMS provider (MQ-Series) and delivers the messages to the instances of the message-driven bean, which then process the messages;
(3) After processing the Request Message, the message-driven bean sends the Result to the response queue;
(4) The application client receives the Result;

The application server can handle multiple instances of message-driven beans. There are two important requirements when implementing CCRM Optimizer 200 related to response time and computing load.

(1) Response Time. It is required that CCRM adds only a “marginal” increase in Transaction Manager 100 response time. In practice, the added response time imposed by CCRM Optimizer 200 will depend upon the following factors:
The number of offers sent for scoring per optimization request. This number could typically vary from less than ten offering scenarios (ex: price variations for a pre-selected offer in case of a CCRM system used to optimize the price of negotiated transactions—refer to Business Case #1) to several hundred of offers in case of optimization of offerings from a rich product catalog (ex: Business Case #2);
The number of offer attributes and customer characteristics and preferences used in Choice Modeling and the number of possible values of each attribute;
The complexity of the choice model: Logit, Nested, Cross-nested . . . (refer to CCRM Modeler 400);
The number of sequences/sets of choice to evaluate for each optimization request (see here-below);

(2) Transactions load. The load oil CCRM Optimizer 200 will be dependent upon the number of optimization requests sent per second. Typically the load could vary from less than one request per second (in a B2B negotiation context) to tens or even hundreds per second for high load transactional systems such as Internet merchant sites or Global Distribution Systems (GDS), which may be accessed by thousands of users simultaneously.

Queue configurations with multiple instances (as presented in FIGS. 4B, 4C and 4D) can be used depending on the case for ensuring a high performance in terms of load and response time. If required by the load, different instances of CCRM Optimizer 200 may run on different physical servers.

Follows a detailed description of CCRM Optimizer 200 process. The description is done with reference to “step numbers” in FIG. 3 “CCRM Optimizer Architecture Diagram”.

### 1—Transaction Manager Sends an Optimization Request

Transaction Manager 100 sends an “Optimization Request” message to the Messaging Server. Messaging contracts/structures may be specific to each CCRM embodiment. Preferred embodiments will use XML messages. The Messaging Server could be based on MQ Series or other messaging servers of the market. The content of the Optimization Request message is described in the section “Transaction Manager 100” with reference to three business cases presented in section 3.4.9.

### 2—Message Referencing and Parsing—Message Handler 210

Each incoming message is processed by Message Handler 210. First Message Handler 210 assigns an internal reference (id) to the message along with Transaction Manager Request Id.

The message is parsed and a Request Object is loaded into memory with its content. The list of candidate offers is obtained in the Request Object with their attributes and the possible values of these attributes are read. Attributes corresponding to “Negotiation Variables” (non monetary) and “Price Variables” may have different values. In such cases, an Offer Instance is attached to the offer for each combination of possible values of the variables.

Let's suppose that we have P negotiation variables. Each variable p has nₚ possible values. All the other attributes being fixed.

Totally there are

$${\prod }_{p = 1}^{P} {n}_{p}$$

possible combinations of negotiation variables (offer instances).

For example in Business Case #1 “Parcel Transport Contract”, the following instances are attached to the Offer “Domestic Overnight before 10:00 am”:
CollectionHour=“Before 04:00 pm”/Price First Kg=$10.00/Price Add Kg=$1.40
CollectionHour=“Before 04:00 pm”/Price First Kg=$10.00/Price Add Kg=$1.30

In this example 120=3*8*5 offer instances are built, corresponding to possible combinations of values of variables “Collection Hour”, “Price First Kg” and “Price Add Kg”.

Then Message Handler 210 passes the Request Object to different procedures (steps 3 to 8). Once these treatments are completed, Message Handler 210 generates an Optimization Response Object/Message that will be sent back to the Messaging Server (step 9).

### 3—Segment Assignment 220

Given customer characteristics, preferences and requirements transmitted in the Request Object, Segment Assignment 220 accesses the Segments Tables and finds the tree and the path to the customer segment. Refer to Tree-Based Segmentation 310 for a description of the segment assignment procedure.

### 4—Rating Simulation 230

In situations where the Optimization Request Object does not contain the actual price of each offer, but only the specification of the pricing formula and the value of the different pricing variables, it is necessary to calculate the resulting average price of the offer and the revenue generated. This step in necessary in the case of B2B contracts with recurring sales for which the Sales Cube of the customer (i.e. the distribution of its future orders) is complex and the pricing formula depends upon different dimensions of this Sales Cube. Let us consider, for example the case of the Parcel Transport Operator defined in Business Case #1. The unity of measure (UOM) of the price is “the shipment (SHP)”. The Optimization Request Object does not contain the price of the contract but only the specification of the pricing formula (with pricing variables and possible values). In our case, the price of a shipment (shp) of weight (w) is given by the following two parts formula (applied at the elementary order line level):

Price(shp)=PRICE_FIRST_KG+PRICE_ADD_*INTEGER(w) (4)

### Where:

PRICE_FIRST_KG is the price of the first Kg of the shipment up to 0.999 kg,
PRICE_ADD_KG is the price of the additional Kg of the shipment starting at 1.000 kg,
INTEGER(w) is the integer part of the weight of the shipment.

Note that this formula is fairy simple. More complex formulations of price may take into account other order attributes such as origin (collection point), destination (delivery point), day of week, period . . . .

The expected average price (per shipment) of the contract is given by the following formula, as the sum of prices of future shipments executed under the contract, divided by the number of shipments:

Avg_Price(contract)=[ΣshpεcontractPrice(chp)]/Σshpεcontract^{shp}=Σ_{11=(),∞}[(PRICE_FIRST_KG+PRICE_ADD_KG*n)*S(n))]/ΣshpεContract^{shp} (5)

### Where:

S(n) is the number of shipments with weight between n and n+1 Kg ([n,n+1[).
S(n) is a particular Sales Cube referred to as the “Weight Profile” of the customer.

Even with simple formulations of pricing as above, the precise evaluation of the average price of a contract requires the consideration of Sales Cubes across all dimensions considered in the pricing formula (here the weight). Table (3) provides a comparison of two methods of calculation of the revenue and average price of the contract. The first method is based on the Sales Cube calculation as defined in Formula (5). This methods provides an exact calculation of the revenue and average price generated by the contract in case of perfect compliance between the actual sales profile and the negotiated sales profile. The other method is referred to as “myopic” because it tries to estimate the revenue and average price of the contract without considering the weight profile. This method is naïve. However it is most often used in practice by sales people. It is based on the calculation of the average weight of the shipments (here 1.2 kg) and application of the pricing formula to this average weight:

Avg_Price(contract)=PRICE_FIRST_KG+PROCE_ADD_KG*INTERGER(AvgWeight) (6)

In our example, the naïve method overestimates the actual price by 5%. This example shows the importance of evaluating the projected revenue and average price of a contract based on Sales Cubes across dimensions that are used in the formulation of price. This is the case of the “Weight Profile” in our example. However it shall be noted that “Profile by Origin and Destination Region” is not considered here in the simulation of revenue because Origin and Destination are not used in the price formula in Business Case #1.

### Rating Procedure:

This step is performed in case of B2B contracts with recurring sales only.

The Rating Engine supports the definition of:
Different Price Plans;
Different Pricing Methods for each price plan. A Pricing Method corresponds to a pricing formula (defined as a mathematical expression involving price variables);
Different Pricing Methods are predefined such as price multipliers defined for each cell of a grid involving 1 to N dimensions (order line attributes) or discounting methods based on customer characteristics. CCRM allows to extend existing pricing methods and create new ones;
Price Plans can be applied to a given customer segment and have a specific period of application.

CCRM Optimizer 200 send to the Rating Engine:
The Pricing formula contained in the Optimization Request message/object (see example in Business Case #1)
The Sales Profiles described in the Optimization Request message/object (see example in Business Case #1)

The Rating Engine calculates the expected revenue from the Contract as follows:
First, the reference Sales Cube is found (refer to Transaction Manager 100 step 6);
Then, the Sales Profile is disaggregated using the reference Sales Cube;
The price variables are then used for each cell of the Sales Cube to apply the Pricing Formula;
The revenues are then aggregated across the cells of the Sales Cube to obtain the expected revenue and the average price is calculated given the quantities.

Remark: It shall be noted that in cases of “spot” transactions, when the price is well specified by Transaction Manager, this Step 4 of CCRM Optimizer is not invoked.

### 5—Competitive Positioning 240

This method is executed when the Customer Choice model includes competitors' prices as predictive variables and these prices must then be evaluated at the transaction level. It could also be invoked in B2B negotiation contexts in order to provide to the Analyst or to the Sales Executives a benchmark of competitive prices in order to evaluate the adequacy of an intended price for a given customer.

There are three possibilities to evaluate competitive prices:
Competitive prices are transmitted in the Optimization Request Message/Object.
They are modeled based on the value of cost and price variables for a given customer (example in Business Case #1: shipments per month, kg per month) and/or customer characteristics (ex: industry, region . . . ). For example linear regressions could be used to that end, each observation corresponding to the measure of one competitive price for a customer or a prospect.
Formal competitive price plans (applied by the Rating Engine to the Sales Cubes)

Competitive positioning 240 uses the same procedure described in Transaction Manager 100 to estimate the Preference Index of competing offers. Refer to formula (3). The application of this procedure requires the definition of the attributes of the competing offers.

### 6—Forecasting 250

The Forecasting procedure calculates choice probabilities at a transaction/customer level for each candidate offer/offer instance/offer sequence/offer set. Three Sales Modes can be managed by Forecasting 250:
Instantiated offers with variance in attribute values (price . . . )—ref: Business Case #1,
Sequenced offers, presented one at a time—ref: Business Case #2,
Simultaneous offers, presented in combination/sets—ref: Business Case #3.

In the two last cases, CCRM Optimizer 200 will define the optimal order of presentation of the offers. In the case of Simultaneous offers, the order calculated by CCRM Optimizer 200 will define the ranking of the offers in Internet or GDS pages.

Forecasting 250 proceeds as follows.

### 6A. Initialize Forecasting Objects

Forecast Objects are created into memory for each candidate offer/offer instance/offer set/offer sequence. The forecast object has four properties initialized with the “Null” value:
Forecast.Actual: containing the actual value of the forecast that will be used by CCRM Optimizer 200 to deliver recommendations;
Forecast.Historical: containing the result of the historical choice rate defined in the Prediction Tables (if any);
Forecast.Model: containing the result of application of the choice model (if any).
Forecast.Origin: “O” for analyst override, “R” for historical choice rates and “M” for choice model.

### 6B. Read Parameters

Strategies & Parameters tables are accessed to retrieve the forecasting parameters applicable to the current context (offers category, assigned segment). These parameters are:
Sales Mode (Instantiated offers, Sequenced offers, Simultaneous offers);
In the case of Simultaneous offers, if the sub-sets are allowed (Yes/No);
Choice Model Activated (Yes/No);
Forecast Mode (Simple Mode/Expert Mode);
Number of alternatives in the model including the loss (in the case of a sequenced sales mode there is another alternative to add which is the Keep alternative);
Max Combined Offers denoted K (in case of simultaneous/sequenced sales modes)

### 6C. Retrieve Predictions

The Predictions tables are accessed to retrieve the predictions set for the different offers/offer instances/offer sets/offer sequences and the assigned segment. Two types of predictions are stored in these tables for a offer/offer instance/offer set/offer sequence (refer to Prediction Management 330):
Analyst Predictions (overrides, i.e. predictions with origin value equal to “O”). Note that if no override has been made by the Analyst, this field contains the “Null” value. In some cases the Analyst Prediction may not be a fixed value but a range a values (a minimum and a maximum);
Historical Choice Rates (if available).

These different values are loaded into a Prediction object which is initialized for each offer/offer instance/offer set/offer sequence with the different properties initialized with a “null” value:
Prediction.Analyst
Prediction.Historical

Remark: In case of simultaneous or sequenced sales mode and Expert Forecast Mode, CCRM Optimizer 200 accesses the Prediction tables twice. First to retrieve the predictions by offer, then the prediction by set/sequence (refer to here-below).

### 6D. Retrieve Choice Model

If the Choice Model is activated for the current segment, the Choice Models tables are accessed to find the model corresponding to the current customer segment and retrieve the formulation of the choice probabilities:
The type of model (logit, nested, cross nested . . . );
In case of nested or cross nested model, the alternative's tree structure (for each nest the reference of the upper nest and the list of the lower nests belonging to this nest);
The list of references of customer characteristics used in the model;
The list of offer attributes used in the model and the function to apply (if any). In the case of a nested structure, some attributes may be related to the nests utility part and others to the alternatives utility part. In this case, for each attribute in the list, the related utility part is defined;
For each offer attribute, a Boolean variable equal to one if the weights related to this attribute are alternative specific and else zero;
The list of weights;
a The list of other parameters (degrees of membership in the case of a cross-nested model);
The estimated values of the weights and other parameters;
For each weight, the reference of the related variable and the alternative—if any (in case of alternative specific weight);
For each non weight parameter (scale parameter or degree of membership parameter), the reference of the related nest.

The previous information is loaded into a Model Object in memory.

### 6E. Forecasting Procedure

Forecasting proceeds differently depending on the Sales Mode:
Instantiated offers,

Sequenced offers,

Simultaneous offers.

6E-i. Forecasting in Case of Instantiated Offers (ex: Business Case #1)

At the start of the process all properties of forecast objects (Actual Forecast, Historical Forecast, Model Forecast and Forecast Origin) are set to “Null” (refer 6A here-above).

For each offer instance, Forecasting 250 proceeds as follows:
Step 1: Forecast.Historical is loaded with Prediction.Historical. Remark: historical choice rates may be missing for some offer instances (because there is no historical data defined for this offer instance). In this case the Forecasting properties remain set to “Null”.
Step 2: If the Choice Model is activated for this segment, then Forecast.Actual and Forecast.Model properties will be loaded with the result of the win probability calculated by applying the model retrieved from the Choice Model to the choice set limited to the given offer instance and the Loss alternative. Then the Forecast.Origin is set to “M”. Else Forecast.Actual is loaded with Prediction.Historical and Forecast.Origin is set to “R”.

Here is an example of calculation of the win probability. Let us assume that the model retrieved from the Choice Model tables is the following:

### Model:

Model name=“Logit”
Number of alternatives=2 (including the Loss alternative)
Alternative specific constants=β₀ (the Loss constant is always equal to zero for identification)
Customer characteristics=7 dummy variables related to the characteristic Industry (discrete variable having 8 values): Industry1 (related to the value “Electronics”), Industry2 (related to the value “Chemical”), Industry7 (related to the value “Service”)
Related weights={β₁, β₂, β₃, β₄, β₅, β₆, β₇}
Offer attributes=PriceFirstKg, PriceAddKg
Related weights={α₁, α₂}
Values of the weights:

### Customer

Customer Id=231678958
Industry=“Electronics “(Industry1=1 and all other dummy variables equal to 0)

### Offer Instance:

Name=“Domestic Overnight before 10:00”
PriceFirstKg=9.40
PriceAddKg=1.10

### Loss Alternative (Given by Competitive Positioning 240)

PriceFirstKilo=9.20
PriceAddKg=1.00

### Expression of the Deterministic Utilities for the Given Client:

Alternative #1 corresponds to the offer instance and the alternative #2 to the Loss.

$$\begin{matrix}{V}_{1 n} = {β}_{0} + {\sum }_{k = 1}^{7} {β}_{k} \cdot {Industry}_{kn} + {α}_{1}^{1} \cdot {PriceFirstKg}_{1} + {α}_{2}^{1} \cdot {PriceAddKg}_{1} & ( 7 ) \\ {V}_{2 n} = {α}_{1}^{2} \cdot {PriceFirstKg}_{2} + {α}_{2}^{2} \cdot {PriceAddKg}_{2} \\ {V}_{1 n} = - 8.73 + 2.68 - 1.57 * 9.40 - 4.65 * 1.10 \\ = - 25.923 \\ {V}_{2 n} = - 1.98 * 9.20 - 5.71 * 1.00 \\ = - 23.926 & ( 8 )\end{matrix}$$

### Expression of the Win Probability:

$$\begin{matrix}{P}_{n} ( Offer \vert \{ Offer , Loss \} ) = \frac{{e}^{{V}_{1 N}}}{{e}^{{V}_{1 n}} + {e}^{{V}_{2 n}}} \\ = \frac{{e}^{- 25.923}}{{e}^{- 25.923} + {e}^{- 23.926}} \\ = 12 \%\end{matrix} \qquad ( 9 )$$

If the Choice Model is not activated for the current segment, then step 2 is skipped.
Step 3: If Prediction.Analyst is not “Null” (indicating that the analyst has entered an override) and if the override is a unique value then Forecast.Actual is loaded with this value and Forecast.Origin is set to “O”. Else, if it is a range of authorized values, then Forecasting 250 compares the value of Forecast.Actual with this range denoted [Min,Max]:
   If Forecast.Actual is in [Min,Max] it remains unchanged
   If Forecast.Actual<Min, then Forecast.Actual is loaded with the Min value and Forecast.Origin is set to “O”.
   If Forecast.Actual>Max, then Forecast.Actual is loaded with the Max value and Forecast.Origin is set to “O”.

At the end of step 3 the properties of the Forecast object may remain set to “Null” indicating that there is no probability of choice defined for this offer instance.

6E-ii. Forecasting in Case of Sequenced Offers (Ex: Business Case #2)

The process depends on the Forecast Mode (Simple Forecast Mode or Expert Forecast Mode).

Simple Forecast Mode

In the simple mode, the offers are assumed to be independent: proposing a given offer before the other does only influence the keep and the loss probabilities and not the choice probability of the following offers in the sequence. In order to find the best sequence, Forecasting 250 begins by recommending the offer with the highest expected value, then the second one and so on. Offers are considered one by one and no combination is taken into account. The size of the prediction and forecast objects is then equal to the number of candidate offers.

Forecasting 250 proceeds like in the instantiated offer case.

Expert Forecast Mode

In the expert mode, Forecasting 250 tests all possible sequences. In the case of an important number of candidate offers, Forecasting 250 begins by reducing the number of offers to take into account for building the sequences. The criteria of pre-selection is the win probability (offer versus the Loss alternative).

The K offers with the highest Win Probability will be pre-selected, where K is the Max Combined Offers parameter entered by the analyst (necessarily greater than J, number of proposed offers). When the number of candidate offers is lower than K no pre-selection is needed.

The new list of candidate offers is denoted the “Restricted List”.

Forecasting 250 proceeds as follows for each candidate offer in the candidate list:
Step 1: It creates three new objects containing offers predictions: OfferForecast.Actual, OfferPrediction.Historical and OfferPrediction.Analyst. These objects size is the number of candidate offers. They are first set to “null”. CCRM Optimizer accesses the Prediction tables and loads in OfferPrediction.Historical and OfferPrediction.Analyst, the win probabilities by offer.
Step 2: If the choice model is activated, then OfferForecast.Actual is loaded with the results of the win probability calculated by applying the model retrieved from the Choice Model to the choice set limited to the given offer and the Loss alternative. Else, OfferForecast.Actual is loaded with OfferPrediction.Historical.
Step 3: if the value of OfferPrediction.Analyst is different from null, then the value of OfferForecast.Actual is overridden with this value.
Step 4: the K offers that have the highest values in OfferForecast.Actual are retrieved. The restricted list is created.
Step 5: Forecasting 250 lists all the possible sequences (ordered combination of the different candidate offers within the restricted list) containing at most J offers.
The aim of CCRM Optimizer is to test all these sequences by calculating the value of the choice probabilities of each offer in case of submission of the sequence to the customer (the calculation of the expected value by sequence is then possible—reference Scoring 270).
The number of possible sequences is the total number of ordered combinations of offers in the restricted list. Two sequences are considered different if they contain the same offers but in a different order, or if they have a different length.
For example if there are three candidate offers (K=3) and 3 alternatives to propose (J=3), CCRM finds all possible sequences composed by: one to three offers among a set of three offers {O1,O2,O3}
Theses sequences are:
   Sequences with one offer: (O1), (O2) and (O3)
   Sequences with two offers: (O1→O2), (O1→O3), (O2→O1), (O2→O3),(O3→O1) and (O3→O2)
   Sequences with three offers: (O1→O2→O3), (O1→O3→O2), (O2→O1→O3),(O2→O3→O1),(O3→O1→O2) and (O3→O2→O1)
The number of possible sequences is the total number of ordered combinations (3,p) for p=1,2,3. Here it's 3+6+6=15 possible sequences.
The figure FIG. 5 presents an illustration of all possible sequences in the case of three offers O1, O2 and O3. The first level corresponds to sequences containing only one offer, the second level for sequences with two offers and the last level for sequences with 3 offers.
It is important to note that for a given sequence, after presenting the last offer in the sequence, the alternative Keep is no longer available to the customer.
Generally the number of possible sequences containing j offers in a set of K offers is:

$$\frac{K !}{( K - j ) !} \qquad ( 10 )$$

So the total number of all possible sequences containing at most J offers is:

$${\sum }_{j = 1}^{J} \frac{K !}{( K - j ) !} \qquad ( 11 )$$

At this stage, prediction and forecast objects with size being equal to Formula (11) are created with “null” values.
Steps 6 to 8 are then executed for each considered sequence:

We will now assume that the choice model is activated
Step 6: Forecasting 250 accesses the Prediction tables in order to load Prediction.Analyst, Prediction.Historical objects as well as a new forecasting object SACSLPrediction.Analyst (SACL stands for “Sequence Associated Choice Set List”) which will contain the Analyst overrides by Sequence Associated Choice Set or “null” if no override has been entered by the Analyst. Prediction.Analyst and Predicion.Historical contain the choice probabilities of each offer in case of submission of the sequence to the customer. Forecast.Historical is loaded with Prediction.Historical and Forecast.Origin is set to “R”.
Step 7: Then Forecast.Actual and Forecast.Model will be loaded with the result of the probability calculated using the following method and the Forecast.Origin is set to “M”. Forecasting 250 calculates all the choice probabilities (Loss probability, Keep probability and probability of choosing a given alternative) in order to estimate the outcome of the considered sequence.
The sequence is divided in sub-sequences. Each sub-sequence corresponds to a choice situation and a given choice set. The outcome probabilities of the sequence are directly related to probabilities of the sub-sequences.
Assuming that choices are independent (a choice in a given sub-sequence doesn't influence the future choices in the sequence), the probability of choosing an offer Oj at the end of the sequence is the product of:
   The probability of choosing Oj in the choice set corresponding to the last sub-sequence (including the Loss alternative without the Keep alternative) and;
   The probabilities of choosing the Keep alternative in the choice set corresponding to each previous sub-sequence (including the Loss and the Keep alternative)
For example considering the sequence (O2→O1→O3) which is equivalent to:
   Presenting first O2: first sub-sequence is related to the choice set: {O2,K,L} which outcome should be K to continue the sequence;
   Then presenting O1: second sub-sequence related to the choice set: {O2,O1,K;L} which outcome should also be K;
   Finally presenting O3: third and last sub-sequence related to the choice set {O2,O1,O3,L}. There is no Keep alternative here because no more offers are presented.
The outcome probabilities of the sequence (O2→O1→O3) are:

P(O1|O2→O1→O3))=P(K|{O2,K,L}).P(K|{O2,O1,K,L).P(O1|{O2,O1,O3,L}) (12)

P(O2|O2→O1→O3))=P(K|{O2,K,L}).P(K|{O2,O1,K,L).P(O2|{O2,O1,O3,L}) (13)

P(O3|O2→O1→O3))=P(K|{O2,K,L}).P(K|{O2,O1,K,L).P(O3|{O2,O1,O3,L}) (14)

P(L|(O2→O1→O3))=P(K|O2,K,L}).P(K|{O2,O1,K,L).P(L|{O2,O1,O3,L}) (15)
For each Sequence Associated Choice Set, if there is a “null” in the SACSLPrediction.Analyst, the choice model is used to calculate the conditional probability. Else the Analyst Override is used and the Forecast.Origin is set to “O”.
Step 8: Finally, for a given sequence, if Prediction.Analyst is different from “Null” and contains fixed override values then Forecast.Actual is loaded with Prediction.Analyst and Forecast.Origin is set to “O”. If the Prediction.Analyst contains a range of override values [Min,Max] then:
   If Forecast.Actual is in [Min,Max] is remains unchanged
   If Forecast.Actual<Mill, then Forecast.Actual is loaded with the value Min and Forecast.Origin is set to “O”.
   If Forecast.Actual>Max, then Forecast.Actual is loaded with the value Max and Forecast.Origin is set to “O”.

If the choice model is not activated, the 5 first steps are the same as well as the 8th
Steps 6 and 7 are then executed for each considered sequence:
Step 6: Two new forecasting objects (1) SFCSPrediction.Analyst (Sequence Final Choice Set that will contain all the offers of the sequence in addition to the Loss alternative) that will contain Analyst overrides by Sequence Final Choice Set or “null” if no override has been entered by the Analyst; and (2) KeepPiohabilities.Analyst that will contain the probabilities of the Keep alternative given the sequence step (see CCRM Analyzer) are created. Forecasting 250 accesses the prediction database. It loads Prediction.Analyst, Prediction.Historical objects, SFCSPrediction.Analyst and KeepProbabilities.Analyst. Prediction.Analyst and Predicion.Historical contain the choice probabilities of each offer in case of submission of the sequence to the customer. Forecast.Historical is loaded with Prediction.Historical.
Step 7: If Prediction.Analyst is different from “null” then Forecast.Actual is loaded with this value and Forecast.Origin is set to “O”. Else, if Prediction.Historical is not equal to “null” then Forecast.Actual is loaded with the value of Prediction.Historical and Forecast.Origin is set to “R”.
Else, if there is no analyst prediction and no historical prediction, CCRM Optimizer considers the value of SFCSPrediction.Analyst. If it is “null”, it means that there is no prediction on the final choice set and then Forecast.Actual is set to “null”.
When the value of SFCSPrediction.Analyst is not “null”, CCRM Optimizer calculates the probability of choosing a given offer given the order of the sequence using the following formula (we suppose here that there are O1, . . . , OP offers in the sequence).

$$P ( Oj \vert sequence ) = {\prod }_{l = 1}^{P - 1} {P}_{l} ( K ) \cdot P ( Oj \vert \{ O 1 , O 2 , … , OP \} ) \qquad ( 16 )$$

The Pₗ(K) are the probabilities of the Keep option, given the order l of presentation of offers in the sequence, that are contained in the KeepProbabilities.Analyst object. These probabilities are assumed to be independent of the offers (see Analyzer section).
The P(Oj|{O1, O2, . . . , OP}) are the predictions contained in the SFCSPrediction.Analyst. Forecast.Actual is set with the values of the probabilities given by the formula (16) for each offer.

6E-iii. Forecasting in Case of Simultaneous Offers (Ex: Business Case #3)

In case of a Simultaneous Sale Mode, the offers are proposed at the same time to the customer. Then, the aim of CCRM Optimizer 200 is to find the optimal combination of offers to propose to customer. The process depends on the used Forecast Mode (Simple Forecast Mode or Expert Forecast Mode).

Simple Forecast Mode

In order to find the best combination of offers to propose (choice set), Forecasting 250 proceeds like in the instantiated offer case. It calculates offer by offer, the win probability of the offer (against the Loss) and recommends the set containing the J offers with the highest Expected Value.

Expert Forecast Mode

In this mode, Forecasting 250 tests all possible choice sets (combinations). If the parameter Include Subsets is equal to “Yes” then, the choice sets tested are all choice sets containing at least one offer and at most J offers. If this parameter is set to “No” then the choice sets tested are only choice sets containing exactly J offers. In the case of an important number of candidate offers, Forecasting 250 begins by reducing the number of offers and builds the Restricted List (same steps 1 to 4 than the case of sequenced offers).

In order to be general and treat the case of Include Subsets=“Yes” and “No”, let's denote j the number of offers in the choice set. If Include Subsets=“Yes”, j may be any number between 1 and J and in case of Include subsets=“No”, j is necessarily equal to J. In both cases Forecasting 250 considers all possible choice sets containing j offers (for every possible value of j).

So in both cases for every possible value of j:
Step 5: Forecasting 250 lists all possible combinations containing j offers from the restricted list containing K offers. A combination is an unordered set containing j elements among the biggest set containing the K offers.
The aim is to test all these combinations by calculating the choice probabilities of each offer in the given choice set (the calculation of the expected value by sequence is then possible—refer to Scoring 270).
The number of possible combinations (j,K) is given by the formula:

$$\frac{K !}{j ! ( K - j ) !} \qquad ( 17 )$$

For example if K is equal to 5 offers {O1,O2,O3,O4,O5} and j is equal to 3, CCRM finds all possible combinations of 3 offers from 5 offers. The number of possible combinations is:

$$\begin{matrix}\frac{5 !}{3 ! 2 !} = \frac{1 \cdot 2 \cdot 3 \cdot 4 \cdot 5}{1 \cdot 2 \cdot 3 \cdot 1 \cdot 2} \\ = \frac{4 \cdot 5}{2} \\ = 10\end{matrix}$$

These combinations are: {O1,O2,O3}, {O1,O2,O4}, {O1,O2,O5}, {O1,O3,O4}, {O1,O3,O5}, {O1,O4,O5}, {O2,O3,O4}, {O2,O3,O5}, {O2,O4,O5} and {O3,O4,O5}. Forecasting 250 adds the Keep alternative to the related choice set of each possible combination.
At this stage, the prediction and forecast objects with size being equal to the number of possible combinations (ref formula 17) are created with “null” values.
Steps 6 to 8 are then executed for each considered choice set:

We will now assume that the choice model is activated
Step 6: Forecasting 250 accesses the prediction database in order to load Prediction.Analyst and Prediction.Historical objects. Prediction.Analyst and Predicion.Historical contain the choice probabilities of each offer within the choice set. Forecast.Historical is loaded with Prediction.Historical.
Step 7: Then Forecast.Actual and Forecast.Model properties will be loaded with the results of choice probabilities (for every offer in the choice set) calculated by applying the model retrieved from the Choice Model to the given choice set. The Forecast.Origin is set to “M”.
Step 8: Finally, if Prediction.Analyst is different from “Null” then the value of Forecast.Actual is loaded with Prediction.Analyst and Forecast.Origin is set to “O”. If Prediction.Analyst contains a range of authorized values and not a fixed value, CCRM operates the same way than in the two previous cases.

If the choice model is not activated, only step 7 changes and step 8 remains unchanged:
Step 7b is: Then Forecast.Actual is loaded with Prediction.Historical and Forecast.Origin is set to “R”.

### 7—Costing 260

Costing 260 calculates opportunity costs and incremental costs for each offer/offer instance that has been forecasted and will be scored by Scoring 270.

### 7A—Calculation of Opportunity Costs

We assume that CCRM is connected with a RMS providing bid prices for each resource corresponding to the potential offers.

Refer to Glossary for the definition of Opportunity Costs and Bid Prices.

(1) Case of an Enterprise Selling Products with No Substitution (Buy-Up/Recapture) Effects.

The Opportunity cost of product (i,j)—where index i represents the resource and index j the fare—is equal to the marginal expected revenue from the last product allocated to the resources available. In this case the two concepts of opportunity cost and bid price are equivalent and we obtain:

OC_{i,j}=BP_{i,j}=PR_{i,j}*MD_{i,j} (18)

where:
PR_{i,j} is the price of product i,j
MD_{i,j} is the marginal demand probability for the last unit of inventory

When different products (for example different fare classes j, j−1) “pull” on the same resources, the bid price could correspond to the allocation of different products with different prices and probabilities.

Example for Business Case #3. Let us consider the three different fare products that share the same inventory of flight SW001 (here indexed by i=1) whose capacity is limited to 200 seats. Fares are indexed by j=1 to 3. Let us assume that the prices PR and marginal demand probabilities MD are the following for the last unit of inventory allocated to each fare class:

| | | |
|---|---|---|
| PR_{1,1} = $99 | MD_{1,1} = 50.0% | PR_{1,1} * MD_{1,1} = $49.5 |
| PR_{1,2} = $69 | MD_{1,2} = 71.7% | PR_{1,2} * MD_{1,2} = $49.5 |
| PR_{1,3} = $39 | MD_{1,3} = 100% | PR_{1,3} * MD_{1,3} = $39 |

The bid price is equal to $49.5 and can be obtained by the sale of either:
1 unit of product 1,1 valued $99 having a marginal demand probability of 50.0%
1 unit of product 1,2 valued $69 having a marginal demand probability of 71.7%

However, as its price is inferior to the bid price, product 1,3 will not be available in this case.

(2) Case of an Enterprise Selling Portfolios of Products with Possible Substitution Effects (Buy-Up/Recapture)

The formulation of the opportunity cost OC_{i,j} of a product (i,j) is more complex due to the fact that some requests for product (i,j) which might potentially not be served in the future due to limited capacity might be satisfied (and not lost) with other substitutable products (k,l). For a given product (i,j) let's denote Φ_{i,j} the set of all products (with fare j available for future sale/booking time) sharing at least one resource with (i,j) including (i,j) itself. We exclude from Φ_{i,j} products whose prices are lower than the bid price BP_{i,j} at the time of the transaction.

The opportunity cost of selling the product (i,j) is then:

$${OC}_{i , j} = {BP}_{i , j} - {\sum }_{k , l ∈ {Φ}_{i , j}} {PD}_{k , l} * [ \begin{matrix}{\sum }_{{m , n ∈ {Ω}^{⋆}}_{m , n \neq k , l}} {RE}_{( k , l \to m , n )} * \\ {PR}_{m , n} * {AR}_{( m , n \vert k , l )}\end{matrix} ] \qquad ( 19 )$$

### Where:

BP_{i,j} is the bid price calculated by the Revenue Management system based on an assumption of independent demand for each fare product and no substitution (buy-tip/recapture) effects.
PD_{k,l} is the probability that the future marginal demand that would be “displaced” in case of sale of product (i,j) concerns a given product (k,l) in Φ_{i,j} sharing at least one resource with product (i,j). This probability distribution PD describes the profile of the “average marginal sale” that would be displaced might the current transaction be accepted. This probability PD_{k,l} could be calculated as the frequency of the marginal demand MD_{k,l} (provided by the RMS) for product k,l given the marginal demand for the other products (m,n) in the set Φ_{i,j}:

$${PD}_{k , l} = \frac{{MD}_{k , l}}{{\sum }_{m , n ∈ {Φ}_{i , j}} {MD}_{m , n}} \qquad ( 20 )$$

Ω* is the list of products m,n substitutable to k,l
RE_{(k,l}_{_{→}}_{m,n)} is the recapture (or buy-up) rate between product (k,l) and a substitute product (m,n). It is calculated based on the Recapture model (refer to Substitution Modeler 430).
PR_{m,n} is the price of product (m,n)
AR_{(m,n|k,l)} is the forecasted Availability Rate of product (m,n) given the known arrival distribution of demand for product (k,l) and the expected availability curve of product (m,n) depending on time. These two elements, necessary for the calculation of the Availability Rate, are provided by the RMS as shown in the following example.

In the formulation of the opportunity cost here above, we have made the assumption of only “1^{st} round” recapture, meaning that a customer request that is denied for product (k,l) can be recaptured on another product (m,n) but if it is denied a second time for the request on (m,n) then the sale is definitely lost.

To illustrate the calculation Of Opportunity Cost, consider Business Case #3.

The following fare products share the same inventory of flight SW001 (indexed i=1):

| | | |
|---|---|---|
| PR_{1,1} = $99 | MD_{1,1} = 50.0% | PR_{1,1} * MD_{1,1} = $49.5 |
| PR_{1,2} = $69 | MD_{1,2} = 71.7% | PR_{1,2} * MD_{1,2} = $49.5 |
| PR_{1,3} = $39 | MD_{1,3} = 100% | PR_{1,3} * MD_{1,3} = $39 |

Now we consider, in the case of rejection of the request on a given fare class of flight SW001, the “marginal Customers” that Would be recaptured either on same flight SW001 in another class or on next flight SW003 (indexed i=2) and assume the following recapture coefficients (provided by Substitution Modeler 430):
RE_{(1,1}_{_{→}}_{2,1)}=0.20 (flight to next flight recapture for fare F1)
RE_{(1,2}_{_{→}}_{1,1)}=0.15 (buy-up in same flight from F1 to F2)
RE_{(1,2}_{_{→}}_{2,2)}=0.30 (flight to next flight recapture for fare F2)
The Bid Price is equal to $49.5, so only fares 1,1 and 1,2 are available.
We assume that all other recapture rates are equal to zero meaning that if a request cannot be served, then it is lost.
   Prices on flight 2 are:
PR_{2,1}=$89
PR_{2,2}=$59
PR_{2.3}=$29

In case of sale of product (1,2), the set Φ_{1,2} contains only products (1,2) and (1,1). The product (1,3) is not considered because it is not available (price lower than the Bid Price).

The opportunity cost attached to product 1,2 is in application of Formula (19):

OC_{1,2}=BP_{1,2}—PDI,L R E(I,I-)₂,I)* PR₂,₁* AR(2,1 11,I)i - PDi,₂*[RE(1,₂ I,)* PRI,L* AR(,,₁ 11,2)+RE(1,₂-)₂,₂) PR₂,₂*AR(₂,_{21 1,2}) (21)

In this formula:
BP_{1,2}=$49.5 is the bid price calculated by the RMS with the assumption of independent demand and no substitution of products.

PD_{1,1}=MP_{1,1}/(MP_{1,1}+MP_{1,2})=50.0%/(50.0%+71.7%)=41.2%

PD_{1,2}=MP_{1,2}/(MP_{1,1}+MP_{1,2})=71.7%/(50.0%+71.7%)=58.8%
AR(1,1|1,2) is assumed to be equal to 80% because product 1,1 is expected to be closed at 5 days before departure, whereas 80% of the demand for product 1,2 arrives before that relative date.
AR(2,2|1,2) is assumed to be equal to 40% because Product 2,2 is expected to be closed at 10 days before departure whereas 40% of the demand for product 1,2 arrives before that relative date.
AR(2,1|1,1) is assumed to be equal to 100% because product 2,1 is expected to remain available until day of departure.

### Then:

$$\begin{matrix}{OC}_{1 , 2} = {BP}_{1 , 2} - {PD}_{1 , 2} * [ \begin{matrix}{RE}_{( 1 , {2}_{\to } 1 , 1 )} * {PR}_{1 , 1} * {AR}_{( 1 , 1 \vert 1 , 2 )} + \\ {RE}_{( 1 , {2}_{\to } 2 , 2 )} * {PR}_{2 , 2} * {AR}_{( 2 , 2 \vert 1 , 2 )}\end{matrix} ] - \\ {PD}_{1 , 1} * [ {RE}_{( 1 , {1}_{\to } 2 , 1 )} * {PR}_{2 , 1} * {AR}_{( 2 , 1 \vert 1 , 1 )} ] \\ = \$49 .5 - 41.2 \% * [ 0.20 * \$89 * 100 \% ] - \\ 58.8 \% * [ 0.15 * \$99 * 80 \% + 0.30 * \$59 * 40 \% ) \\ = \$31 .0\end{matrix}$$

The previous example, based only on direct flights, is a relatively simple illustration of formula (19). The calculation is more complex when origin and destination fare products share the same (flight) resources over a network with hub & spokes.

### 7B—Calculation of Incremental Cost

This procedure is performed in case of B2B contracts with recurring sales.

The Costing Engine supports the definition of:
Different cost categories;
Different costs types for each category;
Different cost models with different periods of application;
A cost model is defined at an offer level for the crossing of 0 to n Sales Profiles corresponding to registered Sales Cubes.
The cost model for a given cost type is related to one cost variable calculated for the Sales Cubes (example in Business Case #1: number of shipments, number of Kg). It is composed of a multiplier parameter which applies to the cost variable. Parameters may be set to vary for a given customer segment (The Costing Formula).

In order to calculate the Incremental cost of a given B2B contract implying recurring sales, Costing 260 sends to the Costing Engine:
The Sales Profiles described in the optimization request message/object (see example in Business Case #1)

The Cost Engine calculates the expected incremental cost from the Contract as follows:
First, the reference Sales Cube is found (refer to Transaction Manager 100 step 6)
Then the Sales Profile is disaggregated using the reference Sales Cube;
The costs variables are then used for each cell of the Sales Cube to apply the Costing Formula;
The found costs are then aggregated across the cells of the Sales Cube for the different cost types to obtain the incremental cost.

Remark: in cases of “spot” transactions, when the incremental cost is well specified by Transaction Manager, this procedure 7B is not invoked.

The results of procedures 7A and 7B are loaded in Cost Objects for each offer/offer instance.

### 8—Scoring 270

Scoring 270 receives as an input the Forecast Objects (results of Forecasting 250) containing for each offer/offer instance/offer set/offer sequence the choice probabilities as well as the Cost Objects (results of Costing 260) containing for each offer/offer instance the incremental and opportunity costs.

Scoring 270 then proceeds as follows:
It reads the Strategies & Parameters (step 8A)
It calculates the Value of Learning (Vol) associated to each offer or offer instance, if the VOL strategy is activated (step 8B)
It calculates the Value, Expected Value and the Score of each offer instance (step 8C)
It selects the offers to be presented to the customer and their order of presentation, i.e. display or sequence order (Step 8D)

### 8A—Read Strategies & Parameters

The Strategies & Parameters tables are first accessed to retrieve the strategies and parameters defined for the Current type of offer and the current segment.

The two basic strategies applied by CCRM Optimizer are:
Maximize Expected Value [conditional to minimum conversion probability]—see definition of Value here-after;
Maximize Conversion Probability [conditional to minimum value].

In the case of Sequenced Offers, a minimum conversion probability can also be set by sequence order. Example: 30% for first offer presented, 50% for second offer presented . . . .

Refer to Set Strategies & Parameters 280 for the definition of CCRM Optimizer parameters and strategies.

### 8B—Value of Learning

The Value of Learning functionality aims to present to customers, on a reduced scale, offer/offer instances/offer sequences/offer sets that are not optimal in terms of maximum expected value or maximum conversion rate. Indeed if “non optimal” offers are never presented it will not be possible to evaluate their choice rate and model their choice probability. Value of Learning thus permits to guarantee minimum levels of exposure for these offers.

The way Value of Learning proceeds is as follows: the analyst can turn-on, at a segment level, an information function “Info” for each offer/offer instance/offer set/offer sequence (“offer”). A simple formulation of the information function is for example:

Info(offer)=Min(ActExp(offer)/EXP_MIN,1) (22)

where:
ActExp(offer) is the number of exposures (or percent of total exposures) recorded for the offer/offer instance/offer set/offer sequence “offer” during a given period of time (ex: each week/month/quarter, last n weeks/months/quarters, year to date . . . ). Note: rolling periods can be used to ensure that offers are exposed up to a given level, on a continuous basis.
EXP_MIN is the minimum number of exposures necessary to obtain a reliable estimation of choice rates or choice probability.

Info(offer) is equal to 0 if the offer has not been exposed during the reference period and is equal to 1 if the offer has been exposed at the minimum level EXP_MIN.

The value of learning VoL(offer) of a given offer/offer instance/offer set/offer sequence (denoted offer) is defined as:

$$\{ \begin{matrix}VOL\_MAX + ( \begin{matrix}VOL\_MIN - \\ VOL\_MAX\end{matrix} ) * Info ( Offer ) & if 0 \leq Info ( offer ) < 1 \\ 0 & if Info ( offer ) = 1 \end{matrix} \qquad ( 23 )$$

where:
VOL_MIN is an analyst defined monetary [or multiplier] coefficient reflecting the “value” (versus offer prices) that the analyst grants to increasing the information function of an offer when Info=1).
VOL_MAX is an analyst defined monetary [or multiplier] coefficient reflecting the “value” (versus offer prices) that the analyst grants to increasing the information function of an offer when Info=0).

VoL(offer) is equal to VOL_MAX if the offer has not been exposed during the reference period and tends towards VOL_MIN if the offer has been exposed near the minimum exposure level EXP_MIN. Once this level is reached, Vol(offer) is equal to 0.

Remark: Vol( ) could be designed as an adder of value (then expressed in monetary terms, as in the previous definition) or as a multiplier of value.

CCRM Optimizer 500 also permits to set other control parameters for “non optimal” offers:
Frequency of Presentation (ex: 5%),
Max Number in Set (ex: 1),
Order in Sequence (ex: “2,3”).

For example the precedent parameters would mean that “non optimal” offers are computed and displayed:
In 5% of sessions drawn randomly;
Limited to 1 in each offer set,
In 2nd or 3rd positions in the sequence (never in 1st).

Remark: Step 8B is skipped if the Value Of Learning Strategy is not activated for the current category of offers and customer segment.

### 8C—Value, Score and Expected Value

8C-i. Value

The value of a given offer in a given offer set or offer sequence is defined as follows:

$Value(offer)=$Price(offer)+$AncRev(offer)−$IncCost(offer)−$OppCost(offer)+$VoL(offer) (24)

where:
$Price(offer) is the net price of the offer;
$IncCost(offer) is its incremental cost (if any) occurring in case of sale of the offer (refer to Costing 260);
$OppCost(offer) is the opportunity cost (if any) occurring in case of sale of the offer (refer to Costing 260);
$AncRev is the estimated ancillary revenue (if any) that will be collected as a result of the sale of the offer. Ancillary revenue may vary by offer (refer to CCRM Sales Monitor 500);
$VoL(offer) is the Value of Learning adder coefficient related to the offer, as calculated in step 8B if the VOL Strategy is activated. Remark: Value of Learning may also be defined as a multiplier applying to the terms of formula (24). In which case this formula is adapted consequently.

Incrementality: formula (24) can also be written introducing the Incrementality coefficient % IncVal(offer)

$$\$Value ( offer ) = \$Price ( offer ) * \% IncVal ( offer ) \\ with \\ \% IncVal ( offer ) = [ \begin{matrix}1 + \$ AncRev ( offer ) - \$ IncCost ( offer ) - \\ \$ OppCost ( offer ) - + \$ Vol ( offer )\end{matrix} ] / \$Price ( offer ) \qquad ( {24}^{′} )$$

Formula (24′) reflects the fact that two offers may, independently of their price, generate a different amount of additional revenue and support different costs, leading sometimes to reversing the order of price and value. Table 5 shows an example in Business Case #1. As shown, the value and price of the two offers are in reverse order.

TABLE 5
Incrementality
(Business Case #2 - Airline)

| | | Opportunity | | |
|---|---|---|---|---|
| Offers | Price | Cost | Incrementality % | Value |
| Flight 1, Fare 2 | $69 | $31 | 55.1% | $38 |
| Flight 2, Fare 2 | $59 | $12 | 79.7% | $47 |

8C-ii. Score

The score of an offer is an indicator, comprised between 0 and 100, reflecting its relative value for the Enterprise compared to other offers. Usually a score of 100 corresponds to the best possible offer for a given type of customer whereas a score of 0 will correspond to a worst scenario. CCRM Optimizer 500 enables the Analyst to set different formulas of score depending on the formulation of value (see hereabove) and the definition of price or profitability targets by customer segment. It is also possible (notably in B2B sales environments) to define internal price validation rules depending on the score.

The Score guides the Sales Execs and the call center agent in proposing the right offer to the customer. The score can also be used to estimate the sales performance of Sales Exec, Call Center agents and Partners and be integrated in their compensation and commissioning plans.

8C-iii. Expected Value

The Expected value of an offer/offer instance within a given offer set/offer sequence is defined as follows:

$ExpValue(offer)=$Value(offer)* % ChoiceProb(offer)*% RealRate(offer)−$AttPen(customer)*%LossProb(offer) (25)

where:
% ChoiceProb(offer) is the choice probability of the offer/offer instance in the offer set/offer sequence;
% RealRate(offer) is the realization rate of the offer. It reflects the probability of realization of the sale (after cancellation or modification). Refer to CCRM Sales Monitor 500.
$AttPen(customer) is the Attrition Penalty for the Enterprise in case of choice of the “Loss” alternative among the choice set/sequence by the customer. It reflects the sales potentially lost in the future if a repeat customer request is turned away due to offer availability or pricing. A turn-away can jeopardize, not only current profitability but also future profitability (guest life time value concept). $AttPen can be estimated by type of customer. Ex:
   $AttPen (if Customer is “Initiator”)=$ 0
   $AttPen (if Customer is “Repeater”)=$ 40
   $AttPen (if Customer is “Super Repeater”)=$ 80
% LossProb(offer) is the probability of choice of the “Loss” alternative if the related offer/offer set/offer sequence is proposed.

Two variants of formula (25) can be derived:

ExpValue(offer)=$Value(offer)*%SaleProb(offer)−$AttPen(customer)*%LossProb(offer) (26)

where:

% SaleProb(offer)=% ChoiceProb(offer)*% RealRate(offer)

and:

$ExpValue(offer)=[$Price(offer)*%IncValue(offer)*%SaleProb(offer)]−$AttPen(cust)*%LossProb(offer) (27)

### 8D—Selection and Ranking of the Offers

Scoring 270 ranks the offers according to the strategy (objective function and constraints) defined by the analyst for the type of offers and the segment. In order to detail the procedure we will distinguish three cases:
offer instances,
offer sequences,
offer sets.

8D-i. Case of Offer Instances

For each possible offer instance (K offer instances), Scoring 270 calculates the objective function (as described in step 8C) and verifies the constraints (ex: Choice probability>10%). Two types of constraints may be defined:
Hard Constraints: in this case an offer instance that does not satisfy the constraint is removed from the list and will not be presented to the customer,
Soft Constraints: in this case an offer instance that does not satisfy the constraint is not removed from the list but will be presented with lower priority.

The remaining offers are sorted by decreasing objective function.

8D-ii. Case of Offer Sequences

For each possible sequence (built with K offers), Scoring 270 calculates the objective function of each offer within the sequence (as described in step 8C) and verifies the constraints for each offer (ex: Choice probability>10%). Offer sequences with at least one offer that does not satisfy a Hard Constraint are removed from the list and will not be presented to the customer,

For each remaining sequence, an objective function is calculated as the Maximum of the objective functions of each offer in the sequence. Example (in the case of maximization of the expected value):

$ExpVale(O1→O2→O3)=Max[$ExpValue(O1),$ExpValue(O2),$ExpValue(O3)] (28)

The remaining offer sequences are then sorted by decreasing objective function. The sequence maximizing the objective function is selected for presentation to the customer.

8D-iii. Case of Offer Sets

For each possible set (containing a maximum of J offers built from potential K offers), Scoring 270 calculates the objective function of each offer within the set (as described in step 8C) and verifies the constraints for each offer within the set. Offer sets with at least one offer that does not satisfy a hard constraint are removed from the list of possible offer sets and will not be presented to the customer.

For each remaining set, the objective function is calculated as the Maximum of the objective function of each offer in the set. Example (in the case of maximization of the expected value):

$ExpValue({O1,O2,O3})=Max[$ExpValue(O1),$ExpValue(O2),$ExpValue(O3)] (29)

The offer sets are then sorted by decreasing objective function. The sequence maximizing the objective function is selected for presentation to the customer.

Note: If the SUBSET_ALLOWED parameter is set to “1” then Scoring 270 calculates the objective function for all subsets of the offer sets of J offers. This may result in selecting a reduced number of offers. For example in Business Case #3 it may happen for example that:

$ExpValue({O_{1,1},O_{1,2},O_{2,1}})>$ExpValue({O_{1,1},O_{1,2},O_{2,1},O_{2,2}}) (30)

### General Remark:

An hard constraint may be expressed as: $Value(offer)>0, meaning that offers whose value are negative (for example Price<Cost) will not be presented. An important application of this constraint is the case of travel operators with constrained inventories. As explained here-above, the RMS often calculates Bid-Prices that do not take into account substitution effects such as Recapture and Buy-up. For this reason the Bid Price may be over-estimated and in many cases the Availability Rule (Price>Bid Price) is too restrictive, which leads to closing certain offers which should have remained opened based on the criteria of opportunity cost. CCRM Optimizer 500 receives these offers with a special (“Virtual Availability Restriction”=1) and calculates their opportunity cost as defined in Costing 260. Then these offers could be displayed as available (if Price>OppCost) even if (Price<BidPrice).

### 9—Response Object/Message is Sent Back to Transaction Manager

Once the Scoring step is performed, Message Handler 210 compiles the results of CCRM Optimizer 200 and build a message/object that will be passed to Transaction Manager 100. Basically the Response Message contains the following data structured for example in an XML message:
Request Id
Session Id
Description of the applied Strategy, Constraints and Parameters
List of offers with primary attributes, sequencing order, choice probabilities, value, score (from 0 to 100 or through a star system * to *****, expected value.

### 10—Strategies & Parameters—280

The strategies, constraints and parameters supported by CCRM Optimizer are presented in the precedent steps 1 to 9. Remarks:
They may be specific to certain types of interactions. Examples
In post selling (including payment sessions);
Cross Sell strategy: find which complementary product/service is most likely to be purchased by the customer;
Up Sell: Propose a superior service/product for an additional price as a promotion;
A “Save The Sale” strategy may be used in case of order cancellation or modification (when the customer wants cheaper alternatives) in case of customer resistance at the end of a sales session. Strategy may be activated by the Sales Agent/Sales Exec in this case.
The strategies could be maintained by
Type of offer,
Segment (terminal leave or upper node of the segmentation tree);
Period (transaction or delivery) period.
They can be extended;
A segment can inherit strategies, constraints and parameters from another segment

### CCRM Analyzer 300

CCRM Analyzer 300 has five main functional blocks (1) Tree-Based Segmentation, (2) Reporting, (3) Prediction Management, (4) Alerts and (5) Performance Monitoring.

Tree-Based Segmentation 310

The segmentation process has two objectives. First, it aims to take into account heterogeneity of customers and group similar customers based on their expected choice behavior. The purpose is to find a tree based segmentation using customer related variables that influence their choices so that segments would be homogeneous and contain customers having a similar choice behavior. The customer related variables include the customer's characteristics, his preferences and his requirements. Preferences and requirements are considered here as variables permitting to describe the customer and will be referred also as “customer characteristics”. An asymmetric tree structure is adopted because it provides the following advantages:
it is intuitive and very easy to understand,
it provides an incremental segmentation approach,
analyses can be performed, models can be calibrated and predictions can be defined either for each terminal leaf of the tree and for the upper nodes as well. The reason to consider upper nodes is that sometimes, especially in the case of new customers, some customer characteristics used in the segmentation may not be known and it is then impossible to assign a terminal leaf of the tree but only an upper node/segment to the transaction. In this case, CCRM applies the prediction/model related to an upper segment.

Second, the segmentation permits to control the size of the dataset in terms of number of transactions used for the analysis and the modeling. The issue of the dataset size is critical for choice modeling—refer to CCRM Modeler 400. However the adequate number of transactions for modeling is not straight-forward to define because many issues come into play and notably the type of model used, the choice variables used, the homogeneity of customers in terms of preferences. A last issue is computation time: even if a large choice dataset permits to enrich the model, it increases computation time and sometimes it is even impossible to find a solution for the Maximum Likelihood—refer to CCRM Modeler 400. For robust quantitative modeling, a minimum of 100 customers in the dataset is generally needed, but the size of required data grows with the number of parameters to estimate in the model. Taking into account all these observations, the optimal dataset size may range from 100 to 1,000 transactions/customers for a given segment In CCRM Analyzer 300, a “Primary Segmentation” is imposed by the analyst using Tree-Based Segmentation 310. This is achieved by the analyst on the basis of its intuitive inference of customer choice behavior (“analyst priors”) with the help of Reporting 320.

CCRM Modeler Choice-Based Segmentation 420 procedure could then be used to validate and refine automatically this segmentation. The introduction of a primary segmentation is necessary for two reasons: (i) in order to reduce the size of the dataset used in the modeling and (ii) in order to be able to assign at least a high level segment to each customer in the case of missing characteristics.

### 1—Segmentation Configuration

The analyst defines incrementally a segmentation using an asymmetric tree structure. At each node/level, a unique customer characteristic is chosen as sub-segmentation criteria. FIG. 6 presents an example of segmentation user interface for Business Case #1 (express delivery contracts). As depicted in FIG. 6A, a selection box displays the list of customer characteristics including preferences and requirements. The analyst chooses one of these characteristics as “splitting criteria”. The chosen characteristic will be used to build the first level of the segmentation. This variable can either be discrete or continuous. A discrete variable may be of type “static” (with a pre-defined list of fix values) or “dynamic” (with values that may be updated automatically). In the case of a continuous characteristic, the analyst defines the breakpoints permitting to split the variable. In this way, he defines the categories of the given variable. If he introduces p breakpoints, p+2 categories are created corresponding to the p+1 intervals: [min, 1^{st} breakpoint], [1^{st} breakpoint, 2^{nd} breakpoint], . . . , [p^{th} breakpoint, max] and a “no reference” category which will contain all customers with missing values for the considered characteristic. When the analyst submits the breakpoints, the constructed categories are displayed. In FIG. 6B the selected characteristic is “SHP/Month” which is the number of shipments sent by month. If the analyst defines two breakpoints (for example 1.000 and 2.000), then four categories are created as shown in FIG. 6C. In case of a discrete variable, the resulting categories are immediately displayed. In both cases, the resulting categories may be used directly as sub-segments or some of them may be grouped together in “sub-segments”. To that end, the analyst creates new sub-segments by entering their numbers and names as described in FIG. 6C where three sub-segments are created (“Top”, Medium” and “Small”). To finish with this level of segmentation, the analyst assigns to each category of the splitting characteristic a sub-segment-with a selection list (FIG. 6D).

The previous procedure called “Sub Segmentation Map” may be stored in order to be re-used at any other node of the Tree. For each node, the analyst can continue the sub-segmentation using the procedure described above with any remaining characteristic. Note that the segmentation tree may be asymmetrical with deeper and/or more detailed specification of certain parts of the structure according to the number of customer/transactions enumerated by CCRM at each node. An example of Tree resulting from the segmentation is presented in FIG. 6E. The user can navigate within the tree by unfolding/folding the different nodes and select a given leaf or an upper node of the structure. The name of the leaf or upper node is then displayed with the number of customers found in the segment (see here-after). The number of leaves and upper nodes is also displayed.

The number of segments to build could typically vary from less than ten to thousands depending on CCRM embodiment. The following parameters must be considered in practice
Number of transactions (per week, per month . . . ),
Prediction frequency (weekly, monthly . . . ).

The objective is to obtain between 100 and 1,000 customers/transactions per segment for a reference transaction period defined by the analyst. For example in the case of a merchant web site we may have as much as 100,000 transactions per week for a given product category. In order to obtain an average number of 500 customers per segment we must then consider approximately 2,000 segments. It shall be noted that this number of segments could be obtained at the third level of a segmentation procedure using three sub-segmentation characteristics consequently with respectively 10, 10 and 20 categories per node at each step.

### 2—Storage of the Tree in the Segments Tables

Once defined, the segmentation tree is stored in the Segments Tables. It is possible to define different segmentation trees that may for example correspond to product categories, types of interactions (ex: Shopping/booking, Payment, Modification of order/booking, Cancellation Recovery . . . ), customer categories (ex: Intenders, Repeaters, Super-repeaters . . . ), distribution channels . . .

A segmentation tree is defined by its nodes (upper nodes and leaves). For each node the following information is stored in the Segment Tables (non exhaustive list of data)
node id: the unique reference of the node;
structure id: the unique reference of the segmentation tree;
parentId: the unique reference of the parent node;
bMethod id: the unique reference of the sub-segmentation method applied at this node (in case of upper nodes only). Each bMethod corresponds to a customer characteristic defined in the CCRM repository. It may be of type discrete static, discrete dynamic or continuous. It may use a dynamic retrieval function able to calculate the value of a customer characteristic “on the fly” (ex “effective Nb of Shipments by Month” in Business Case #1);
nodevalues: the list of values or breakpoints separated by a delimiter.

### 3—Segment Assignment

During CCRM Optimizer process and during the loading of the Transaction Tables (see Transaction Manager), each customer is identified and a segment is assigned to the customer. In case of modification of the segmentation posterior to the loading of the Transaction Tables, a re-segmentation procedure may be launched to re-assign customers to segments. This procedure may also be invoked in order to display statistics (number of customer/transactions per node) in the segmentation user interface.

The Segment Assignment procedure uses the Tree Structure as previously defined to generate bytecode on the fly. CCRM uses code generation in order to improve performance by avoiding the use of the (java/C++) Reflection mechanisms when invoking bMethods. For each customer in the Customer Tables, the tree structure, loaded into memory, is explored starting from the root node (with parent id=null), in order to find the correct child node. The bMethod defined for the node is used to retrieve the value of the corresponding customer characteristic. This value is compared with the nodevalues defined for each (child) node corresponding to the (parent) node in order to find the adequate child node, and so on.

Reporting 320

Reporting 320 accesses the Segments Tables, the Customers Tables, the Offers Tables, the Transaction Tables, the Strategies Tables and, if these Tables are part of CCRM embodiment, the Realization Rates Tables and the Ancillary Revenue Tables in order to help the Analyst to analyze customer purchasing behavior, offering performance and define and improve segmentations, offerings and strategies.

### 1—Flexible OLAP Reporting

Reporting 320 uses sate-of-the-art On-Line-Analytical Processing (OLAP) functionalities to analyze data contained in CCRM Database. It uses segmentation trees to filter customers and provides reports across different dimensions with filtering, sorting, aggregation and drill-down capabilities. Different types of reports are available depending on the implementation such as, for example:
Analysis of customer needs/preferences collected through Transaction Manager 100 A simple example being the stated preference by customers for a given attribute such as Collection Time (Business Case #1), Resort (Business Case #2), or Time of Departure (Business Case #3) including the “No preference” statement.
Analysis of sales performance by offer (exposures, sales, conversion rates) depending on user stated preferences. For example (Business Case #2): Which offers were the most proposed and accepted by customers depending on their stated Preferred Resort?
Trend Analysis showing the historical evolution of key performance variables—such as exposures, sales, revenue, price, conversion rate . . . depending on transaction period (with a flexible granularity: year, semester, quarter, month, week or day).
Time Variation Analysis showing the evolution of key performance variables—such as exposures, sales, revenue, price, conversion rate . . . depending on time of delivery of the product/service (with a flexible granularity: year, semester, quarter, month, week or day).
Top offers/offer sets/offer sequences in terms of exposures, sales, exposure rate, choice rate . . . as well as less performing ones.
Frequency of number of offers proposed per transaction, win rate and keep rate at each step of the sequence (for sequenced offers).
Frequency of application of sales strategies (see CCRM Optimizer 200)

Additional OLAP functionality could be configured at CCRM installation time based on the different data objects stored in the CCRM Database.

### 2—Performance View

Reporting 320 “Performance View” provides a capability for a structured and systematic analysis of offering performance by segment.

The Analyst selects the category of offers to be analyzed. Then, he selects a customer segment by choosing a leaf or an upper node in the segmentation tree and a Transaction Period that could be either a year, a semester, a quarter, a month, a week, a day or another period defined by a begin date and an end date. He can also set a filter in terms of minimum number of exposures (or exposure rate): in such a case only offers [instances/sequences/sets] with exposures superior to that minimum will be considered in the analysis. He may also define a reference period to be used as baseline for comparison.

Example (for Business Case #2—sequenced offers). The analyst selects
Offer Category=“Ski Holiday Packages”
Stay Period=“School Holidays 2006” and Reference Period=“School Holidays 2005”
Segment=“Preferred Resort=Punta Magna Three Star Hotel”
Transaction Period=”4^{th} Quarter 2005” and Reference Period=4^{th} Quarter 2004”
Offer sequences with more than “5” Exposures for the chosen segment

CCRM Analyzer then accesses the Offers Database, the Customer Tables and the Transaction Tables and retrieves the list of corresponding transactions. It summarizes the information by offer instance/sequence/set as defined in the example shown in Table 7 (“Performance View”)

### Comments and Options:

Offer instance/sequence/set. Each line shows the statistics related to a given offer instance/sequence/set. In this case the first line can be read as follows: the offer sequence O2→O2 has been presented 285 times, resulting in 108 sales of offer O1 or offer O2.
Supersets/super-sequences. In the case of sequenced or simultaneous offers, if the option “Include Supersets” is activated by the Analyst, the displayed statistics will include all sequences/sets containing the given sequence/set as sub-set/sequence. In this case, each offer sequence is displayed in the table with an ending arrow sign (ex: “O1→O2→”) and each offer set is displayed with an ending “ . . . ” sign (ex: “{O1,O2 . . . }”). For example in the case of “O1→O2→”, the offer sequences considered in the statistics include O1→O2, O1→O2→O3 . . . .
The Choice Rate column may be complemented by two other columns (if such data is available—See CCRM Sales Monitor—: “Realization Rate” and “Sell Rate” (Sell Rate=Choice Rate*Realization Rate).
Sorting. Offers may be sorted by Exposures, Choice/Sell Rate, Value or Expected Value by clicking on the corresponding column header.
Value may be calculated either based on “Revenue” or “Contribution Margin” depending on the applicable strategy (refer to CCRM Optimizer 200). Value could incorporate Ancillary Revenue as well (refer to CCRM Sales Monitor 500).
Expected Value is equal to Choice Rate*Value (or Sell Rate*Value if Realization rate is considered). It measures the performance or the offer [instance/sequence/set] (refer to CCRM Optimizer 200).
Trend Icons “ [symbol] ” and “ [symbol] ” following each numerical value indicate a significant gap (above or below analyst defined parameters) between the value calculated for the reference period and the value calculated for the selected transaction period.
Trend column displays the evolution of Expected Value between the Reference Period and the selected Transaction Period. The action button “ [symbol] ” permits when a click or mouse-over event is generated by the analyst to display the evolution of choice rate, realization, value, ancillary revenue and expected value by Transaction Period or Delivery Period with a granularity that can be defined by the analyst year, semester, quarter, month, week or day.
Drill-down. Clicking the Unfold Icon “ [symbol] ” preceding each offer permits to access statistics details either (i) by offer as illustrated in Table 7A, or (ii) for all supersets/super-sequences as illustrated in Table 7B or (iii) for next super-sequences (step by step). The type of expansion (by offer, “all supersets” or “next supersets”) is selected by the Analyst through the User Interface with a selection button device.
CCRM Analyzer 300 proposes two Analysis Modes in the case of sequenced or simultaneous offers:
Simple Mode (by offer): in this case each line of the Performance View corresponds to an offer and statistics are calculated in terms of exposures and sales by offer independently of the offer sets or sequences that were actually proposed. This mode is used for assisting in the management of Simple Predictions (see Predictions Management here-after).
Expert Mode (by offer set/sequence): in this case each line of the Performance View corresponds to an offer set/sequence or superset/super-sequence and statistics are calculated at these levels. Tables 13 and 14 present examples of the Expert Mode.

Additional selection options are available to display the Performance View such as
Filters by offer, offer sequence or offer sub-set. Examples:
In case of instantiated offers: offer O1 may be selected as filter. Then only instances of this offer—with different prices . . . —such as O1₁, O1₂, O1₃ . . . . are presented in the Performance Analysis table.
In case of sequenced offers: a given sequence/sub-sequence such as O1→O2→ may be selected.
In case of simultaneous offers: a given subset such as {O1 . . . } corresponding to supersets containing {O1} may be selected.
Size of set or sequence (applicable to sequenced and simultaneous offers). For example if analyst chooses “Size of Set/Sequence=1”, then each line of the Performance View will present one offer such as presented in Table 8. The “→” sign following the offers indicates that super-sequences are considered as well in the analysis. In the example 1450 sequences beginning by O1 were presented which resulted in 538 sales (in O1 or in other offers as well) and a conversion rate of 37.1% was achieved. The average value was $ 2,230 and the expected value was $827.

Table 9 presents the Global Performance View at the highest level (corresponding to “Size of Sets/Sequences=0”). The “ALL→” sign indicates that all super-sequences of offers are considered together in the analysis.

It is then possible to drill down at a lower level of detail with different expansion options available: by offer, expand all super-sequences or expand next super-sequences.

Note: the field displayed in the analyses can be configured depending on CCRM embodiment.

Prediction Management 330

Predictions are defined by the analyst for each segment. They represent estimates of the probability of choice for each offer, offer instance, offer sequence or offer set (depending on CCRM specific embodiments). Predictions are used by CCRM Optimizer 200 to forecast choice probabilities. We will distinguish three cases for the purpose of presenting the functionality of Prediction Management:
Instantiated offers with variation in attribute values (price . . . )— ref. Business Case #1,
Sequenced offers, presented one at a time—ref: Business Case #2,
Simultaneous offers, presented in combination/sets—ref: Business Case #3.

In the case of sequenced and simultaneous offers, the analyst may choose between two Predictions Modes:
Simple Prediction Mode (by offer) in which the number of predictions is reduced
Expert Prediction Mode (by offer sequence/set) in which the number of predictions is higher.

In all cases the analyst can use the reports and performance views produced by Reporting 320 to validate its priors and build predictions. In addition to that, Prediction Management 330 proposes different tools to copy and past, transform and monitor predictions. The process for defining and reviewing predictions is presented here-after.

### 1—Case of Instantiated Offers

A prediction may be defined for each instance of a given offer. Let us consider Business Case #1. The Offer “Domestic Overnight before 10:00 am” may be proposed with three negotiation variables: (i) Collection Time, (ii) Price first Kg and (iii) Price additional Kg. The analyst uses Reporting 320 to review the historical performance (exposures and choice/win rates) for the different values of the negotiation variables and can switch to the Prediction View in order to validate the predictions that will be used by CCRM Optimizer 200. Table 10 shows the Prediction View for the segment selected in the Segmentation Tree (/Tier=“1000-2000”/Industry=“Electronics”). The Analyst has selected a reference period for the analysis and has fixed the Negotiation variable “Collection Hour” to the value “After 06:00 pm”. Other negotiation variables “Price First Kg” and “Price Add Kg” remain undefined (“ALL” values). The analyst has selected the negotiation variable used as Prediction Dimension in the Prediction View (“Price First Kg” in our case).

### Comments:

The exposures and choice/win rates correspond to the chosen historical reference period. They can also be complemented by two other columns (if such data is available—refer to CCRM Sales Monitor 500): “Realization Rate” and “Sell Rate” (Sell Rate=Choice Rate*Realization Rate)
The analyst can Activate the Prediction by clicking the check-box in front of each value of the negotiation variable. Only activated predictions will be used by CCRM Optimizer 200 (offers instances/sequences/sets for which predictions are not activated are assumed to have a choice probability of zero)
The Apply Rate button [symbol] in each line permits to copy choice rates for the reference period to the Prediction field.
The analyst can enter/modify a Prediction in the “Prediction fields”. CCRM Analyzer 300 also permits to display oil user request two Prediction columns (“Current Prediction” and “New Prediction” in order to permit comparisons before validating any change of predictions). When the user enters its own prediction the value is displayed with a specific format (bold, blue . . . )
The “Origin” fields indicate if the prediction has been generated from Historical Choice Rates “R” or if it is an override “O” by the analyst. In case of mouse-over or click event, Prediction Management 330 displays details on the origin of this prediction. For example: the date/time of last update, the reference period, the calculation method (simple mode, expert mode . . . ), the original segment and offer/sequence/set (in case of inheritance from another segment or offer/sequence/set) as well as the identification of the analyst who as modified the prediction (in case of “override”). A specific button permits then to visualize the “history of modifications” of the prediction.
The Alerts fields permit to set different types of alerts for the Monitoring of the Predictions (see hereafter).
The “Trend” buttons permit to plot the evolution of exposures, choice rates . . . by Transaction Period or Delivery Period.
Remarks:
The precedent Predictions, once saved, apply to every value of negotiation variable “Price Add Kg”.
Then, the analyst can change the selection of negotiation variable, for example by specifying a value for “Price Add Kg” and modify the corresponding predictions for each value of “Price First Kg”; or change the variable selected as Dimension for the Prediction View.
It is also possible to copy and paste Predictions. For example the predictions made in Table 11 for Collection Hour=“After 06:00 pm” could be copied and then pasted to initiate predictions made for Collection Hour=“04:00 to 06:00 pm”.

These predictions could then be adjusted using the Prediction View. It is also possible to paste values with application of a function (ex: add a constant, multiply by a factor . . . )

### 2—Case of Simultaneous Offers

Two prediction modes are possible in this case: simple mode and expert mode.

2-a. Simple Mode

Predictions are made by offer. Principle: the choice rate of each offer is calculated as the number of choices of the offer (independently of the offer set) divided by the number of exposures of the offer. Table 11 shows an example:

2-b. Expert Mode

A prediction is made by offer set. For a given offer set, the analyst enters a prediction of choice probability for each offer in the offer set. The conversion probability of the offer set is equal to the sum of predicted choice probabilities of offers in the set. Table 12 shows an example:

### 3—Case of Sequenced Offers

Two prediction modes are also possible in this case: simple mode and expert mode.

### 3A. Simple Mode

Predictions are made by offer. Same principle as in the case of simultaneous offers.

### 3B. Expert Mode

For sequences with historical choice data in the reference period, a prediction is made by offer sequence. For a given offer sequence, the analyst enters a prediction of choice probability for each offer in the sequence. The conversion probability of the offer sequence is equal to the sum of predicted choice probabilities of the offers in the sequence. Table 13 shows an example:

For sequences that were not proposed/exposed during the reference period, the analyst can perform predictions by offer set and validate the predictions of Keep probabilities by sequence step. To that end CCRM Analyzer 300 displays the following table, for analyst validation:

### Remarks:

The Exposures in this table are the number of transactions with sequence length superior or equal respectively to 1, 2, 3 . . .
The Keep Rate is a direct outcome of the Exposure column. For example the Keep rate at the 1^{st} step is the ratio between the exposures of sequences with length>=2 and exposures of sequences with length>=1 (681/1510=45.1%) . . .

CCRM Optimizer 300 will then use the predictions by offer set and the Keep probabilities to produce forecasts by sequence.

### 4—General Functionality of Prediction Management 330

### 4A. Inheritance

It is possible to inherit predictions (copy and past mechanism) from one segment to another one (for all offers/offer instances/offer sets/offer sequences) or, within a given segment, from one offer/instance/set/sequence to another one.

### 4B. Alerts

The Alerts fields permit to set different types of alerts for the monitoring of predictions (refer to Alerts 340 here-after).

4C. Offer Instances/Sequences/Sets without Historical Exposures

The analyst may define predictions for offer instances/sequences/sets for which no exposures have been recorded for the reference period and hence no historical choice rates are available to initiate predictions. In such a case the analyst defines the new offer instance/sequence/set and the corresponding prediction. This line appears in the Prediction View with a “N” (like “new”) sign ii the Origin column.

### 4D. Reconciliation Between the Reference Period and the Future (Prediction) Period

In certain CCRM embodiments, offers are stable over time whereas in other embodiments offers and/or offer attributes (such as price or other attributes) may vary over time. Reconciliation deals with the issue of taking into account in the prediction process
New offers,
Historical offers that have been removed from the catalog,
Changes in offer attributes (such as price . . . ).

CCRM Reconciliation procedure, permits to identify such changes. In the example shown in Table 15, offer O1 has been removed from the catalog, a new offer O2 has been created and the price of offer O3 has changed.

TABLE 15
Reconciliation Procedure

| | Old | | Other | | | New | | Other |
|---|---|---|---|---|---|---|---|---|
| Reconcile | Offer | Price | Attribute . . . | \ddot{\|} | Reconcile | Offer | Price | Attribute . . . |
| [symbol] | O1 | $2190 | — | \ddot{\|} | | | | — |
| | | | — | \ddot{\|} | [symbol] | O2 | $2340 | — |
| | O3 | $1950 | — | \ddot{\|} | | O3 | $2050 | — |
| | . . . | . . . | . . . | . . . | | . . . | . . . | . . . |

When analyst clicks the Reconcile button [symbol] , CCRM displays the equivalent offers corresponding to removed offers and to new offers. Equivalent offers are those that are the “nearest” to the given offer using a user-defined distance function based on offers attributes.

The historical choice rates observed for equivalent offers of new offers (O2 in our example) may then be considered to initialize predictions for these new offers.

The analyst may also consider the variations of attribute values in order to adjust the historical choice rates. In our example, the price of offer O3 has increased by 5%, then the analyst may estimate the impact of this increase on the choice rate.

For offers that were removed from the catalog (case of O1), predictions shall in principle be disabled unless an equivalent new offer is found and associated. In this case CCRM proposes a function to copy the historical choice rates of the old offer to the new one.

### Remarks:

In order to implement the “Reconciliation” procedure, CCRM Analyzer 300 accesses the Offers Catalog and retrieves the offers published for the future Transaction Period considered in the Prediction.
The reconciliation is generally independent of the segment. However certain offers may be specific to some segments or may have prices that vary per segment.

### 4E. Applicability

The predictions, once validated by the analyst, are applicable to a given offer category, a given segment (i.e. terminal node or upper node of the segmentation tree), a given offer/offer instance/offer set or offer sequence and to a given period.

The application period may be delimited by a start or/and an end date. In certain CCRM embodiments, especially in sectors where seasonality in demand impacts choice behavior and price sensitivity (such as in travel and tourism or Internet sales of other seasonal products), it is recommended to differentiate the predictions according to the period of the year (ex: peak season, shoulder season, low season . . . ).

### 4—Storage of Predictions

Two types of predictions are stored in the Prediction Tables:
Prediction by offer/offer instance,
Prediction by offer set/offer sequence.

The Predictions by offer correspond to the Simple Prediction Mode thus permitting to reduce the number of candidate offers in the Optimization step (see Forecasting 250).

The predictions by offer instance/offer set/offer sequence correspond to the Expert Prediction Mode.

4A—Predictions by Offer/Offer Instance (Simple Prediction Mode)

Two types of data are stored in the Prediction tables:
Analyst Predictions (overrides). This table corresponds to the Origin value equal to “O”.
Historical Choice Rates (if available). The origin value is then equal to “R”.
   These two tables use the following common keys:
   Segment id
   Offer id

For a given segment and offer, the following stored data is common to both tables:
The value of the win probability (or rate) if any. Note that if there is no value available this field contains the “Null” value
The Prediction Origin (“O” or “R”)
The date and time of creation or update
The start date of application
The end date of application

In addition to that, the table of Historical rates contains:
the reference period that was used to calculate the rates,
   and the table of Analyst Predictions contains:
if any, instead of a win probability, a minimum and maximum values
an identification of the Analyst who made the override.

4B—Predictions by Offer Set/Offer Sequence (Expert Prediction Mode)

We will distinguish two cases:
Sequenced offers, presented one at a time—ref: Business Case #2,
Simultaneous offers, presented in combination/sets—ref: Business Case #3.

4B-i. Prediction Tables in Case of Sequenced Offers

In this case there are also two types of data are stored in the Prediction tables
Analyst Predictions (overrides),
Historical Choice Rates (if available).

These tables contain predictions by sequence for all possible sequences containing at most J offers (refer to CCRM Optimizer 200 and CCRM Modeler 400).
The following keys are used:
Segment id
Sequence id

For a given segment and sequence the following data is stored:
The number of offers contained in the sequence
Their ids
Their order of presentation in the sequence
the values (if any) of the choice probabilities (or rate) of every offer in case of submission of the sequence to the customer and “Null” if no value is available
the origin of the prediction (“O” or “R”)
The date and time of creation or update
The start date of application
The end date of application

Historical Choice Rate are stored with:
The reference period that was used to calculate the choice rates.

Analyst Predictions are stored with:
If any, instead of a choice probability, a minimum and maximum values (authorized range)
The list and ids of Sequence Associated Choice Sets
For every Sequence Associated Choice Sets, the Choice probabilities (if any else a “Null” value) of each offer contained in the given choice set
The list of Keep probabilities by sequence step
An identification of the Analyst who made each override.

Remark: The Sequence Final Choice Set (see Glossary) is contained in the list of Sequence Associated Choice Sets. It's the final choice set containing all the offers in addition to the Loss alternative.

4B-ii. Predictions Tables in Case of Simultaneous Offers

As in the previous case, historical predictions and analyst predictions are stored. They both contain predictions by choice set (combination) for all possible choice sets containing J offers (refer to CCRM Optimizer 200 and CCRM Modeler 400).
Segment id
Choice set id

For a given segment and sequence the following data is stored
The ids of offers contained in the choice set
The values (if any) of the choice probabilities (or rate) of every offer in case of submission of the sequence to the customer and “Null” if no value is available
The origin of the prediction (“O” or “R”)
The date and time of creation or update
The start date of application
The end date of application

Historical Choice Rate are stored with:
The reference period that was used to calculate the choice rates.

Analyst Predictions are stored with:
If any, instead of a choice probability, a minimum and maximum values (authorized range)
An identification of the Analyst who made each override.

Alerts 340

CCRM Analyzer 300 includes a mechanism of Alert permitting the system to notify the analyst of different situation requiring attention or action. This mechanism will be extended in CCRM Modeler 400.

### 1—Alerts Configuration

In the Prediction View, the analyst can set different types of alerts for the monitoring of the Predictions by segment and offer/offer instance/offer set/offer sequence such as:
Revision date: an alert will be posted for review of the predictions at a given date in the future or after a given number of days;
Number of exposures superior or inferior to a limit;
Number of sales superior or inferior to a limit;
Choice rate superior or inferior to a limit;
Prediction gap: an alert will be generated if the actual choice rate deviates from the prediction by more/less than a specified limit;
Combinations of the precedent conditions.

The analyst can set a weight function for the alert. The analyst also defines the frequency of alert generation (monthly, weekly, daily, every N hours). The configuration of alerts is stored in the CCRM Database.

### 2—Alerts Generation

Alerts are generated by a batch process whose input is an Aggregation Table generated from the Transaction tables, the Prediction tables and the Alerts Configuration tables. This process is run with the frequency defined by the analyst. The process checks if each alert condition set for any segment is verified by the offers/instances/sets/sequences. If so an alert is written to an Alert table with an update field indicating the date/time of generation of the alert.

### 3—Alerts Review

Alerts are displayed in different forms to the analyst:
Simple list with indication of the segment, the offer, the type of alert, the weight, the condition, the update date/time. This list provides sorting and filtering capabilities;
Number of alerts displayed in the tree structure (at node level) with their cumulative weights;
Alerts displayed in the Prediction View and Performance View;
History of alerts.

Analyst possible actions are:
change status to “read”;
change status to “ignore”;
enter a comment.

Performance Monitoring 350

A first method to assess the impact of CCRM is to use the trend analysis reports of conversion rate, price, value and expected value provided by Reporting 320. However this method based on comparison between different historical periods does not permit to isolate the impact of CCRM and environment/other business practices which may have also an impact on performance. A second method is based on the comparison of CCRM recommendations and those of previous pricing/offer-pushing logic (“Baseline Recommender”) in identical situations. In order to implement this method, it is necessary (1) to formalize the logic of the Baseline Recommender based on pre-existing rules or (2) to infer these rules from the analysis of choice data. Alternatively it could also be envisioned to keep the “Baseline Recommender” processing requests in parallel with CCRM and comparing the results of the two systems during a certain Test period. In this procedure one of the two systems (CCRM or Baseline Recommender) is used to deliver actual recommendations to Transaction Manager 100 and the other one is used for the purpose of benchmarking. For example during the phase of test and acceptance of the CCRM system, the Baseline Recommender could be used to deliver recommendations to Transaction Manager 100 whereas CCRM is used to provide recommendations for benchmark. After acceptance of the CCRM system, once its advantages and superiority over Baseline Recommender have been proved, CCRM will interface with Transaction Manager whereas the Baseline Recommender will be used for purpose of assessing the gains generated over time by CCRM.

A Gain function can be calculated at a transaction level as shown in Table 16, for comparison of the results of the two systems:

TABLE 16
Example of Gain Calculation for a given transaction

| Recommender | Offer | | | Expected | |
|---|---|---|---|---|---|
| System | Recommended | Value | Forecast | Value | Gain |
| Baseline | O1 | $1,000 | 80% | $800 | — |
| Recommender | | | | | |
| CCRM | O2 | $1,200 | 75% | $900 | $100 |

Remark: Forecasts are either based on predictions validated by the analyst or built based on Choice Modeler 410. In both cases they are based on unbiased choice data.

### CCRM Modeler 400

CCRM Modeler 400 is an optional module which complements CCRM Analyzer 300 with three functional blocks (1) Choice Modeler 410 which provides advanced predictions of choice probabilities at the customer and segment level, (2) Choice Based Segmentation 420 permitting to validate and refine customer segments and (3) Substitution Modeler 430 which assesses choice of substitution products when requested products are not available.

These three functionalities, executed in batch mode, are invoked by the analyst using CCRM User Interface. This interface permits the Analyst to:
Configure and invoke Choice Based Segmentation 420 in order to validate and refine the primary segmentation elaborated with CCRM Analyzer 300. Choice Based Segmentation 420 makes a request to Choice Modeler 410 and uses the statistical tests of the resulting model to recommend an advanced segmentation. These models are calculated at a high level in order to find characteristics which are the best predictors of customer choices. These characteristics are then used to refine the segmentation tree.
Configure customer choice models: once the segmentation is completed and is validated by the analyst, a more detailed Customer Choice model is specified for each segment and Model Predictions of choice probabilities are calculated for each segment.
Review and validate the results of the two previous tasks.
Schedule automatic recalibration of Choice Models and Model Predictions with a pre-defined frequency.
Review the list of alerts generated by Choice Modeler 410 when models are refreshed in “scheduled” mode.

CCRM Modeler 400 communicates with the following Tables:
Customers Tables,
Transaction Tables,
Segments Tables,
Choice Models Tables,
Predictions Tables.

Choice Modeler 410

Choice Modeler 410 models choice probabilities for each customer and each offer based on actual customer choices recorded during historical sale sessions. The models are defined at the segment level. CCRM Modeler 410 uses the Discrete Choice Analysis framework to derive a utility function based on customer characteristics and offer attributes. Model parameters are estimated using the Maximum Likelihood method.

### 1—Model Configuration

First of all, the analyst configures the model and sends a request to Choice Modeler 410 in order to estimate the model. The analyst can either select a previously saved model in the library and change it, take such model as a template to create a new model or configure a new model from scratch. The analyst specifies the model by defining the following elements through the user interface
Transaction Period related to choice data (from date T1 to date T2)
Subset of customers. This selection is done by navigating in the Segmentation Tree.
The selection may correspond to a terminal leaf of the tree or to a (higher) node. In the case of a node, all child nodes and their terminal leaves will be selected. The total number of customers is displayed in the selected node/leaf. Remark: this number shall be within an allowable range of values [MIN_CUST, MAX_CUST] (ex: [100, 1000]) permitting to effectively compute the model (refer to Tree Based Segmentation 310). If the number of customers is outside this allowable range the analyst receives a warning message in order to reduce the size of the selection or the Transaction Period.
Type of model used: “logit”, “nested”, “cross-nested” . . . (see here-below)
Sales Mode: instantiated offers, sequenced offers or simultaneous offer.
The number of alternatives and their nature (offer: “O”, Keep: “K” or Loss: “L”)
Nesting structure (in the case of a nested model): the analyst chooses the nesting tree. To do so, he may use two different ways. First, in the case of a restricted number of alternatives, he may specify the number of nests and for each nest select among the list of alternatives the ones belonging to the nest. The second way is to choose among the list of offers attributes, the attribute that would permit to split the alternatives (see the segmentation section for further details).
The list of customer characteristics to be used in the model and their type (Continuous or discrete). An exhaustive list of available customer characteristics is displayed on the User Interface. The characteristics already used in the segmentation are marked (usually these variables will not be used in the modeling but the analyst may decide to add them to the modeling in order to test heterogeneity). The Analyst chooses among this list, the characteristics that may influence the choice behavior.
The list of offer attributes to be used in the model (for example: price, Preference Index . . . ). An exhaustive list of available offer attributes is displayed on the User Interface. The Analyst chooses among this list, the attributes that are assumed to influence the choice behavior.
For each continuous variable, the analyst can select a transformation function among a library of available functions (log . . . ).
For each selected continuous offer attribute, the analyst can impose to the related weight to be alternative specific or not (this concept will be introduced here-below).
Finally, the analyst can set competitive price and Preference Index (if available) as attributes of the “Loss” alternative.

Once the model specification is completed, the analyst makes a request to Choice Modeler 410 in order to prepare the data and estimate the model. The model configuration is transmitted to the server as an object or an XML file depending on CCRM embodiment. Follows an example of an XML model specification file.

TABLE 17
Example of XML Choice Model Specification

```
<modelRequest id >001234567</modelRequest id>
<segment id>367656799</segment id>
<data period>867290921</data period>
<model>
    <model name=“logit”/>
    <salesMode type=“sequenced”/>
    <alternatives nb =“8”>
        <alternative type =“O” Id = “A1”/>
    <customerCharacteristics>
        <characteristic Id=“CC1”/>
        <characteristic Id=“CC2”/>
    </customerCharacteristics>
    <attributes>
        <attribute Id=“OA1”/>
        <attribute Id=“OA2”/>
        <attribute Id=“OA3”/>
        <attribute Id=“OA4”/>
        <attribute Id=“OA5”/>
        <attribute Id=“OA6”/>
    </attributes>
</alternative>
<alternative type =“O” Id = “A2”/>
    <customerCharacteristics>
        <characteristic Id=“CC1”/>
        <characteristic Id=“CC2”/>
    </customerCharacteristics>
    <attributes>
        <attribute Id=“OA1”/>
        <attribute Id=“OA2”/>
        <attribute Id=“OA3”/>
        <attribute Id=“OA4”/>
        <attribute Id=“OA5”/>
        <attribute Id=“OA6”/>
    </attributes>
</alternative>
<alternative type =“O” Id = “A3”/>
    <customerCharacteristics>
        <characteristic Id=“CC1”/>
        <characteristic Id=“CC2”/>
    </customerCharacteristics>
    <attributes>
        <attribute Id=“OA1”/>
        <attribute Id=“OA2”/>
        <attribute Id=“OA3”/>
        <attribute Id=“OA4”/>
        <attribute Id=“OA5”/>
        <attribute Id=“OA6”/>
    </attributes>
</alternative>
<alternative type =“O” Id = “A4”/>
    <customerCharacteristics>
        <characteristic Id=“CC1”/>
        <characteristic Id=“CC2”/>
    </customerCharacteristics>
    <attributes>
        <attribute Id=“OA1”/>
        <attribute Id=“OA2”/>
        <attribute Id=“OA3”/>
        <attribute Id=“OA4”/>
        <attribute Id=“OA5”/>
        <attribute Id=“OA6”/>
    </attributes>
</alternative>
<alternative type =“O” Id = “A5”/>
    <customerCharacteristics>
        <characteristic Id=“CC1”/>
        <characteristic Id=“CC2”/>
    </customerCharacteristics>
    <attributes>
        <attribute Id=“OA1”/>
        <attribute Id=“OA2”/>
            <attribute Id=“OA3”/>
            <attribute Id=“OA4”/>
            <attribute Id=“OA5”/>
            <attribute Id=“OA6”/>
        </attributes>
    </alternative>
    <alternative type =“O” Id = “A6”/>
        <customerCharacteristics>
            <characteristic Id=“CC1”/>
            <characteristic Id=“CC2”/>
        </customerCharacteristics>
        <attributes>
            <attribute Id=“OA1”/>
            <attribute Id=“OA2”/>
            <attribute Id=“OA3”/>
            <attribute Id=“OA4”/>
            <attribute Id=“OA5”/>
            <attribute Id=“OA6”/>
        </attributes>
    </alternative>
    <alternative type =“K” Id = “A7”/>
        <customerCharacteristics>
            <characteristic Id=“CC1”/>
            <characteristic Id=“CC2”/>
        </customerCharacteristics>
        <attributes>
            <attribute Id=“OA7”/>
        </attributes>
    </alternative>
    <alternative type =“L” Id = “A8”/>
        <attributes>
            <attribute Id=“OA8”/>
        </attributes>
    </alternative>
</alternatives>
<customerCharacteristic Id=“CC1”>
    <characteristic name =“Age” type=“continuous”/>
</customerCharacteristic>
<customerCharacteristic Id=“CC2”>
    <characteristic name =“Value” type =“continuous”/>
</customerCharacteristic>
<offerAttribute Id=“OA1”>
    <attribute name=“WeekOfStay” type=“continuous”/>
    <alternative specific weight>no</alternative specific weight>
</offerAttribute>
<offerAttribute Id=“OA2”>
    <attribute name=“NumberWeeks” type=“continuous”/>
    <alternative specific weight>no</alternative specific weight>
</offerAttribute>
<offerAttribute Id=“OA3”>
    <attribute name=“NumberRooms” type=“continuous”/>
    <alternative specific weight>no</alternative specific weight>
</offerAttribute>
<offerAttribute Id=“OA4”>
    <attribute name=“Category” type=“dummy”/>
    <alternative specific weight>yes</alternative specific weight>
</offerAttribute>
<offerAttribute Id=“OA5”>
    <attribute name=“RoomType” type=“dummy”/>
    <alternative specific weight>yes</alternative specific weight>
</offerAttribute>
<offerAttribute Id=“OA6”>
        <attribute name=“Price” type=“continuous”/>
        <apply function=“log”/>
        <alternative specific weight>yes</alternative specific weight>
    </offerAttribute>
    <offerAttribute Id=“OA7”><attribute name=“OrderOfPresentation” type=“continuous”/>
        <alternative specific weight>no</alternative specific weight>
    </offerAttribute>
    <offerAttribute Id=“OA8”>
        <attribute name=“CompetitivePrice” type=“continuous”/>
        <apply function=“log”/>
    </offerAttribute>
</model>
```

### 2—Preparation of the Data

Given the model configuration, Choice Modeler 410 accesses the following Tables to gather the data necessary to the process.

2A. In the case of a previously saved model, it accesses the Choice Models Tables in order to retrieve the model configuration.

2B. The Segments Tables where the Segmentation Tree is stored are accessed. Choice Modeler 410 retrieves the tree structure.

2C. It accesses the Customers Tables in order to retrieve customers belonging to the current selection.

2D. It accesses the Transaction Tables in order to retrieve choice data corresponding to transactions made during the specified transaction period by customers within the current selection.

All the precedent data is loaded into memory.

### 3—Customer Choice Modeling

The whole collected choice dataset, is transmitted to Choice Modeler 410 which will construct the individual choice sets by customer, express the different utilities and estimate the Weights using the Maximum Likelihood Method. Choice Modeler 410 uses Discrete Choice Analysis methodology.

Before describing the way Choice Modeler 410 proceeds, here is a quick introduction to the framework of Discrete Choice Analysis. This framework distinguishes the following concepts: decision maker, alternatives and their attributes and finally the decision rule.
Decision-Maker (denoted n).

The decision-making entity and its characteristics. Here, the decision maker is the customer.
Alternatives (denoted i or j)

The options available to the decision-maker. Once customer's preferences are collected, CCRM Modeler assumes that offers presented to the customer are limited in number: only a maximum of J offers will be presented (J can for example be equal to 10 alternatives—or a higher number if required). The assumption of a limited number of alternatives is not that severe because for example in call centers the first alternatives that are presented are the more likely to be chosen. Even in the case of an internet site, the results of a search are displayed page by page and the number of offers presented in a given page is limited. It is assumed that the customer only considers offers that are presented in the first page knowing that the number of displayed offers can be modified. In addition to that, the aim of CCRM is to find the best ordered set of offers. Then offers that are presented the later are necessarily offers which have the lowest probability to be chosen and the lowest value.

It is necessary to distinguish (i) the Universal Choice Set which contains all alternatives potentially available to all Customers in the segment and (ii) the Individual Choice Set which is the subset of alternatives available to a particular customer. Using these definitions, the universal choice set will always include the J alternatives and the “Loss” (also called “No Purchase”) alternative. In some cases, all the J alternatives are not presented to the customer because some of them are not available. In the case of a sequential presentation of offers (Business case #2 for example), there is an additional alternative “No choice and ask/wait for another offer” (called “Keep” here-after). After every offer has been presented, the customer has the choice between: all the alternatives that have already been presented (necessarily less than J), the “Keep” alternative and the “Loss” alternative. The Individual choice set is then composed of all these alternatives. The following Table 18 summarizes the two concepts of Universal Choice Set and Individual Choice Set, in case of simultaneous offers and sequential offers.

TABLE 18
Choice Sets

| | Sequential Offers | Simultaneous Offers |
|---|---|---|
| | (ex: Call center) | (ex: Internet Site) |
| Universal | {J alternatives that can be | {J alternatives that can be |
| Choice | presented to the | displayed to the customer, |
| Set | customer, Keep, Loss} | Loss} |
| Individual | {Subset of the J | Subset of the J |
| Choice Set for | alternatives including | alternatives including |
| Customer n | offers available to | offers available to |
| | customer n, Keep, Loss} | customer n, Loss} |

In all the cases, the Loss alternative will be considered as the last alternative and will have the number J+1 (or J+2 in case of “Keep” Alternative with number J+1).

The alternatives are all defined using attributes. An attribute permits to describe the alternative, its benefits and costs to the decision maker.

Remark: It is important to distinguish between:
The alternatives and the offers: for each customer, an offer is an instance of alternative;
The universal choice set and the offer catalog: customers do not have the choice among all offers in the catalog but only among the set of offers that were proposed to them and that do not exceed J offers.

The universal choice set is used in the expression of the utilities for all customers (see here below) and the individual choice set is used in the calculation of the probabilities of choice of a given customer.

Follow examples of choice sets in the three business cases.

Business case #1:
In this case offers have different instances depending on the attributes values. The attributes can be separated into two different categories: those describing the service and those describing the prices. The first category of attributes permit to retrieve the offers from the Offer Catalog.
Attributes describing the offers:
   The delivery date: may have two different values (“D+I” and “D+2”)
   The collection time: may have 3 values (“<04:00 pin”, “04:00-06:00 pm” and “>06:00 pm”)
   The delivery hour: may have 4 different values (“<08:00 am”, “<09:00 am”, “<10:00 am” and “<12:0 am”)
Pricing attributes:
   The price of the first kg (from $10.00 to $ 8.60)
   The price of an additional kg (from $ 1.40 to $ 1.00)
When a sales manager negotiates a contract with a customer, lie collects his needs and then proposes a relevant offer. The customer has then the choice between two alternatives: the specific offer instance proposed (described by its attributes values) and the Loss (No Purchase) alternative. The universal choice set is then equal to this couple of alternatives {Offer Instance Proposed, Loss}. Here, the universal choice is also the individual choice set.

Business Case #2:
In the case of the Call Center of Star Holidays, the offer catalog is very rich and only a limited number of alternatives is proposed to the customer. Let's suppose that no more than 6 offers are proposed to a given customer. The offers are proposed one by one. After each proposed offer (before the 6^{th} offer), the customer can choose each one of the proposed offers, the Keep alternative or the Loss alternative. In this case the universal choice set is composed of 8 alternatives: the 6 “maximum” offers proposed, the Keep and the Loss alternatives.
Each alternative is described by its attributes: Package type, Week of stay, Number of weeks, Number of adults, Number of children, Number of rooms, Hotel category, Destination, Room type, Room view, Travel Included or not, Kids club or not Sky lessons or not and the Price.
In the Optimization Request Message, only 5 offers matched the preferences and requests of the customer. In this case, the individual choice set of this customer contains only 7 alternatives and not 8: the 5 offers that matched his preferences, the Keep and the Loss alternatives.

Business Case #3
The offer catalog contains 9 offers: 3 morning flights and for each flight 3 different fare products. The sales are made via the Internet site. If we assume that the maximum number of offers displayed to a customer is 9, then the universal choice would be composed of the 9 displayed offers and the Loss alternative. There is no Keep alternative because the sale mode is not sequential but simultaneous.
In this universal choice set, offers are described by the following attributes: From Airport (origin), To Airport (destination), Departure Time, Flight, Fare, Fare Name, Transferable or not, Refundable or not, Price and the Competitive Offer. Number of Adults, Number of Children and Number of Infants are not considered as they are given by the customer request.
   The Decision Rule. It is the process used by the decision-maker to evaluate the alternatives in the choice set and make a choice. CCRM choice models are based on the Utility Theory, which assumes that the decision-maker preference for an alternative is expressed by a value, called utility, and the decision-maker selects the alternative in the choice set with the highest utility. The utility is modeled as a random variable in order to reflect uncertainty. More specifically, the utility that individual n associates with alternative i in the choice set C, is given by:

Uᵢₙ=Vᵢₙ∈ᵢₙ (31)
where Vᵢₙ is the deterministic part of the utility, and ∈ᵢₙ is the random term capturing uncertainty and accounting for omitted or unknown attributes, unobserved heterogeneity, measurement errors and specification errors.
The decision rule states that the alternative with the highest utility is chosen. Therefore, the probability that alternative i is chosen by decision-maker n from choice set Cₙ is:

P(i|Cₙ)=P[Uᵢₙ>Uⱼₙ,∀j∈Cₙ] (32)
The deterministic term Vᵢₙ is for each alternative expressed as a function of the attributes of the alternative itself and the characteristics of the decision-maker. That is:

Vᵢₙ=V(zᵢₙ,Sₙ) (33)
where:
   zᵢₙ is a vector of attributes of alternative i for customer n
   Sₙ is a vector of characteristics of customer n.
Choice Modeler 410 combines the two vectors zᵢₙ and Sₙ in a new vector of attributes Xᵢₙ. Then:

Vᵢₙ=V(Xᵢₙ) (34)
V is assumed linear in the parameters:

$${V}_{in} = V ( {X}_{in} ) = {\sum }_{l} {b}_{l} {X}_{in , l} \qquad ( 35 )$$

where bₗ is a vector of parameters (weights)
The linear formulation used by Choice Modeler 410 is not very restrictive because linearity in parameters b is not equivalent to linearity in attributes and characteristics. Choice Modeler 410 allows for any transformation function “f” of the attributes and characteristics (z and S) such as logarithm, exponential . . . . These transformations may be included as elements of vector X.
The deterministic term of the utility Vᵢₙ is therefore fully specified by the vector of weights bᵢ.

### Case of Discrete Variables

To take into account non continuous (discrete) variables in the expression of the utilities, Choice Modeler 410 creates related dummy variables using the method described here after. When a variable is continuous, it is directly used in the utility. If not, dummy variables are introduced. Suppose that this categorical variable has d categories. Then Choice Modeler 410 creates d−1 dummy indicators Dij. One simple scheme is to select the last category as the baseline, and to code Dij=1 when observation i falls in category j, and 0 otherwise, as shown in Table 19.

TABLE 19
Dummy Variables

| Category | D1 | D2 | . . . | Dd − 1 |
|---|---|---|---|---|
| 1 | 1 | 0 | . . . | 0 |
| 2 | 0 | 1 | . . . | 0 |
| . | 0 | 0 | . . . | 0 |
| . | 0 | 0 | . . . | 0 |
| . | 0 | 0 | . . . | 0 |
| d − 1 | 0 | 0 | . . . | 1 |
| d | 0 | 0 | . . . | 0 |

For each discrete variable, a set of dummy variables is introduced in the modeling.

Example: Expression of the utilities in Business Case #2
The universal choice set is composed of 8 alternatives: the 6 offers proposed, the Keep and the Loss alternative.
These alternatives are described by the following attributes:
   Package type: Pack
   Hotel category: Cat
   Destination: Dest
   Room type: RType
   Room view: RView
   Week of Stay: WStay
   Number of weeks: Weeks
   Number of adults: Adults
   Numnber of children: Childs
   Number of rooms: Rooms
   Travel Included or not: Travel
   Kids club or not: KClub
   Ski lessons or not: Ski
   Price: P
These attributes depend on alternative i but also on customer n. They are all indexed by i and n.
The customer n is described by the following characteristics (including preferences/requirements and context information) all indexed by n:
   Lead Tiie of Booking: LT
   Type of Period: Period
   Country: Ctry
   Zip code: Zip
   Age: Age
   Number of adults: Adults
   Number of children: Childs
   Customer value: Value
   Frequency: Freq
   Affiliation: Aff
   Promotion code: Promo
   Package Type (preferred): pPack
   Number of Weeks (preferred): pWeeks
   Number of Rooms (preferred): pRooms
   Age of Youngest Child: AgeYChild
   Age of the Oldest Child: AgeOChild
   Hotel Category (preferred): pCat
   Week of Visit (preferred): pWStay
   Destination (preferred): pDest
   Room type (preferred): pType
   Room view (preferred): View
   Travel Included or not (preferred): pTravel
   Kids club or not (preferred): pKClub
   Ski lessons or not (preferred): pSki
We will assume that:
   A segmentation has been defined using the characteristics: Period, LT, Ctry, pCat and pDest;
   Only the characteristics Age and Value influence the choice behavior for a given segment;
   Only the attributes WStay, Weeks, Cat, RType and price P influence the choice behavior;
   The offers proposed match the basic requirements meaning that the attributes of the offer like: number of adults, number of children . . . match the characteristic number of adults and number of children.
For each customer n, the utilities of the 8 alternatives in the universal choice set can be expressed as follows:

V₁ₙ=β₁^{0+β}₁¹.ageₙ+β₁².valueₙ+β₁³.WStay₁ₙ+β₁⁴.Weeks₁ₙ+β₁⁵.Rooms₁ₙ+β₁⁶.Cat₁ₙ+β₁⁶.Cat₁ₙ+β₁⁷.Rtype₁ₙ+β₁⁸.P₁ₙ

V₂ₙ=β₂^{0+β}₂¹.ageₙ+β₂².valueₙ+β₂³.WStay₂ₙ+β₂⁴.Weeks₂ₙ+β₂⁵.Rooms₂ₙ+β₂⁶.Cat₂ₙ+β₂⁶.Cat₂ₙ+β₂⁷.Rtype₂ₙ+β₂⁸.P₂ₙ . . .

[symbol]

V₁ₙ=β₁⁰+β₁⁰+,ageₙ

V₈n=0 (36)
Alternative #7 is the Keep alternative. Alternative #8 is the “Loss”.
Here for a given customer n, the utility of the Keep alternative depends on the characteristics of n but also on the order of presentation of offers.
For i from 1 to 7, the βᵢ⁰ are called the alternative specific constants. There is no alternative specific constant for the Loss alternative for identification purpose. In fact, only the differences between utilities are relevant so we can impose one of the alternative specific constants (here it's the one related to the Loss alternative) to be equal to zero.
βᵢ¹ and βᵢ² are the weights relative to the customer characteristics. They are specific to each alternative meaning that characteristics do not influence the utilities of the alternatives the same way.
For each alternative I, βᵢ³, βᵢ⁴, βᵢ⁵, βᵢ⁶, βᵢ⁷ and βᵢ⁸ are the weights relative to the attributes. Here they are assumed to be alternative specific assuming that each offer attribute does not influence the choice of alternatives in the same way. This is the more general case, we can assume sometimes that a given attribute influences in the same way all the utilities and then we constraint the relative weights to be equal for each alternative.

### Different Types of Models

In order to calculate Probabilities of choice, CCRM models rely on assumptions related to the random term of the utility ∈ᵢₙ in order to ensure the computability of the model. These assumptions and the expression of utilities lead to different specifications of the model. The main types of specifications used by the CCRM Modeler are:
Logit model
Nested Logit (or “Nested”) model
Cross-nested logit (or “Cross-Nested”) model

These different type of specifications of the choice model are briefly presented here-after. It shall be noted that in some other embodiments, CCRM could use other choice model specifications such as: the probit model or the mixed logit. These two specifications will not be introduced here but are well described in the Discrete Choice literature (see reference [R3]).
Logit Model. This model relies on the assumption that the error terms ∈ᵢₙ are independent and identically Gumbel distributed. The general formula of the probability density function of the Gumbel won't be described here but it permits to express the probabilities of choice by the following expression:

$$P ( i \vert {C}_{n} ) = \frac{{e}^{{V}_{in}}}{{\sum }_{j ∈ {C}_{n}} {e}^{{V}_{jn}}} \qquad ( 37 )$$

This formulation is simple but it implies an important property: “Independence from Irrelevant Alternatives” (IIA). Ti is property of Logit Models can be stated as follows: the ratio of the probabilities of any two alternatives i and k is independent of the choice set.

$$\frac{{P}_{in}}{{P}_{kn}} = \frac{{e}^{{V}_{in}}}{{e}^{{V}_{kn}}} \qquad ( 38 )$$

The IIA property of the Logit Model is a limitation for some CCRM applications, notably if alternatives share observed or unobserved attributes. In this case the assumption of independence of the random parts of the utilities is not valid. Let us consider the example developed in Business Case #2 (Tour Operator) and the following offers:
   O1=“Residential Package at Punta Magna Three Star Resort, Family Room, Mountain View”;
   O2=“Residential Package at Jung Frau Three Star Resort, Family Room, Mountain View”;
   O2′=“Residential Package at Jung Frau Three Star Resort, Family Room, Garden View”;
The last offer O2′ is a slight variation of offer O2.
Suppose that the choice set is first {O1,O2} and that these offers have the same choice probability P(O1)=P(O2)=1/2, thus P(O1)/P(O2)=1
Suppose that the choice set is then {O2,O2} and that the market shares for Mountain View and Garden View are again the same:
(O2)=P(O2′)=½, thus P(O2)/P(O2′)=1
If the choice set is now {O1,O2,O2}, the IIA Property states that the precedent ratios of probability remain unchanged and we should have:
P(O1)/P(O2)=P(O2)/P(O2′)=P(O1)/P(O2′)=1, thus leading to:
P(O1)=P(O2)=P(O2′)=⅓
This last result is in contradiction with the intuition that adding O2′ to the choice set will not change the preferences between the two resorts but instead lead to the following probabilities
P(O1)=50% and P(O2)=P(O2′)=25%.
The IIA property I not valid in this case and the Logit Model shall be rejected.
   Nested Model: Suppose that we have a large number of alternatives and that some of them share some observed attributes. This is the case for example in business case #2 where two packages may be very similar (only the room type is different for example). In this case, the assumption of independence of the alternative is not relevant. To treat such choice sets, CCRM may use the Joint or the Nested logit model. These models are extensions of the Logit Model designed to capture some correlations between alternatives. To that end CCRM Modeler partitions the choice set Cₙ into M nests Cₘₙ such that

$${C}_{n} = {{⋃}_{m = 1}}^{M} {C}_{mn} \qquad ( 39 )$$

and notably if alternatives share observed or unobserved attributes.

Cₘₙ∩_{m′n}={ }∀m≠m′ (40)
We can represent this structure with a tree as shown in FIG. 6A. In this model, choices are decomposed in two sub-choices: (i) the choice of the nest and then (ii) the choice of an alternative among this nest. Choice Modeler 410 models sub-choices with a Logit. Alternatives within a nest share some observed attributes as well as unobserved attributes. The random utility is then decomposed in a part relative to the nest and a part relative to the alternative. The utility of alternative i in nest Cₘ is then:

Uᵢₙ=\tilde{V}ᵢₙ+\tilde{∈}ᵢₙ+\tilde{V}₁₀₆ _{ₒᵢₙ}+\tilde{∈}_{Ω}_{ᵢₒₙ} (41)
where:
   \tilde{V}_{Ω}_{ₒᵢₙ} is the utility part of nest Ωₒᵢₙ for customer n
   \tilde{V}ᵢₙ is the utility part of alternative i for customer n
The error terms \tilde{∈}ᵢₙ,\tilde{∈}_{Ω}_{ᵢₒₙ} are assumed to be independent with different scale parameters μ and μₘ. The scale parameters are parameters defining the standard deviation of the Gumbel distributions. Some of them will be normalized to one and the others will be estimated with the unknown model coefficients.
For each nest within the choice set we associate the composite utility:

$${V}_{{C}_{mn}} = {\tilde{V}}_{{C}_{mn}} + \frac{1}{{μ}_{m}} ln {\sum }_{j ∈ {C}_{mn}} {e}^{{μ}_{m} {\tilde{V}}_{jn}} \qquad ( 42 )$$

The probability for individual n to choose alternative i within choice set C, is given by:

P(i|Cₙ)=P(Cₘₙ|Cₙ).P(i|Cₘₙ) (43)
where

$$\begin{matrix}P ( {C}_{mn} \vert {C}_{n} ) = \frac{{e}^{μ {V}_{{C}_{mn}}}}{{{\sum }^{M}}_{i = 1} {e}^{μ {V}_{{C}_{in}}}} \\ and & ( 44 ) \\ P ( i \vert {C}_{mn} ) = \frac{{e}^{{μ}_{m} {\tilde{V}}_{in}}}{{\sum }_{j ∈ {C}_{mn}} {e}^{{μ}_{m} {\tilde{V}}_{jn}}} & ( 45 )\end{matrix}$$

Cross Nested models. In some implementations when the alternatives may belong to more than one nest like as in the example shown in FIG. 6B, Choice Modeler 410 uses a Cross-Nested formulation which generalizes the Nested Logit model. For each alternative i and each nest m, Choice Modeler 410 defines the Degree of Membership αᵢₘ (0≦αᵢₘ≦1) of alternative i in nest m. Parameters αᵢₘ are unknown and are estimated together with the weights. Under this formulation, the utility of alternative i in nest in is given by:

U_{i,mn}=\tilde{V}ᵢₙ+\tilde{∈}ᵢₙ+\tilde{V}_{C}_{ₘₙ}+\tilde{∈}_{C}_{ₘₙ}+1nαᵢₘ (46)
The probability for individual n to choose alternative i is:

$$P ( i \vert {C}_{n} ) = {\sum }_{m = 1}^{M} P ( {C}_{mn} \vert {C}_{n} ) {P}_{n} ( i \vert {C}_{mn} ) \qquad ( 47 )$$

Under the same assumptions for epsilons than in the Nested Logit formulation, we have:

$$\begin{matrix}P ( {C}_{mn} \vert {C}_{n} ) = \frac{{e}^{μ {V}_{{C}_{mn}}}}{{{\sum }^{M}}_{i = 1} {e}^{μ {V}_{{C}_{in}}}} & ( 48 ) \\ P ( i \vert {C}_{mn} ) = \frac{{α}_{im} {e}^{{\tilde{V}}_{in}}}{{\sum }_{j ∈ {C}_{mn}} {α}_{jm} {e}^{{\tilde{V}}_{jn}}} & ( 49 )\end{matrix}$$

knowing that:

$${V}_{{C}_{mn}} = {\tilde{V}}_{{C}_{mn}} + ln ( {\sum }_{j ∈ {C}_{mn}} {α}_{jm} {e}^{{\tilde{V}}_{jn}} ) \qquad ( 50 )$$

For a detailed description of the formulation and properties of these different models, see references [R2] and [R3].

### 3A—Estimation of the Model Parameters

The aim of the modeling is to calculate for each alternative, its probability of choice by a given customer. To do that, Choice Modeler 410 uses the expressions of probabilities given by the model: Logit, Nested, Cross-Nested or other formulations used in other embodiments of CCRM. This requires the estimation of the weights b and of other unknown parameters that define the deterministic utilities (such as degrees of membership or the scale parameters μ). Choice Modeler 410 uses the Maximum Likelihood method to estimate these unknown parameters. The likelihood of a set of historical observations (choices) is the probability of obtaining that particular set of observations, given the choice probability distribution model.

So in order to estimate the parameters, Choice Modeler 410 expresses the probabilities of the choice situations that were actually faced by customers. Choice Modeler 410 distinguishes between two different choice situations: simultaneous offers and sequenced offers.
Case of simultaneous offers. Example: Internet site where offers are presented simultaneously to the customer. For each customer n, the whole session is a unique choice situation (observation) because all the alternatives are proposed to customer n at the same time. The outcome of this observation is the alternative that was chosen (one of the proposed offers or the “Loss” alternative). The likelihood of such an observation is the probability that the chosen alternative, among all those proposed and “Loss”, is the one that the customer has actually chosen. This probability can be formulated as follows:

$${P}_{n} = {\prod }_{j} {P}_{jn}^{{y}_{jn}} \qquad ( 51 )$$

Where yᵢₙ=1 if n chooses alternative j and yᵢₙ=0 else. The terms Pⱼₙ are given by the formulation of the model (logit, nested, cross-nested . . . ). For example, in Business Case #3 (Airline Internet bookings) if flights F1, F2 and F3 were displayed to customer n and n did not chose anyone of these flights (lie chose the Loss alternative), then the likelihood of this observation is the probability that n chooses Loss among the individual choice set containing F1, F2, F3 and Loss. In the case of a Logit formulation this likelihood is written:

$${L}_{n} = P ( Loss \vert \{ F 1 , F 2 , F 3 , Loss \} ) = \frac{{e}^{{V}_{Loss , n}}}{\begin{matrix}{e}^{{V}_{F 1 , n}} + {e}^{{V}_{F 2 , n}} + \\ {e}^{{V}_{F 3 , n}} + {e}^{{V}_{Loss , n}}\end{matrix}} \qquad ( 52 )$$

Assuming that all observations are independent because each one relates to a given customer and customers are independent, the likelihood of our choice dataset is the product of all theses probabilities across customer transactions:

$$L ( β ) = {\prod }_{n = 1}^{N} {\prod }_{j} {P}_{jn}^{{y}_{jn}} \qquad ( 53 )$$

Case of sequenced offers. Example: Call Center transactions. In this case offers are not presented simultaneously to the customer, but one by one. A session/transaction is decomposed in multiple pseudo-observations, each corresponding to an elementary choice. The first pseudo-observation is the choice situation where the first offer was proposed and the Keep and Loss alternatives were both available. The second pseudo-observation is the choice situation where the 1st and the 2nd offers and Keep and Loss alternatives were available, and so on. Let's suppose that the first offer proposed to the customer was offer A. This offer was rejected by the customer who preferred to hold on and wait for another offer (“Keep” alternative). Offer B was then proposed. Again, the customer waited for another offer. The next offer proposed was offer C. The customer finally chose offer B. Choice Modeler 410 divides this session into three pseudo-observations each corresponding to a choice situation as presented in the following Table 20.

TABLE 20
Pseudo Observations

| Pseudo- | Alternatives | |
|---|---|---|
| observation | available | Outcome |
| 1 | {A, Keep, Loss} | Keep |
| 2 | {A, B, Keep, Loss} | Keep |
| 3 | {A, B, C, Loss} | B |

The likelihood of the session, is the probability of obtaining all the pseudo-observations. CCRM assumes that these pseudo-observations are independent, the probability of the whole session is then equal to the product of the probabilities of obtaining each pseudo-observation:

$${P}_{n} ( session ) = {\prod }_{l} P ( pseudo - {observation}_{l} ) \qquad ( 54 )$$

In our example this probability is:

P(session)=P(K|{A,L,K}).P(K|{A,B,L,K}).P(B|{A,B,C,L}) (55)

where:
K is the Keep alternative
L is the Loss alternative

Each probability is formulated using the choice model. In the case of the Logit formulation, this likelihood would be:

$${P}_{n} ( session ) = \frac{{e}^{{V}_{n , K}}}{\begin{matrix}{e}^{{V}_{n , K}} + \\ {e}^{{V}_{n , L}} + {e}^{{V}_{n , A}}\end{matrix}} \cdot \frac{{e}^{{V}_{n , K}}}{\begin{matrix}{e}^{{V}_{n , K}} + {e}^{{V}_{n , L}} + \\ {e}^{{V}_{n , A}} + {e}^{{V}_{n , B}}\end{matrix}} \cdot \frac{{e}^{{V}_{n , B}}}{\begin{matrix}{e}^{{V}_{n , L}} + {e}^{{V}_{n , A}} + \\ {e}^{{V}_{n , B}} + {e}^{{V}_{n , C}}\end{matrix}} \qquad ( 56 )$$

The likelihood of the whole data set is:

$$L ( β ) = {\prod }_{n} {P}_{n} ( {session}_{n} ) \qquad ( 57 )$$

Case of more than one session per transaction. In this case, for every customer, Choice Modeler 410 first calculates the likelihood for each session and then calculates the likelihood for the whole transaction. Let's suppose that for each customer n, CCRM has tₙ observations corresponding to tₙ sessions, (tₙ=1 in case of only one session per customer). The likelihood related to the whole transaction of customer n will be the product of the likelihoods of all sessions related to this customer:

$${P}_{n} ( transaction ) = {\prod }_{t = 1}^{{t}_{n}} {P}_{n} ( {session}_{t} ) \qquad ( 58 )$$

Pₙ(sessionₗ) is given by the formula (54) above. And finally the likelihood of the whole data set would be (assuming independence between the transactions):

$$L ( β ) = {\prod }_{n} {P}_{n} ( {transaction}_{n} ) \qquad ( 59 )$$

### 3B—Maximization of the Likelihood Function

In the three different cases, Choice Modeler 410 estimates the model by calculating the parameters that maximize the likelihood of the choice dataset for a given segment. To do this maximization, Choice Modeler 410 uses Quasi-Newton methods. These methods are regarded as the most sophisticated for solving unconstrained maximization problems. The best performing Quasi-Newton methods are the DFP (for Davidson, Fletcher and Powell), and the BFGS (for Broyden, Fletcher, Goldfarb and Shanno). Choice Modeler 410 uses a library of Quasi-Newton methods. The default one is the BFGS method but the analyst can access to this library and change the method of maximization. In other embodiment of CCRM, some constraints on the models parameters (like the sign or a range of authorized values) may be introduced by the Analyst. In this case, Choice Modeler uses classical methods for solving constrained maximization problems (Sequential Quadratic Programming and others . . . )

In another embodiment, CCRM Modeler uses techniques of Bayesian Markov Chain Monte Carlo estimation procedures. These methods have the advantage of estimating individual-level weights which means that the weights present in the utility formulation may be different from one customer to the other in order to take more into account the heterogeneity among customers.

### 3C—Statistical Tests

In order to validate the models for a given segment, Choice Modeler 410 provides statistical tests to make inferences about parameters. These tests help the analyst to:
Assess the influence of predictive variables,
Evaluate the goodness of fit of a given model,
Compare two models and choose the best one,
Assess the relevance of the Logit structure and the validity of the IAA assumption,
Compare two nested logit specifications.

Choice Modeler 410 provides the following statistical tests with flagging of their result:

### 3C-1. Tests of Parameter Values

Plausibility Tests. They consists to observe the signs and values of the weights and compare them with the priors of the analyst. For example, most of the times the price weight has to be negative because it estimates price sensitivity. Moreover the ratio between the weight of a non monetary attribute and the weight of the price indicates the relative value granted by the customers to this attribute. So if the weights estimated by the model are outside the priors of the analyst, Choice Modeler 410 generates an alert displayed in front of the related parameter. Choice Modeler 410 provides an alert configuration interface to set minimum and maximum values for each parameter and for ratios of two parameters.
T-test and P-value. the statistical T-test and the P-value permit to assess if any particular parameter (weight or other estimated parameter of the model) is significantly different from some known value, often zero. These two tests are equivalent. They are both results of the hypothesis test of nullity of a parameter. Assessing that a given parameter is different from zero permit to assess that the related variable (if any) influences the choice behavior. T-test and P-value are based on the property that the ratio of the estimator of a parameter b and its standard deviation is normally distributed with mean 0 and variance 1. This ratio is called the T-ratio. The T-test is the comparison of the T-ratio with the value of the standard normal distribution at a certain level of significance. Generally a significance level alpha equal to 0.05 is used to evaluate the nullity of coefficients and in this case the value of the standard normal distribution is −/+1.96. If the absolute value of the T-ratio is greater than 1.96 then we can reject the hypothesis of nullity of the coefficient. Likewise, the probability value (P-value) of the statistical hypothesis test of nullity is the probability of wrongly rejecting the null hypothesis if it is in fact true. The P-value is compared with the significance level (generally 0.05) and, if it is smaller, the result is significant. So for a given variable, the Analyst looks to the results of the T-test or P-value test of the related weight, if the absolute value of the T-test is greater than 1.96 (which equivalent to a P-value less than 0.05), then he can assess that the weight is significantly different from zero and that the variable influences the choice.

### 3C-2. Goodness-of-Fit of the Model

Likelihood Ratio. The likelihood ratio test (LRT) is a statistical test of the goodness-of-fit of the model. The model is compared to the basic model (with all weights equal to zero), to check if it fits the dataset significantly better. The likelihood ratio is then defined by:

LR=2*(LL(β)−LL(0)) (60)

where LL(β) is the value of the log-likelihood function of the estimated weights and LL(0) is its value when all the weights are set equal to zero. The LRT statistic approximately follows a chi-square distribution. To determine if the difference in likelihood scores among the two models is statistically significant, we must consider the degrees of freedom. In the LRT, the degrees of freedom are equal to the number of additional parameters in the more complex model. Knowing that the basic model has all weights equal to zero, the degrees of freedom is then equal to the number of coefficients in the complex model. Choice Modeler 410 determines the value of the Chi-square distribution from standard statistical tables and compares it to the value of LR. If LR is greater than this value then it means that the model is significantly better than the basic model.

### 3C-3. Comparison of Two Models

Adjusted Rho Square. This statistic has the advantage of ranging from zero, when the estimated parameters are no better than zero parameters, to one, when the estimated parameters perfectly predict the choice of the decisions makers in the dataset. Adjusted rho square is defined as:

$${\overline{ρ}}^{2} = 1 - \frac{LL ( β ) - K}{LL ( 0 )} \qquad ( 61 )$$

where LL(β) is the value of the log-likelihood function at the estimated parameters and LL(0) is its value when all the parameters are set equal to zero. K is the number of estimated parameters. A decreasing Adjusted Rho Square means that the model is over-fit. This statistic is useful for comparison of models with different number of parameters.

### 3C-4. Tests of Model Structure

The previous tests permit to assess the goodness of fit of a given model and not the goodness of specification of the model itself. Choice Modeler 410 uses additional statistical tests that permit to detect if a logit formulation is not valid (violation of the IIA assumption). A violation of IIA assumption means that the alternatives are not independent and then a nested or cross-nested logit formulation is more adequate. IIA assumption tests are based on the comparison of estimation of the Logit Model on full set of alternatives and on a specified subset of alternatives (and the sub-sample of data with choices from this subset). In case of relevant IIA assumption, the estimations of the parameters wouldn't be statistically different.
Hausman-McFadden Test. The aim is then to do two different estimations of the parameters:
Scenario 1: on the universal choice
Scenario 2: on a restricted subset of this universal choice set

If IIA holds, the two sets of estimates should not be different². Let β1 denote the estimates of the same parameters obtained from the whole universal set and Σ1 denote their estimated covariance matrix (this matrix is estimated by the Quasi-Newton method). Let β2 denote the estimates obtained on the subset of alternatives and Σ2 denote their estimated covariance matrix. With the absence of some alternatives in scenario 2, it is possible to estimate only a sub-vector of β. This sub-vector doesn't include the alternative specific constants of alternatives not included in the restricted choice set. The estimation data used for the scenario 2 is the subset of the whole dataset omitting observations with chosen alternatives not in the restricted choice set. ²By different we mean here statistically different meaning that the result of the equality test between the parameter would be true.

Under these assumptions, the statistic:

(β1−β2)′(Σ2−ρ1)(β1−β2) (62)

has a chi-square distribution when IIA is true. The degree of freedom of the chi-square test equals the rank of the matrix Σ2−Σ1.

So to attest if the IIA assumption is true or not, CCRM Modeler compares the value of this statistic with the Chi2 table with the given degree of freedom. If it is greater than the IIA is true, else the IIA assumption is rejected and the Logit formulation is not adequate.
McFadden Omitted Variable Test. The aim of this test is to introduce new variables defined using a subset of alternatives.

Step 1: Estimate the basic Logit model, using all the observations.

Step 2: Suppose A is a specified subset of alternatives. Create new variable:

$${z}_{in} = \{ \begin{matrix}- log ( \frac{{P}_{in}}{{\sum }_{j ∈ A} {P}_{jn}} ) & if i ∈ A \\ 0 & if i ∉ A\end{matrix} \qquad ( 63 )$$

where Pᵢₙ is calculated using the basic model estimates.

Step 3: Estimate an expanded model that contains the basic model variables plus the new variables zᵢₙ, and carry out a likelihood ratio test that the coefficients of zᵢₙ are zero:

LR=2[(Log likelihood with z's)−(Log likelihood without z's)]

If IIA holds, then this statistic has a chi-square distribution with one degree of freedom. This test is equivalent to a test of a basic Logit model against a Nested Logit model with the single nest A. However, it is simple to test the Logit model against several nests at once, simply by introducing an omitted variable for each suspected nest. The coefficients of the omitted variables provide some guide to the choice of nesting structure if the IIA hypothesis fails.

All these tests are statistical tools which assist the analyst in validating or rejecting a given model. The different steps of the analyst are as follows. Before testing nested logit models, he begins by a logit formulation. Then the first output to be examined is the likelihood ratio. Then, he examines the signs and relative values of the parameters estimates and the significance of individual parameters. In case of more than one specification, everything else being equal, a specification with the higher maximum likelihood is considered better. To compare two models with different number of parameters to estimate, the analyst may use the adjusted rho square, the model with the highest adjusted rho square is the best one.

Finally to assess if the logit formulation is not valid, the analyst observes the IIA assumption tests. If the IIA assumption is rejected, he may try new model specifications with a nested or cross-nested formulations. Then he can compare the different nested models using the “adjusted rho square” statistic.

For a complete description of these tests, see the references [R5] and [R6].

### 4—Model Validation

The Maximum Likelihood method permits to calculate the model parameters (including the weights and other parameters to estimate like the αᵢ) and the statistical tests. The following Tables 21A and 21B illustrate an example of displayed results.

TABLE 21A
Choice Dataset

| | Preferred resort = “Punta |
|---|---|
| Segment (Tree leave/node) | Magna” |
| Transaction Period | January 2006 |
| Number of Observations | 250 |
| Number of Customers | 159 |
| Number of Alternatives | 7 |
| Number of parameters to estimate | 23 |

TABLE 21B
Model Results

| | |
|---|---|
| Initial Log-likelihood | −631 |
| Final Log-likelihood | −580 |
| Likelihood Ratio | 102 |
| Chi2 Test (95%) | Succeeded |
| Chi2 Test (90%) | Succeeded |
| Adjusted Rho Square | 0.87 |
| Convergence | Succeeded |
| Final Gradient Norm | 0.000056 |

### Remarks:

The table of results is displayed to the Analyst on User Interface. As shown, it first summarizes the choice dataset:
Segment: leaf or upper node of the segmentation tree which has been selected
Transaction period (corresponding to the chose data set)
Number of choice situations
Number of customers in the segment
Number of alternatives used in the modeling (including the Loss and the Keep)

Second, it includes the general tests results:
The initial Log-likelihood (with all β parameters set to zero)
The final log-likelihood (at the maximum)
The likelihood ratio as defined here above
The Chi2 test result at 95% (comparing the likelihood ratio with the value of a standard Chi-square distribution tables at 95%). It the example of Table 21B, the chi2 test succeeded then we can assume with 95% confidence that the model is better that the null model (with all parameters equal to zero).
The Chi2 test result at 90% same that the precedent but with a confidence level equal to 90%.
Adjusted Rho Square as defined above
The convergence status of the maximization procedure (if occurred or not). In the example of Table 21 B, the convergence occurred which means that the maximum likelihood has been reached.
The final nor m of the gradient. This norm is one criteria of assessing the convergence of the Quasi-Newton method and stopping the iterative procedure of maximization. At the convergence, this norm should be very near from zero (less than a given small value defined by the Analyst).

Choice Modeler 410 displays all these tests in order to help the analyst assessing the goodness of the model (model versus the null model with all parameters equal to zero).

Third, Choice Modeler 410 displays a table containing the estimation of the model parameters. Table 22 shows an example of results. The table includes:
The name of the variable (constant, characteristic or attribute)
If the related weight is “alternative specific” or not (“generic”)
The estimation of the weight (or Weights by alternative in the case of alternative specific weight)
The estimation of the standard deviation (SD) of this estimator
The plausibility of the estimation: if the Analyst has already entered a prior on the sign or value of a given parameter, this column indicates if the estimated value matches this prior.
The value of the T-test (or P-value) related to the weight estimator. In the following table, only T-tests are displayed.
The outcome of the t-test (success or not): this outcome is equal to “success” if the value of the T-test is absolutely greater than “1.96”.

In the case of an alternative specific weight, the number of lines displayed is equal to the number of alternatives. The analyst can then unfold the corresponding lines of the table thanks to the [symbol] (unfold) and [symbol] (fold) buttons to view the detail of the model result by alternative.

In the other case, only one line is displayed including the estimation of the related weight.

The T-tests results help the analyst assessing if a given variable influences the choice. If the result of the T-test is “success”, then the related weight is significantly different from “0” and the related variable influences the choice. In the case of failure of the T-test, CCRM can't assess that the weight is different from “0” and the related variable does not influence significantly the choice and can be removed from the model and a new formulation of the utilities without the given parameter may be better.

### 5—Model Predictions

Choice Modeler 410 produces probabilities of choices for each customer in the segment dataset by applying the choice model under validation to each offer/offer instance/offer set or offer sequence (refer to CCRM Optimizer 200 for a detailed description of prediction/forecasting methods). Then Choice Modeler 410 aggregate these predictions at the segment level by averaging the probabilities of choice of each customer contained in the dataset.

Predictions produced at this stage are averaged for the “typical” customer in the segment and not differentiated according to customer characteristics which may vary within a given segment. We will refer to these predictions hereafter as “Model Average Predictions”. As the choice model could use customer characteristics as predictive variables, the results found when applying the model to a given customer could be different from the Model Average Prediction (see CCRM Optimizer 200). However the prediction at the segment level is important to help the Analyst validate the choice model.

### 6—Advanced Prediction Management

The objective of CCRM Modeler is to help fine-tune analyst predictions that could be supported by a simple analysis of choice rates (see Prediction Management 330). In practice, predictions made by the analyst based on CCRM Analyzer could have the following shortfalls:
They may be produced only for offers, offer instances, offer sets or offer sequences that have already been presented to the customer in the past and for which historical choice rates can be calculated. This excludes in principle new offers or existing offers or sets/sequences that have never been presented.
Even though CCRM Analyzer permits the analyst to enter his priors (predictions) for such new offers, the number of instances/sequences/combinations to consider in practice is often daunting. For example, the possible arrangements of 10 offers proposed in 3 sequences is equal to 10*9*8=720. If the number of segments is equal to 100. It is necessary to control 72,000 predictions which results to be a very difficult task in practice.
Historical rates are averaged by segment and do not take into account variations in customer characteristics or preferences within a given segment.

Key advantages of Choice Modeler 410 are its capability to:
Automatically produce predictions for a large number of offer instances/sequences/sets including those that have never been proposed to customers in the past.
Adapt to variations in offer attributes. Changes in prices or in other offer attributes over-time are automatically taken into account by the choice model, which is not the case with predictions based exclusively on historical choice rates.

The analyst can check the Model Average Predictions resulting from the choice model for a given offer, offer instance, offer set or sequence. Combined to the statistical tests described above, these predictions are the keys that the analyst uses in order to validate the model. Choice Modeler 410 also permits the analyst to modify model predictions when he estimates them wrong based on his “a priori” or set minimum or maximum values for Forecasts. Predictions are defined for each segment and are displayed using the same User Interface that predictions built with CCRM Analyzer 200. The Prediction View of Prediction Management 330 is enriched with the consideration of Model Predictions and Forecasting Limits.

Predictions validated by the Analyst and Forecasting Limits are then used by CCRM Optimizer 200. We will distinguish three cases for the purpose of presenting the functionality of Prediction Management using Choice Modeler 410:
Instantiated offers with variance in attribute values (price . . . )— ref. Business Case #1,
Sequenced offers, presented one at a time—ref: Business Case #2,
Simultaneous offers, presented in combination/sets—ref: Business Case #3.

### 6A—Case of Instantiated Offers

Let us consider the same example treated in Tables 10 (CCRM Analyzer). Table 23 hereafter presents the Prediction View enriched with the results of Choice Modeler 410

### Comments:

Here the Reference period is the model reference period
Model Average Predictions are aggregated probabilities (at the segment level) of choosing the given offer instance if it is proposed alone versus the Loss alternative.
Origin fields indicate if the prediction has been generated from the Model “M” or if it is an override “O” by the analyst.
If Model Predictions are activated and if the analyst chooses to apply the historical rate, this value is considered as an override and will have the tag “O” and not “R”.
The precedent predictions if they have the origin “O”, once saved, apply to every value of the other negotiation variable and to all the segment.
In case of mouse click on a given value of choice probability, a new window is opened and the details of the probabilities by customer are displayed.

### 6B—Case of Simultaneous Offers

As for predictions built with CCRM Analyzer, two prediction modes are possible in this case: Simple Mode and Expert Mode.

6B-1. Simple Mode

Predictions are made by offer. Model Average Predictions are aggregated probabilities (at the segment level) of choosing the given offer if it was proposed alone versus the Loss alternative.

### Comments:

By clicking on the Model Average Predictions, the analyst accesses the details of the choice probabilities by customer.
When the Analyst makes an override, the value is used for the whole segment.

6B-2. Expert Mode

In the Expert Mode, the prediction is made by offer set. For a given offer set, the analyst sees the historical rates and the Model Average Predictions of choice among the choice set (aggregated at the segment level). If he decides to enter an override, he enters a prediction of choice probability for each offer in the choice set. The conversion probability of the offer set is equal to the sum of predicted choice probabilities of offers in the set. Table 25 shows an example:

### 6C—Case of Sequenced Offers

Two prediction modes are also possible in this case: Simple Mode and Expert Mode.

6C-1. Simple Mode

Predictions are made by offer. Same principle as in the case of simultaneous offers.

6C-2. Expert Mode

In this mode, the prediction is made by offer sequence. For a given offer sequence, the analyst sees by offer in the sequence, the choice rates (if the sequence has historical data) and the Model Average Prediction aggregated at the segment level. For each offer, the Model Average Prediction is the probability of choosing the offer at the end of the sequence knowing the sequence order. This probability is different from the probability of choosing the offer among the choice set.

The Analyst may also enter his prediction of choice probability for each offer in the sequence (knowing the sequence order). The conversion probability of the offer sequence is equal to the sum of predicted choice probabilities of offers in the sequence.

There are two possible views. The first one, similar to CCRM Analyzer Prediction View is shown in the following Table 26

The second view is especially used when analyzing a new sequence that has no historical data. It permits to access the details of this sequence. It shows the different sub-sequences related to that sequence.

### Comments:

The sub-sequences are displayed by order of presentation to the customer so that the first sub-sequence displayed is the sequence containing only one offer (first one in the sequence).
By scrolling down each subsequence, the analyst accesses to the relative choice set (not ordered offers). This choice set contains the offers in the sub-sequences but also the Loss alternative and the Keep alternative (in case of non final sub-sequence). This table permits the analyst to validate the prediction of the model concerning the choice probabilities among the choice sets in the given sequence or sub-sequence.

The arrow “→” at the end of a given sub-sequence means that this sub-sequence is not final which means that the Keep alternative belongs to the relative choice set.

### General Functionality of Advanced Prediction Management

When a new offer is added to the product catalog or when significant attributes of an existing offer are changed (ex: price), Choice Modeler 410 calculates choice probabilities for the new/changed offer (for each segment) based on the attribute weights (case of a new offer without addition of a new choice attribute). The analyst will be able to override these initial Model Predictions with its own priors (for each segment) and wait until sufficient data is collected to model actual customer choices. The analyst can define a minimum exposure rate to test the new offer as well as conditions/alerts for reviewing the Predictions. Choice Modeler 410 provides the following features:
Forecast Limits: forecasts elaborated based on the Choice Modeler could be set to remain, for a given offer/offer instance/offer set/offer sequence, above a minimum value and/or below a maximum value defined by the analyst. For example the analyst can impose that the choice probability of offer O1 shall be comprised between 30% and 40%. Forecast limits could be set for any node of the segmentation tree (including the root and the terminal leaves). The could be set for a particular offers/instance/sequence/set or in general terms for any type of offer.
These Limits could be automatically released on a given date in the future or when the number of exposures of the offer/offer instance/offer set/offer sequence reaches a threshold defined by the analyst.

These different advanced override rule can be defined by segment and by offer/offer instance/offer set/offer sequence in the different Prediction Modes (simple or expert).

### 7A: Storage of the Model

After validating the results of the model and its predictions, the configuration of the model is stored in the Model Tables:
Model id, name and comments
The data period (of application)
The segments (of application) which may be different from the dataset segment(s) chosen to calibrate the model. This is done by a multiple selection (check-boxes) of terminal leaves or upper nodes of the segmentation tree.
The type of model (logit, nested or cross nested . . . );
In case of a nested or cross nested model, the alternative's tree structure;
The number of alternatives with their nature (offer, Loss alternative or Keep alternative);
The list of customer characteristics used in the model;
The list of offer attributes used in the model and the transformation function to apply (if any). In the case of a nested structure, it contains several sub-lists: the list of attributes common to all alternatives and the list of attributes common the alternatives in the same nest;
For each offer attribute, a boolean variable equal to one if the weights related to this variable are alternative specific and zero else;
The list of weights and their estimated values;
The list of other parameters (degrees of membership for example . . . ) and their estimated values;
For every weight, the reference of the related variables and alternative (in case of alternative specific weight);
For every other parameter (degree of membership or scale parameter μ), the reference of the related nest.

### 7B—Storage of the Predictions (Overrides)

When the analyst enters overrides and validates them, theses values are transmitted to the Predictions Tables for storage. For a complete description of the data transmitted see storage of prediction in Analyzer section.

### 8—Update of the Modeling

There are two ways of refreshing the current model: the scheduling and the update on analyst request.

### Analyst Request:

For a given segment, the Analyst may update the stored model and its predictions at any time. He configures then a new model and launches the estimation. After seeing the results, he may validate it or not.

### Scheduling:

For a given segment, the scheduling mode is based on a model configuration which is already saved. The aim is to refresh the dataset used for the estimation and launch a new estimation of the parameters on the new dataset (new observations that occurred after the last estimation of the model). The parameters that are configured for the scheduling mode are:
1. The date and time of launch of the new estimation or the frequency of launching (every day or week at a given time).
2. The new dataset: to refresh the dataset, the Analyst refreshes the reference period. Let's suppose that the dataset used in the stored model corresponds to the reference Period P1 and have N observations. Let's denote P2, the period between PI and the scheduled date.
   When configuring the scheduling, the analyst can choose:
      To launch the new estimation on the period: P1+P2
      To launch the estimation only on the period P2
      To launch the estimation on the last N observations

To manage the scheduled model and validate it, several alerts are available. They permit the Analyst to see if the new model is as good as the last one and it some important changes have occurred.

### Alerts:

There are the different types of alerts for the monitoring of the scheduling by segment, some of them are more important than the others. There are three possible labels from the more important to the less important alert: “Urgent”, “Important” and “Caution”. “Urgent” Alerts can not be ignored by the Analyst.

Here is a description of these alerts:
Alerts about data size: if there are not enough observations in the new dataset, an “Urgent” labeled alert is generated. The minimum number of observations is a parameter specified by the “Analyst”.
Alerts about the goodness of the new model, theses alerts are based on the comparison of the results of the new model with the last one:
In case of non convergence of the new model, a labeled “Urgent” alert permits to warn the Analyst that the new dataset has to be changed because it didn't permit the estimation of the model.
If the new likelihood ratio test fails, a “Urgent” alert is generated.
If the new Adjusted Rho Square is smaller than the last one, a labeled “Important” alert is generated.
If the sign of a given weight has changed, a labeled “Important” alert is generated.
If the relative variation of a given weight is greater than a given limit (also fixed by the Analyst), a labeled “Caution” alert is generated.
If the t-test of a given variable is not significant, an “Important” alert is generated
If the t-test of a given variable was not significant in the last model and became significant in the new model, a “Caution” alert is generated
If the Influence Index (see segmentation) of a dummy variable changes, a “Caution” alert is generated
Alerts about the predictions gaps: these alerts are based on the values of the different model predictions (for a given offer/offer instance/offer set/offer sequence). These probabilities are the aggregated probabilities at the segment level.
If the relative variation of a given choice probability is important (greater than a given limit), then an “Important” alert is generated.
In the case of availability of an Analyst min-max override, if the choice probability is superior or inferior to these limit, an “Important” alert is generated.
In case of availability of an Analyst override for the given choice probability, if the relative variation between this override and the calculated probability exceeds a given limit, an “Important” alert is generated.

An alert may also be a combination of some of the previous alerts.

The analyst also defines the frequency of alert generation (monthly, weekly, daily, every N hours).

The configuration of alerts is stored in the CCRM Database.

When seeing the alerts, the Analyst may:
change status to “read”
change status to “ignore” (this action is possible for all alerts except for those who have the label “Urgent”)
enter a comment

Choice Based Segmentation 420

Choice Based Segmentation 420 permits to validate and refine the segmentation based on actual customer choices. It is launched either on analyst request or in scheduled mode.

### 1—Segmentation Configuration

First the Analyst has defined a primary segmentation using Tree Based Segmentation 310. Let us denote this primary segmentation: S₁, . . . , Sₘ, . . . , S_{M}. By clicking on a given segment Sₘ, the analyst sees a list of customer characteristics (including preferences and requirements). The characteristics that had already been used in the primary segmentation are marked in this list. The analyst configures a choice model by choosing several customer characteristics that may influence the choice behavior for this segment Sₘ: let's denote the chosen characteristics: Cₗ, . . . , C_{K}. This list may be different from one segment Sₘ to another S_{m′.}

For segmentation purposes, Choice Based Segmentation 420 uses a simple Logit formulation and a list of 1 to 3 basic offers attributes (for example including Price) is sufficient. However Choice Based Segmentation 420 permits the configuration of more complex models if the analyst wants to introduce additional offer attributes.

For each segment Sₘ, the configuration of the “secondary” segmentation contains the following data:
Reference of the segment Sₘ and its definition (involved characteristics and categories or breakpoints defining the categories, sub-segments . . . );
List of chosen (customer) characteristics and (offer) attributes defining the logit model that will be used to refine the segmentation.

### 2—Refinement of the Segmentation

Once the model configuration is defined, Choice based Segmentation 420 prepares the data (step 2A). It first accesses the Customers Tables in order to retrieve the customers belonging to segment Sₘ. Then it invokes Choice Modeler 410. The following data is transmitted:
the references of the related customers,
the configuration of the model including the list of variables.

### 3 to 4—Customer Choice Modeling

At reception of the previous data, Choice Based Segmentation 420 accesses the Transaction Tables in order to retrieve the related choice dataset necessary for the modeling.

Refer to the procedure described in Choice Modeler 410. The output of this procedure is a table with the estimated weights and their p-value. This table is transmitted to Choice Based Segmentation 420.

### 5—Sub-Segmentation Procedure

Let's assume that there are J+1 alternatives in the universal choice set corresponding to J offers in addition to the Loss alternative. For the sake of clarity, we assume that there is only one offer attribute denoted Xᵢₙ and that the weight associated to this attribute doesn't vary across alternatives, which means that the analyst has a prior that this attribute influences the utilities of all alternatives in the same way. This assumption is not that strong especially because we are only interested at this stage by characteristics weights and not by attributes weights. Remark: in case of several attributes, the method used to sub-segment is the same.

For a customer n, the deterministic utilities of each alternative are:

$${U}_{1 , n} = {α}_{1} + {β}_{1} {C}_{1 n} + {γ}_{1} {C}_{2 n} + … + {ϕ}_{1} {C}_{Kn} + θ {X}_{1 n} \\ {U}_{2 , n} = {α}_{2} + {β}_{2} {C}_{1 n} + {γ}_{1} {C}_{2 n} + … + {ϕ}_{2} {C}_{Kn} + θ {X}_{2 n} \\ ⋮ \\ {U}_{J , n} = {α}_{J} + {β}_{J} {C}_{1 n} + {γ}_{J} {C}_{2 n} + … + {ϕ}_{J} {C}_{Kn} + θ {X}_{Jn} \\ {U}_{Loss , n} = + θ {X}_{( J + 1 ) n} \qquad ( 63 )$$

The characteristics Cₖ can be either continuous, discrete/dummy. The deterministic utility of the Loss alternative does not include any constant or characteristic weight for identification purpose. Because only the differences between utilities are meaningful, adding a constant to alternatives utilities does not affect the choice probabilities.

For each customer characteristic, there are J different weights, each one related to one alternative. So in order to decide if a characteristic is relevant to predict choices, Choice Based Segmentation 420 analyses the J weights related to this variable. If most of these weights are significantly different from zero then it is assumed that the characteristic influences most of the utilities and then influences the choice decision.

To that end, for every characteristic Cₖ, Choice Based Segmentation 420 builds an Influence Index denoted InfIndex(Cₖ) corresponding to the rate of significant weights:

InfIndex(Cₖ)=(# significant weights of Ck/J)*100 (64)

where:
# significant weights of Cₖ is the number of weights of Cₖ for which the p-value is less than 5%.

An alternative Formulation of InfIndex is:

InfIndex(Ck)=(j [if(pval k.<5%)*abs(pkj. ACk)])*100 MaxlnfIndex (64′)

where:
if (expression) is equal to 1 if the expression is “true”, else 0
pval^{k}ⱼ is the p-value of Characteristic k for alternative j
β^{k}ⱼ is the weight of Characteristic k for alternative j
ΔCₖ is the “typical variation” of Characteristic across customers. It is equal to 1 in case of a dummy variable it is given by the distribution of the variable, in the case of a continuous variable (for example the difference of Cₖ between the value Cₖ₋ for which 10% of selected customers have a value of the characteristic inferior to Cₖ₋ and the value Cₖ₊ for which 10% of selected customers have a value of the characteristic superior to Cₖ₊ Then Δ Cₖ₌Cₖ₊−Cₖ₋
MaxInfIndex is maximum ivalue of InfValue across characteristics k

Choice Based Segmentation 420 sorts characteristics by Influence Index. The characteristic having the greatest Influence Index is the one influencing the most the choice decision.

Using the statistical p-values as described, Choice Based Segmentation 420 finds for each segment Sₘ an ordered list of predictive characteristics that will be used to expand the segmentation tree.

CCRM uses the following rules for the ranking of characteristics:
All characteristics, even dummy variables, are ranked by Influence Index.
For a discrete characteristic that has several dummy variables, CCRM considers the Influence Index of the dummy variables related to this characteristic and then assigns their highest Influence Index to the characteristic.
CCRM defines a boolean variable called “Influence State” and denoted InfState.

This Boolean is equal to zero if the Influence Index of the characteristic is equal to zero, else InfState is equal to one. InfState permits to distinguish between characteristics influencing (even slightly) the choice behavior and characteristics that do not influence it at all,

InfState(Ck)=0 if InfIndex(Ck)=0, else 1 (65)
For a discrete characteristic that has dummy variables, CCRM creates a list of related dummy variables that influence the choice behavior (dummy variables with Influence State equal to one). This list will be used to create the categories of the segmentation. All dummy variables that do not influence the choice behavior will not be considered.

The ranking of the characteristics is then transmitted to the analyst and displayed on the User Interface.

### 6—Review and Validation by the Analyst

The list of ranked characteristics Cₗ, . . . , C_{K} is returned to the analyst with for each characteristic:
If discrete: the list of significant dummy variables (Influence state equal to one) with their Influence Index.
If continuous: the value of the Influence state and Influence Index

The analyst has two possibilities:
Choose only the best ranked characteristic and create the next level of segmentation using this variable. In this case the segmentation construction is sequential and the analyst supervises each step of the procedure.
Choose a set of characteristics and construct in one step the whole segmentation.

### First Case

In this case, the analyst chooses only the best ranked characteristic. The next step is to create the categories. If the variable is continuous, the analyst can choose via the interface the number of categories to create. The categories are then created so that the number of customers in each category is equivalent.

If the variable is discrete, CCRM has already the list of significant dummy variables, so it can retrieve the related categories and use only these categories in the sub-segmentation.

### Second Case

The sub-segmentation of each segment Sₘ is made recursively in a top down manner beginning by the first characteristic that influences the most the choice and finishing by the one influencing the least the choice. The split made at each node is based on a single variable, but can result in multiple branches. The different steps are:
Begin by segment Sₘ;
Consider the first predictive characteristic;
Prepare categories: if the predictive characteristic is already categorical, then categories are the ones relative to significant dummy variables, else, categories can be created by dividing the respective continuous distribution of the predictor into a number of categories with an approximately equal number of customers. This number is fixed by the analyst and is the same for all the tree structure;
Split the segment using these categories;
Choose the next predictive characteristic with maximal influence on the choice behavior;
Continue this process until all predictive characteristics in the list are used.

All these steps are made by segment Sₘ, the resulting tree could asymmetrical and have a different number of levels. The retained segments are the terminal leaves.

The procedure is stopped and the analyst is notified if the number of customers within a segment under construction falls below a pre-defined number MIN-CUST.

### Other Functionality

Tree Validation. In order to validate the construction of the primary segmentation, the Influence indexes of the chosen segmentation characteristics may be also calculated for each node of the primary segmentation tree. This procedure shall be applied with a reduced transaction period in order to limit the dataset size.
Influence Indexes by Node Level. Influence Indexes may be calculated at each node of the secondary segmentation and for a set of nodes as well (ex: all nodes of the first, second, third . . . segmentation level) in order to define the optimal sub-segmentation map at a given level of construction of the tree.

FIG. 6E shows an example of asymmetrical tree segmentation for Business Case #1.

Substitution Modeler 430

In some cases, the offers catalog may be very rich and contain alternatives that can be substituted to other ones. This is in particular the case for Airlines (ref Business case #3) and Tour Operators (ref Business case #2).

Let us consider the context of an airline for the purpose of presenting how Substitution Modeler 430 proceeds. In this case a product is a combination of a flight and a fare class.

All the concepts described here-under are applicable to other Industries and Enterprises proposing substitutable offers/products.

Traditional Revenue Management models for airlines are based on the assumption that customers who do not get the product they requested, are lost and travel with a competitor or do not travel at all. The customer's request is then either accepted or the customer is lost.

Actually, when the airline has closed some flights or classes of booking, the choice set of the customer is curtailed. This customer then might consider other products. The unavailability of one product can lead to one of the three following scenarios:
The customer shifts to a higher fare class, same flight;
He shifts to a different flight of the same airline;
He travels with a competitor or does not travel witch means a loss for the airline.

The first scenario depicts a buy-up behavior (also called upsell) and the second one is called recapture. These two concepts, generally neglected, make the modeling of the choices and the optimization of prices more complex than in the case of only one offer or several offers with no substitution effects. Some investigation on this area has been made by researchers (references [R1] and [R4]).

CCRM gives the possibility of incorporating buy-up and recapture in the Revenue Management model. These effects are calculated using the method described hereby based on Customer Choice Modeling.

Assume the airline sells a set of offers ODTF which is a combination of Origin, Destination, Departure Time and Fare. For example an offer ODTF can be (ref: Business Case #3):
From (“ATL”)
To (“DFW”)
Flight SW001 of 2006Mar. 25 departing at 07:00 am
Fare R2: “value” fare non refundable but allowing for change of booking until 7 days in advance of departure with a specific charge,

Let's consider a given itinerary (Origin and Destination) and let's denote related offers OD_{i,j} where:
the index i is the departure time/flight
the index j is the fare varying from j=l (highest fare) to j=J (lowest fare)

P_{i,j} is the fare of the offer OD_{i,j.}

CCRM defines the Buy-up rate by the fraction of rejects on offer OD_{i,j} that are recaptured onto offer OD_{i,j-l} which corresponds to a higher fare class.

At a disaggregated level, for a given customer n, the buy-up can be interpreted as the probability that the customer n who has not been able to buy offer OD_{i,j} (turn-way) will choose offer OD_{i,(j-l)}

$${BU}_{n} ( {OD}_{i , j} ) = \frac{\begin{matrix}{P}_{n} ( {OD}_{i , j - 1} \vert {OD}_{l , j} ∉ Ω ) - \\ {P}_{n} ( {OD}_{i , j - 1} \vert {OD}_{l , j} ∈ Ω )\end{matrix}}{{P}_{n} ( {OD}_{i , j} \vert {OD}_{i , j} ∈ Ω )} \qquad ( 66 )$$

Where Ω is the choice set proposed to the customer.

The recapture ratio is the fraction of rejects on offer OD_{i,j} that are recaptured onto offer OD_{k,l}. At a disaggregated level, for a given customer n, the recapture can be interpreted as the probability that the customer n who was turned-away on offer OD_{i,j} will choose the offer OD_{k,l}

$${RE}_{n} ( {OD}_{l , j} \to {OD}_{k , l} ) = \frac{\begin{matrix}{P}_{n} ( {OD}_{k , l} \vert {OD}_{l , j} ∉ Ω ) - \\ {P}_{n} ( {OD}_{k , l} \vert {OD}_{l , j} ∈ Ω )\end{matrix}}{{P}_{n} ( {OD}_{l , j} \vert {OD}_{l , j} ∈ Ω )} \qquad ( 67 )$$

The term Pₙ(OD_{k,l}|OD_{i,j}∉Ω) denotes the probability of choosing offer OD_{k,l} knowing that the choice set contains OD_{k,l} but not OD_{i,j}.

Buy-up and recapture rates are estimated using the Customer Choice Model. Substitution Modeler 430 permits to build a model for each segment and to estimate the model coefficients. For every customer n in the segment used to build the model, and every offer OD_{i,j}, Substitution Modeler 430 simulates two scenarios (1) OD_{i,j} belongs to the individual choice set and (2) OD_{i,j} does not belong to the individual choice set. Using the model coefficients Substitution Modeler 430 forecasts the two probabilities corresponding to each scenario. Once these probabilities calculated, Substitution Modeler 430 calculate the buy-up and recapture rate for each customer using formulas (66) and (67) here-above.

Substitution Modeler 430 will have to forecast the buy-up and the recapture rates for any hypothetical arriving customer in the future. At modeling time, there is no information about this customer neither about his segment nor his characteristics. Substitution Modeler 430 estimates aggregated buy-up and recapture rates at the market level. To do that, it uses the customer-level buy-up and recapture rates and then it aggregates them given the distribution of the customers in the choice dataset.

It proceeds as follows: for a given customer segment S, Substitution Modeler 430 first selects N customers

(1) who had the offer OD_{i,j} in their historical choice set,
(2) for which OD_{i,j} matches the preferences and requirements (information contained in the Transaction tables).

Then CCRM calculates the average recapture and buy-up rates for this segment:

$${BU}_{segment} ( {OD}_{i , j} ) = \frac{1}{N} {\sum }_{n ∈ S} {BU}_{n} ( {OD}_{l , j} ) \qquad ( 68 )$$

Same for the recapture rate:

$${RE}_{segment} ( {OD}_{i , j} \to {OD}_{k , l} ) = \frac{1}{N} {\sum }_{n ∈ S} {RE}_{n} ( {OD}_{l , j} \to {OD}_{k , l} ) \qquad ( 69 )$$

To calculate these rates at a higher level (market level), let's suppose that there are S1, . . . , SK terminal leaves in our tree segmentation containing each respectively N1, . . . , NK customers. Substitution Modeler 430 calculates for each segment Sₖ the recapture and buy-up rates by averaging the customer's values and then we calculate a Weighted Average on all the segments as follows:

$$\begin{matrix}RE ( {OD}_{i , j} \to {OD}_{k , l} ) = \frac{1}{{N}_{1} + … + {N}_{K}} {\sum }_{{S}_{k}} {RE}_{{S}_{k}} ( {OD}_{i , j} \to {OD}_{k , l} ) \\ and & ( 70 ) \\ BU ( {OD}_{i , j} ) = \frac{1}{{N}_{1} + … + {N}_{K}} {\sum }_{{S}_{k}} {BU}_{{S}_{k}} ( {OD}_{i , j} ) & ( 71 )\end{matrix}$$

Buy-up and recapture probabilities are then used in the optimization procedure (refer to Costing 260). Given the propensity of customers to choose a higher-fare offer when a lower-fare offer is unavailable, sometimes it is more interesting for the Enterprise not to propose the lower fare offer in order to stimulate the buy-up.

This decision has a different logic than the decision to close a particular fare class in order to protect capacity for highest yield demand. This decision process may result in closing certain fare classes, even though their price is above the “bid price” that would be calculated by a traditional RMS.

CCRM Sales Monitor 500

Sales Monitoring is the process of systematically comparing the initial orders with the actual sale invoices in terms of quantities of product sold, revenue or Sales Cubes.

As is shown in FIG. 1, CCRM Sales Monitor 500 processes customer invoice lines extracted from the ERP and produces three types of outputs
Sales Cubes tables;
Realization Rates tables;
Ancillary Revenue tables.

Moreover, CCRM Sales Monitor 500 compares the Actual Sales Cubes to Negotiated Sales Cubes and generates Compliance Alerts when actual values differ from expected values. These different procedures are executed in batch mode with a frequency defined by the Analyst (typically weekly, monthly or quarterly).

### 1—Sales Cubes

Sales Cubes are multidimensional aggregates of invoice lines per Customer (or Segment) and product/service. They describe the buying pattern of each customer and are used by the Rating module and the Costing module for the optimization of B2B contracts with recurring sales.

### 1A. Configuration of Sales Cubes Using Sales Profiles

Sales Cubes can be configured as crossings or elementary tree data structures, called Sales Profiles, whose nodes correspond to categories of invoice line attributes. Remark: each invoice line corresponds to the most elementary sale and refers to such objects such as product/service, time of delivery.

For example in the case of Business Case #1 (Parcel Transport Operator), Sales Profiles may be built using the following attributes of shipment objects referred to in each order line: Product, Origin, Destination, Weight, Day of Delivery, Month of Delivery.

The following Sales Profiles may be defined for the purpose of Rating and Costing calculations:
Product Sales Profile: giving the number of shipments by product, according to the hierarchy defined in the product catalog.
“Destination Sales Profile: with flexible “zoning” by country, then region, then depot, giving the number of shipments by country, region and depot;
“Weight Band Sales Profile: for example [0,1[, [1,2[, [2,3[, [3,4[, [4,5[ . . . . [29,30[, [30,999]);

Sales Cubes are then defined based on these Sales Profiles, each “cell” of the Sales Cube corresponding to the crossing of the most detailed nodes of the Sales Profiles. Example in Business Case #1, cells may correspond to crossings of the following attributes categories.

Example: Cell #1 corresponds to the crossings of:
Product=“Domestic Overnight before 10:00 am”
Destination: Country=“France”/Region=“R1”/Depot=“TLS”
Weight Band=[0,1[
Delivery Month=“January-2006”
   1-b. Calculation and Storage of Sales Cubes

Customer Actual Sales Cubes are populated by an aggregation of invoice lines. Each cell of the Sales Cube contains aggregates of price variables and cost variables for different periods (ex: month, year . . . ).

For each cell in the Sales Cube (such as cell #1 here-above) and also for cell corresponding to the crossing of upper nodes of the related Sales Profiles, CCRM Sales Monitor 500 calculates aggregates of the price variables used in the formulation of price and cost variables used in the costing models such as, for example, in Business Case #1: the number of shipments, the number of parcels, the number of kgs.

These cost and price variables are stored in the Sales Cube table by customer for each customers with sales activity during the period of time (here “January-2006”).

### 2—Realization Rates and Compliance Alerts

Realization rates (refer to Glossary) are calculated by offer category, offer and customer segment by a batch procedure which processes the actual sales activity variables of each customer for a pre-defined period of time (week, month, quarter . . . ). These activity variables are contained in the Sales Cubes tables. CCRM Sales Monitor compares these values with the initial orders/bookings or negotiated sales profiles. This procedure generates compliance alerts when the actual sales deviate from the expected sales.

### 3—Ancillary Revenue

Ancillary revenue is calculated by offer category, offer and customer segment by a batch procedure which processes the sales invoice of each customer on a regular basis (quarter, year . . . ).

### Business Cases

CCRM can be configured to handle a great variety of business situations. The following three business cases illustrate possible configurations of the system. The examples refer to offers of services. However it shall be noted that CCRM could as well serve to optimize the sale of a large variety of products, notably over the Internet.

### Business Case #1: Parcel Transport Operator (B2B Sales)

Star Express (SE) provides Parcel Express and Courier transportation services to business customers. SE Account Managers use CCRM Transaction Manager 100 to collect customer characteristics, service preferences and traffic requirements. CCRM Transaction Manager 100 then accesses the Product Catalog to retrieve offers that match these requirements and preferences as well as the Price Catalog that will provide the possible price points for each offer, the negotiation variables and their possible values for that type of customer.

Table 30 presents an example of Optimization Request message sent to CCRM Optimizer 200 for a particular transaction, which involves a potential contract with an Electronic company from the South West region. The Account Manager has forecasted 1,500 shipments per month for this customer. He has entered in Transaction Manager 100 the needs of the customer in terms of service attributes as shown in the resulting customer Needs Table (Table 28)

TABLE 28
Customer Needs

| | | | | | APW | VPW | AVPW |
|---|---|---|---|---|---|---|---|
| k, l | Attribute | Value | | AVS | (%) | (%) | (%) |
| 1, 1 | Delivery Day | D + 1 | | 1 | 40 | 100 | 40 |
| 1, 2 | Delivery Day | D + 2 | | 0 | 40 | 0 | 0 |
| 2, 1 | Collection | <04:00 | pm | 0 | 35 | 0 | 0 |
| | Time | | | | | | |
| 2, 2 | Collection | 04:00-06:00 | pm | 1 | 35 | 40 | 14 |
| | Time | | | | | | |
| 2, 3 | Collection | >06:00 | pm | 1 | 35 | 100 | 35 |
| | Time | | | | | | |
| 3, 1 | Delivery Hour | <08:00 | am | 0 | 25 | 0 | 0 |
| 3, 2 | Delivery Hour | <09:00 | am | 1 | 25 | 60 | 15 |
| 3, 3 | Delivery Hour | <10:00 | am | 1 | 25 | 100 | 25 |
| 3, 4 | Delivery Hour | <12:00 | am | 1 | 25 | 20 | 5 |

Legend:
k, l: Index of attribute k and index of value l
AVS: Attribute Value Selection. “1” means: “matches customer requirements”.
APW: Attribute Preference Weight. The total of APW across attributes is equal to 100%
VPW: Value Preference Weight. The maximum for a given attribute is 100%
AVPW: Attribute Value Preference Weight (defined as APW * VPW)

The Customer Needs table shows that the offer instance with the highest Preference Index for that customer corresponds to 1,1+2,3+3,3 (collection time after 06:00 pm with delivery at D+1 before 10:00 am). The Preference Index of this offer is PI=35%+40%+25%=100%. Table 29 shows the preference indexes of the different offers obtained by combining the possible values of the attributes. Each line corresponds to a possible instance of the offer.

TABLE 29
Preference Indexes

| Offer | Delivery Day | Collection Hour | | Delivery Hour | | AVS | AVS | AVS | AVS | PI |
|---|---|---|---|---|---|---|---|---|---|---|
| (i) | (k = 1) | (k = 2) | | (k = 3) | | k = 1 | k = 2 | k = 3 | all | (%) |
| 1 | D + 1 | <04:00 | pm | <08:00 | am | 1 | 0 | 0 | 0 | 40 |
| 2 | D + 1 | <04:00 | pm | <09:00 | am | 1 | 0 | 1 | 0 | 55 |
| 3 | D + 1 | <04:00 | pm | <10:00 | am | 1 | 0 | 1 | 0 | 65 |
| 4 | D + 1 | <04:00 | pm | <12:00 | am | 1 | 0 | 1 | 0 | 45 |
| 5 | D + 1 | 04:00-06:00 | pm | <08:00 | am | 1 | 1 | 0 | 0 | 54 |
| 6 | D + 1 | 04:00-06:00 | pm | <09:00 | am | 1 | 1 | 1 | 1 | 69 |
| 7 | D + 1 | 04:00-06:00 | pm | <10:00 | am | 1 | 1 | 1 | 1 | 79 |
| 8 | D + 1 | 04:00-06:00 | pm | <12:00 | am | 1 | 1 | 1 | 1 | 59 |
| 9 | D + 1 | >06:00 | pm | <08:00 | am | 1 | 1 | 0 | 0 | 75 |
| 10 | D + 1 | >06:00 | pm | <09:00 | am | 1 | 1 | 1 | 1 | 90 |
| 11 | D + 1 | >06:00 | pm | <10:00 | am | 1 | 1 | 1 | 1 | 100 |
| 12 | D + 1 | >06:00 | pm | <12:00 | am | 1 | 1 | 1 | 1 | 80 |
| 13 | D + 2 | <04:00 | pm | <08:00 | am | 0 | 0 | 0 | 0 | 0 |
| 14 | D + 2 | <04:00 | pm | <09:00 | am | 0 | 0 | 1 | 0 | 15 |
| 15 | D + 2 | <04:00 | pm | <10:00 | am | 0 | 0 | 1 | 0 | 25 |
| 16 | D + 2 | <04:00 | pm | <12:00 | am | 0 | 0 | 1 | 0 | 5 |
| 17 | D + 2 | 04:00-06:00 | pm | <08:00 | am | 0 | 1 | 0 | 0 | 14 |
| 18 | D + 2 | 04:00-06:00 | pm | <09:00 | am | 0 | 1 | 1 | 0 | 29 |
| 19 | D + 2 | 04:00-06:00 | pm | <10:00 | am | 0 | 1 | 1 | 0 | 39 |
| 20 | D + 2 | 04:00-06:00 | pm | <12:00 | am | 0 | 1 | 1 | 0 | 19 |
| 21 | D + 2 | >06:00 | pm | <08:00 | am | 0 | 1 | 0 | 0 | 35 |
| 22 | D + 2 | >06:00 | pm | <09:00 | am | 0 | 1 | 1 | 0 | 50 |
| 23 | D + 2 | >06:00 | pm | <10:00 | am | 0 | 1 | 1 | 0 | 60 |
| 24 | D + 2 | >06:00 | pm | <12:00 | am | 0 | 1 | 1 | 0 | 40 |

Legend:
AVS k: Attribute Value Selection (“1” means “value of this attribute matches customer requirement”)
AVS all: Product of Attribute Value Selections (“1” means “all attribute values matches customer requirement”)
PI: Preference Index PI(i) = SUM k [AVPW(k, val(i, k))]

Then, the Account Manager has recorded the forecasted sales profile and pricing/costing variables for this potential contract:
Collection Depot (“TLS-Toulouse”)
Average Weight per Shipment (1.2 kg)
Concentration Rate (1.3 parcels/shipment)

The Account Manager has entered two Sales Cubes in terms of traffic origins and destinations by Domestic Region (for example: 600 shipments by month—out of a total of 1,500—will be sent from Region R4 (“TLS”) to Region R1 . . . ). A second profile gives the distribution of the 1,500 shipments by Weight band (Between 0 and 1 kg . . . ).

Then, the Account Manager has entered the competitors which are limited in this case to “Olympic Express” with a “Active” status. On this basis, Transaction Manager 100 has accessed the Product Catalog to find candidate offers which match customer preferences and requirements and has selected product “Domestic Overnight before 10:00”. The Account Manager envisions to submit to the customer an offer based on this product with different attribute values
Collection Hour: which may have three possible values (“Before 04:00 pm”, “04:00 pm to 06:00 pm” or “After 06:00 pm”). Each possible value of this offer attribute implies a different cost to serve and a different utility for the customer, translating into a different win probability and expected profitability for the contract. This is why “Collection Hour” is considered a Negotiation Variable. One of the objectives of CCRM Optimizer 200 is to recommend the best value for this negotiation variable and possible trade-offs with price.
Two Pricing Parameters which are used in the formulation of price per shipment: (i) “Price first kg” which may have different values—price points—comprised between $10.00 and $8.60 per shipment; and (ii) “Price add kg” which may vary between $1.40 and $1.00 per additional kg. These values define possible negotiation bands.

TABLE 30
Optimization Request Message (Case of a Parcel Transport Operator) - XML

```
<opRequestId>564854123</opRequestId>
<sessionId>675230310</sessionId>
<transactionId>606732976</transactionId>
<customerId>231678958</customerId>
<context>
    <interactionType value=“SALE”/>
    <competitor name=“OLYMPIC EXPRESS” status=“ACTIVE”/>
</context>
<characteristics>
    <characteristic name=“Region” value=“SOUTH_WEST”/>
    <characteristic name=“Tier” value =“1000-2000”/>
    <characteristic name=“Industry” value=“ELECTRONICS”/>
</characteristics>
<needs>
    <need name=“CollectionTime” value=“4:00PM-06:00PM” AVPW=“0.14”/>
    <need name=“CollectionTime” value=“>+6:00PM” AVPW=“0.35”/>
    <need name=“DeliveryDay” value=“D+1” AVPW =“0.40”/>
    <need name=“DeliveryTime” value=“<09:00AM” AVPW=“0.15”/>
    <need name=“DeliveryTime” value=“<10:00AM” AVPW=“0.25”/>
    <need name=“DeliveryTime” value=“<12:00AM” AVPW=“0.05”/>
    <sales name=“CollectionDepot” value=“TLS”/>
    <sales name=“Shipments” uom=“shp” period=“month” value=“1,500”/>
    <sales name=“AverageWeight” uom=“KG” value=“1.2”/>
    <sales name=“ConcentrationRate” uom=“parcels” value=“1.3”/>
    <sales name=“RegionToRegion” dimension1=“REGION” dimension2 =“REGION” uom=“SHP”
    period=“MONTH”>
        <profile cell1=“R4” cell2=“R1” value=“600”/>
        <profile cell1=“R4” cell2=“R2” value=“450”/>
        <profile cell1=“R4” cell2=“R3” value=“200”/>
        <profile cell1=“R4” cell2=“R4” value=“150”/>
        <profile cell1=“R4” cell2=“R5” value=“100”/>
    </sales>
    <sales name=“Weights” dimension1=“KG” uom=“SHP” period=“MONTH”>
        <profile cell1=“0-1” value=“840”/>
        <profile cell1=“1-2” value=“500”/>
        <profile cell1=“2-3” value=90”/>
        <profile cell1=“3-4” value=“50”/>
        <profile cell1=“4+” value=“20”/>
    </sales>
</needs>
<candidateOffers>
    <offer name=“Domestic Overnight before 10:00”>
        <attribute name=“DeliveryDay” value=“D+1”/>
        <attribute name=“CollectionDepot” value=“TLS”/>
        <attribute name=“DeliveryTime” value=“<10:00AM”/>
        <negotiationVariable name=“CollectionTime”>
        <Value=“04:00PM-06:00PM”/>
        <Value=“>06:00PM”/>
        </negotiationVariable>
        <price>
            <priceVariable name=“PriceFirstKg” currency=“$”>
                <PricePoint=“10.00”/>
                <PricePoint=“9.80”/>
                <PricePoint=“9.60”/>
                <PricePoint=“9.40”/>
                <PricePoint=“9.20”/>
                <PricePoint=“9.00”/>
                <PricePoint=“8.80”/>
                <PricePoint=“8.60”/>
            </priceVariable>
            <priceVariable name=“PriceAddKg” currency=“$”>
                <PricePoint=“1.40”/>
                <PricePoint=“1.30”/>
                <PricePoint=“1.20”/>
                <PricePoint=“1.10”/>
                <PricePoint=“1.00”/>
            </priceVariable>
            <priceFormula basis=“SHP” multiplier1=“WEIGHT”>
                <apply>
                    <plus>
                    <ci>PriceFirstKg<ci/>
                    <apply>
                        <times>
                        <apply>
                            <quotient>
                                <ci>multiplier1</ci>
                                <cn>1</cn>
                            </quotient>
                        </apply>
                        <ci>PriceAddKg<ci/>
                        </times>
                    </apply>
                    </plus>
                </apply>
            </priceFormula>
        </price>
    </offer>
....
</candidateOffers>
```

### Comments:

CCRM supports different formulations of negotiation variables and pricing variables. Pricing formulas are defined using the MathML standard (see [R10])
The list of possible price points for a pricing variable may also be formulated in term of a price band (or interval) and a value for the variation step (ex: price in the $10.00 to $6.60 range with a step of $0.20.

### Business Case #2: Tour Operator (Call Center Sales)

Star Holidays (SH) sells Tour Packages through different sales channels including its call center. SH proposes an important number of holiday destinations and provides packages which may include, accommodation, nursery and entertainment for children (kids club), sports practice/training and travel from different origin points.

SH Reservation Agents use a bespoke Reservation System as “Transaction Manager” to collect customer characteristics and travel requirements and preferences. Table 31 shows an example of Request Message sent to CCRM Optimizer 200 within a customer call session.

The Reservation Agent first identified that the Customer calling was a “Repeater” and has already bought different SH packages in the past. He is a “High Value Customer” for SH. Transaction Manager retrieved from the CRM, the following Customer Characteristics that were validated during the call with the customer
Country=France
Zip code=75015
Age=47
Nb of Children=2
Number in Party=4
Age of Youngest Children=4
Age of Oldest Children=8
Frequency of Visit=Repeater
Customer Value=High

The customer has no affiliation and does not claim for any promotion granting access to special offers.

Then, the Reservation Agent has entered through Transaction Manager 100 customer travel requirements and preferences as a result of a Q&A script:
Type of Package Requested=Sky Holiday
Week of Visit=2006 Feb. 12
Number of Weeks=1
Preferred Hotel Category=Three Star
Preferred Destination=Punta Magna
Preferred Room Type=Family
Preferred Room View=No Preference
Requirements for Travel from Residence=No
Requirements for Children Club=Yes
Requirements for Sky Lessons=Yes

In order to accelerate the booking process SH has simplified the collection of preferences and has not implemented a measure of preference weights.

On the basis of these requirements Transaction Manager accessed the Product Catalog to find candidate offers matching customer's requirements, the Price Catalog which maintains their prices as well as the Inventory Control system to check availability of rooms, travel and other service components (Kids Club, Sport Lessons . . . ). Unfortunately, the preferred “Punta Magna” Three Star hotel was no more available for the period requested by the customer. A total of 50+ possible packages that may be proposed to the customer where pre-selected, including the five offers listed as a matter of example in Table 31:
Residential Package (excluding transportation) at “Punta Magna” Four Star Hotel for feb-12
Residential Package at “Punta Magna” Three Star Hotel for feb-19
Residential Package at “Jung Frau” Three Star Hotel for feb-12
Residential Package at “Lac Bleu” Three Star Hotel for feb-12
All Inclusive Package (with transport) at “Lac Bleu” Three Star Hotel for feb-12.

In the context of SH, no competitive information is used to decide which offer to propose to the customers and prices are not negotiated during the sales process.

Transaction Manager 100 added to the Optimization Request Message two important information that may influence willingness to pay
Lead Time booking request is done 56 days in advance
Type of Period: “School Holidays” (February-12 is a school holiday for the Paris area indicating that customers with children going to school may be ready to pay a premium for these periods).

TABLE 31
Optimization Request Message (Case of a Tour Operator)- XML

```
<opRequestId>567245129</opRequestId>
<sessionId>056423467</sessionId>
<transactionId>659875512</transactionId>
<customerId>456624154</customerId>
<context>
    <interactionType value=“SALE”/>
    <leadTime uom =“days in advane” value=“56”/>
    <typeOfPeriod value=“School Holidays”/>
</context>
<characteristics>
    <characteristic name=“Country” value=“FRANCE”/>
    <characteristic name=“ZipCode” value=“75015”/>
    <characteristic name=“Age” value=“47”/>
    <characteristic name=“NbAdults” value=“4”/>
    <characteristic name=“NbChildren” value=“2”/>
    <characteristic name=“CustomerValue” value=“HIGH”/>
    <characteristic name=“Frequency” value=“REPEATER”/>
    <characteristic name=“Affiliation” value=“NO”/>
    <characteristic name=“PromotionCode” value=“NO”/>
</characteristics>
<needs>
    <sales name=“PackageType” value=“SKI_HOLIDAY”/>
    <sales name=“NumberOfWeeks” value=“1”/>
    <sales name=“NbRooms” value=“1”/>
    <sales name=“NbAdults” value=“2”/>
    <sales name=“NbChilds” value=“2”/>
    <sales name=“AgeYoungestChild” value=“4”/>
    <sales name=“AgeOldestChild” value=“8”/>
    <need name=“HotelCategory” value=“THREE_STAR”/>
    <need name=“WeekOfVisit” value=“2006-feb-12”/>
    <need name=“Destination” value=“PUNTA_MAGNA”/>
    <need name=“RoomType” value=“FAMILY”/>
    <need name=“RoomView” value=“”NO_PREFERENCE”/>
    <need name=“TravelIncluded” value=“NO”/>
    <need name=“KidsClub” value=“YES”/>
    <need name=“SkyLessons” value=“YES”/>
</needs>
<candidateOfters>
    <offer name =“Punta Magna Residential 4 Star Package”>
        <attribute name=“PackageType” value=“SKY_HOLIDAY”/>
        <attribute name=“WeekOfStay” value=“2006-feb-12”/>
        <attribute name=“NumberOfWeeks” value=“1”/>
        <attribute name=“NbAdults” value=“2”/>
        <attribute name=“NbChilds” value=“2/>
        <attribute name=“NbRooms” value=“1/>
        <attribute name=“HotelCategory” value=“FOUR_STAR”/>
        <attribute name=“Destination” value=“PUNTA_MAGNA”/>
        <attribute name=“RoomType” value=“SUPERIOR”/>
        <attribute name=“RoomView” value=“MOUNTAIN_VIEW”/>
        <attribute name=“TravelIncluded” value=“NO”/>
        <attribute name=“KidsClub” value=“YES”/>
        <attribute name=“SkyLessons” value=“YES”/>
        <price currency=“$” value=“3,600”/>
    </offer>
    <offer name =“Punta Magna Residential 3 Star Package”>
        <attribute name=“PackageType” value=“SKY_HOLIDAY”/>
        <attribute name=“WeekOfStay” value=“2006-feb-19”/>
        <attribute name=“NumberOfWeeks” value=“1”/>
        <attribute name=“NbAdults” value=“2”/>
        <attribute name=“NbChilds” value=“2/>
        <attribute name=“NbRooms” value=“1/>
        <attribute name=“HotelCategory” value=“THREE_STAR”/>
        <attribute name=“Destination” value=“PUNTA_MAGNA”/>
        <attribute name=“RoomType” value=“FAMILY”/>
        <attribute name=“RoomView” value=“MOUNTAIN_VIEW”/>
        <attribute name=“TravelIncluded” value=“NO”/>
        <attribute name=“KidsClub” value=“YES”/>
        <attribute name=“SkyLessons” value=“YES”/>
        <price currency=“$” value=“2,800”/>
    </offer>
    <offer name =“Jung Frau Residential 3 Star Package”>
        <attribute name=“PackageType” value=“SKY_HOLIDAY”/>
        <attribute name=“WeekOfStay” value=“2006-feb-12”/>
        <attribute name=“NumberOfWeeks” value=“1”/>
        <attribute name=“NbAdults” value=“2”/>
        <attribute name=“NbChilds” value=“2/>
        <attribute name=“NbRooms” value=“1/>
        <attribute name=“HotelCategory” value=“THREE_STAR”/>
        <attribute name=“Destination” value=“JUNG_FRAU”/>
        <attribute name=“RoomType” value=“FAMILY”/>
        <attribute name=“RoomView” value=“GARDEN”/>
        <attribute name=“TravelIncluded” value=“NO”/>
        <attribute name=“KidsClub” value=“YES”/>
        <attribute name=“SkyLessons” value=“YES”/>
        <price currency=“$” value=“1,900”/>
    </offer>
    <offer name =“Lac Bleu Residential 3 Star Package”>
        <attribute name=“PackageType” value=“SKY_HOLIDAY”/>
        <attribute name=“WeekOfStay” value=“2006-feb-12”/>
        <attribute name=“NumberOfWeeks” value=“1”/>
        <attribute name=“NbAdults” value=“2”/>
        <attribute name=“NbChilds” value=“2/>
        <attribute name=“NbRooms” value=“1/>
        <attribute name=“HotelCategory” value=“THREE_STAR”/>
        <attribute name=“Destination” value=“LAC_BLEU”/>
        <attribute name=“RoomType” value=“FAMILY”/>
        <attribute name=“RoomView” value=“MOUNTAIN_VIEW”/>
        <attribute name=“TravelIncluded” value=“NO”/>
        <attribute name=“KidsClub” value=“YES”/>
        <attribute name=“SkyLessons” value=“YES”/>
        <price currency=“$” value=“2,900”/>
    </offer>
    <offer PackageName =“Lac Bleu All Inclusive 3 Star Package”>
        <attribute name=“PackageType” value=“SKY_HOLIDAY”/>
        <attribute name=“WeekOfStay” value=“2006-feb-12”/>
        <attribute name=“NumberOfWeeks” value=“1”/>
        <attribute name=“NbAdults” value=“2”/>
        <attribute name=“NbChilds” value=“2/>
        <attribute name=“NbRooms” value=“1/>
        <attribute name=“HotelCategory” value=“THREE_STAR”/>
        <attribute name=“Destination” value=“LAC_BLEU”/>
        <attribute name=“RoomType” value=“FAMILY”/>
        <attribute name=“RoomView” value=“MOUNTAIN_VIEW”/>
        <attribute name=“TravelIncluded” value=“YES”/>
        <attribute name=“KidsClub” value=“YES”/>
        <attribute name=“SkyLessons” value=“YES”/>
        <price currency=“$” value=“3,200”/>
    </offer>
</candidateOffers>
```

### Business Case #3: Passenger Airline (Internet Sales)

Star Wings (SW) is an airline serving different markets in the US. On the ATL to DFW route, SW proposes 5 daily direct flights (connecting flights are not considered in this example).
SW001 departing at 07:00 am
SW003 departing at 10:00 am
SW005 departing at 12:00 am
SW007 departing at 05:00 pm
SW009 departing at 08:00 pm

SW proposes on each of its flight three different fare products (F1, F2 and F3) with different prices and different sales conditions
F1: “flexible fare”, the most expensive but allowing for transfer (change of reservation) and refund without penalty,
F2: “value fare”, discounted, allowing for change of booking until 7 days in advance of departure with a specific charge, but non refundable,
F3: “flash fare” with the highest discount but non transferable and non refundable.

Each offer is the combination of a Flight instantiated by departure date (i) and a Fare product (j). By convention an offer will be referred to as i,j (ex: SW001,F1)

SW does not differentiate pricing by customer. Hence, all customers have access to the same flight schedules and fares at a given moment in time on a given Origin & Destination. However, SW changes its prices overtime using “Dynamic Pricing” rules. The Price Catalog includes different types of pricing rules to that effect:
Price Points: a set of price points are defined for each origin, destination and flight with possible variations by week and day of week. For example the possible price points for fare F1 on flight SW001 are as follows: {$99, $109, $119, $129, $139, $149, $159}
Price Consistency Rules: on a given flight, the price differential between F1, F2 and F3 follow different rules. Example: for flight SW001:

Price(SW001,F1)−Price(SW001,F2)≧$20

Price(SW001,F2)−Price(SW001,F3)≧$20
It is also possible to set minimum differences between the fare levels of different flights. Example:

Price(SW001,F1)−Price(SW003,F1)≧$10
By convention, minimum price differentials will be calculated by CCRM Optimizer 200 as the difference between the maximum values of the different price point sets.
For example, if:
   Price(SW001,F1)∈{$99, $109,$119,$129, $139, $149, $159}
   Price(SW001,F2)∈{$69, $79, $89, $99, $119, $129, $139}
   Price(SW003,F1)∈{$89, $99,$109,$119, $129, $139, $149}
Then:

Price(SW001,F1)−Price(SW001,F2)≧$159−$139=$20

Price(SW001,F1)−Price(SW003,F1)≧$159−$149=$10
Booking Limits: rules may be defined to limit sales to maximum levels of bookings. These rules may include pricing levels. Example:
   Cumulative sales lower or equal to $119 shall not exceed 30 seats (if capacity is equal to 100 seats this rule is equivalent to “70 seats shall be protected for prices strictly superior to $119”
It is assumed that booking limits are implemented within the Inventory Control System (serving as ERP in this example). Transaction Manager 100 checks price points availability in the ERP before sending the list of possible price points to CCRM Optimizer 200.
Bid Prices: Bid price represents the marginal value of capacity on each flight leg (ex: ATL-DFW). Bid prices take into account the probability to sell the marginal capacity at a given price based on the forecast of unconstrained demand for each flight leg. Bid Prices vary dynamically according to sales. It is assumed that CCRM Optimizer 200 will access the Costing Engine module to retrieve bid prices.

SW Web site serves as “Transaction Manager” when the customer initiates a booking request. Transaction Manager collects the following Travel Requirements and Preferences
Departure Airport=ATL
Destination Airport=DFW
Departure Date=2006 Mar. 3 (wed)
Departure Time=Early Morning
Num of adults=1
Number of children=0
Number of infants=0
Modification Possibility=Required
Refundable Ticket=Not Required

Remark: it is assumed that customer characteristics (such as Frequent Flyer Id . . . ) will be entered at a later stage of the sales process. Then we assume CCRM do not need these characteristics in our example to model choices.

On the basis of these requirements and preferences, Transaction Manager accesses the Product Catalog (the Flight Schedule) to find possible “Candidate Offers” which match customer's travel requirements. The Price Catalog, which maintains pricing rules, and the Inventory Control System (serving as ERP) which maintains flight/fare availability are accessed as well. The following offers are pre-selected (in this implementation an offer is a combination of a Flight and Fare with a Price Point satisfying the rules maintained in the Price Catalog):
Price(SW001,F1)∈{$99, $109, $119, $129, $139, $149, $159}
Price(SW001,F2)∈{$79, $89, $99, $109, $119, $129, $139}
Price(SW003,F1)∈{$89, $99,$109,$119, $129, $139, $149}
Price(SW003,F2)∈{$69, $79, $89, $99, $109, $119, $129}

SW has access to a competitive monitoring tool that provides competitor's prices for each offer. In the ATL DFW route, it is assumed that SW has a unique competitor “Olympic Wings (OW)”. For each previous offer, OW prices for competitive products are as follows:
Price_OW(SW001,F1)=$99
Price_OW(SW001,F2)=$69
Price_OW(SW002,F1)=$99
Price_OW(SW002,F2)=$69

Transaction Manager adds to the Optimization Request Message context information that may influence willingness to pay:
Lead Time: booking request is done 21 days in advance
Day of Week (of travel)
Type of Period: “Standard” indicating that no special event with specific influence on demand behavior is recorded for this period.

TABLE 32
Optimization Request Message (Case of Airline Internet bookings)- XML

```
<opRequestId>001234567</opRequestId>
<sessionId>367656799</sessionId>
<transactionId>867290921</transactionId>
<context>
    <interactionType value=“BOOKING”/>
    <leadTime uom =“days in advance” value=“21”/>
    <typeOfPeriod value=“STANDARD”/>
    <dayOfWeek value=“wed”/>
</context>
<needs>
    <sales name=“FromAirport” value = “ATL”/>
    <sales name=“ToAirport” value =“DFW”/>
    <sales name=“DepartureDate” value=“2006-mar-3”/>
    <sales name=“Adults” value:=“1”/>
    <sales name=“Children” value=“0”/>
    <sales name=“Infants” value=“0”/>
    <need name=“DepartureTime” value=“EARLY_MORNING”/>
    <need name=“Transferable” value=“YES”/>
    <need name=“Refundable” value=“NO”/>
    </needs>
<candidateOffers>
    <offer>
        <attribute name=“FromAirport” value = “ATL”/>
        <attribute name=“ToAirport” value =“DFW”/>
        <attribute name=“DepartureDate” value=“2006-mar-3”/>
        <attribute name=“Flight” value=“SW001”/>
        <attribute name=“Fare” value=“F1”/>
        <attribute name=“FareName” value=“Flexible”/>
        <attribute name=“Transferable” value=“YES”/>
        <attribute name=“Refundable” value=“YES”/>
        <attribute name=“DepartureTime” value=“07:00am”/>
        <attribute name=“Adults” value=“1”/>
        <attribute name=“Children” value=“0”/>
        <attribute name=“Infants” value=“0”/>
        <price currency=“$”>
            <pricePoint =“99”/>
            <pricePoint =“109”/>
            <pricePoint =“119”/>
            <pricePoint =“129”/>
            <pricePoint =“139”/>
            <pricePoint =“149”/>
            <pricePoint =“159”/>
        </price>
        <competitors name=“OW” currency=“$” value=“99”/>
    </offer>
    <offer>
        <attribute name=“FromAirport” value = “ATL”/>
        <attribute name=“ToAirport” value =“DFW”/>
        <attribute name=“DepartureDate” value=“2006-mar-3”/>
        <attribute name=“Flight” value=“SW001”/>
        <attribute name=“Fare” value=“F2”/>
        <attribute name=“FareName” value=“Value”/>
        <attribute name=“Transferable” value=“YES”/>
        <attribute name=“Refundable” value=“NO”/>
        <attribute name=“DepartureTime” value=“07:00am”/>
        <attribute name=“Adults” value=“1”/>
        <attribute name=“Children” value=“0”/>
        <attribute name=“Infants” value=“0”/>
        <price currency=“$”>
            <pricePoint =“79”/>
            <pricePoint =“89”/>
            <pricePoint =“99”/>
            <pricePoint =“109”/>
            <pricePoint =“119”/>
            <pricePoint =“129”/>
            <pricePoint =“139”/>
        </price>
        <competitors name=“OW” currency=“$” value=“69”/>
    </offer>
    <offer>
        <attribute name=“FromAirport” value = “ATL”/>
        <attribute name=“ToAirport” value =“DFW”/>
        <attribute name=“DepartureDate” value=“2006-mar-3”/>
        <attribute name=“Flight” value=“SW003”/>
        <attribute name=“Fare” value=“F1”/>
        <attribute name=“FareName” value=“Flexible”/>
        <attribute name=“Transferable” value=“YES”/>
        <attribute name=“Refundable” value=“YES”/>
        <attribute name=“DepartureTime” value=“10:00am”/>
        <attribute name=“Adults” value=“1”/>
        <attribute name=“Children” value=“0”/>
        <attribute name=“Infants” value=“0”/>
        <price currency=“$”>
            <pricePoint =“89”/>
            <pricePoint =“99”/>
            <pricePoint =“109”/>
            <pricePoint =“119”/>
            <pricePoint =“129”/>
            <pricePoint =“139”/>
            <pricePoint =“149”/>
        </price>
        <competitors name=“OW” currency=“$” value=“99”/>
    </offer>
    <Offer>
        <attribute name=“FromAirport” value = “ATL”/>
        <attribute name=“ToAirport” value =“DFW”/>
        <attribute name=“DepartureDate” value=“2006-mar-3”/>
        <attribute name=“Flight” value=“SW003”/>
        <attribute name=“Fare” value=“F2”/>
        <attribute name=“FareName” value=“Value”/>
        <attribute name=“Transferable” value=“YES”/>
        <attribute name=“Refundable” value=“NO”/>
        <attribute name=“DepartureTime” value=“10:00am”/>
        <attribute name=“Adults” value=“1”/>
        <attribute name=“Children” value=“0”/>
        <attribute name=“Infants” value=“0”/>
        <price currency=“$”>
            <pricePoint =“69”/>
            <pricePoint =“79”/>
            <pricePoint =“89”/>
            <pricePoint =“99”/>
            <pricePoint =“109”/>
            <pricePoint =“119”/>
            <pricePoint =“129”/>
        </price>
        <competitors name=“OW” currency=“$” value=“69”/>
    </offer>
</candidateOffers>
```

1-29. (canceled)

30. A system for recommending products or services to said customers to optimize business transactions or contracts, comprising:
a customer centric revenue management (CCRM) modeler for establishing a disaggregated customer choice model based on account characteristics and known product, service or price preferences of a customer;
a CCRM optimizer for computing at least one choice probability of a potential offer by said customer based on said disaggregated customer choice model established by said CCRM modeler, said potential offer being presented to said customer alone, instantiated across said at least one attribute, in combination with other offers, or as a part of a sequence of offers to provide a plurality of offers collectively referred to as an enterprise offering to said customer, and computing an expected value of each offer of said enterprise offering based on a revenue generated by said offering, incremental or opportunity costs associated with said enterprise offering, and said choice probability of said customer to said each offer of said enterprise offering; and
a transaction manager for recommending whether any offer from said enterprise offering should be presented to said customer that maximizes a business objective, which is based on said expected value of said any offer or said at least one choice probability of said any offer, and determining terms, including at least an offering price, of said any offer to be presented to said customer, thereby improving said enterprise offering to said customer.

31. The system of claim 30, wherein said transaction manager is operable to present said customer with a recommended offer at a determined offering price.

32. The system of claim 30, further comprising:
a CCRM database; and
a CCRM analyzer for:
gathering a plurality of data sets of historical interactions between said customer and sales people or a sales web site, wherein said plurality of data sets further comprise interaction data sets that relate to characteristics of said customer, preferences of said customer, offers previously presented to said customer; and choices of said customer;
storing said plurality of data sets in a plurality of computer system tables in said CCRM database;
analyzing said data sets;
building a plurality of segments grouping certain customers that have same type of choice behavior, wherein said choice behavior of the customers are derived from said interaction data sets stored in said computer system tables in said CCRM database; and
wherein said CCRM modeler is operable to:
define said disaggregated customer choice model of said customer;
calibrate said disaggregated customer choice model based on a sample of historical interaction data of said customer; and
select and apply said disaggregated customer choice model to derive choice probabilities of offers for a new customer in accordance with a segment assigned to said customer based on known characteristics and preferences of said customer.

33. The system of claim 32, wherein said CCRM modeler is operable to define said disaggregated customer choice model of said customer as a discrete choice model based on historical sales interaction data of said customer.

34. The system of claim 30, wherein said CCRM optimizer is operable to improve said disaggregated customer choice model of and said enterprise offering to said customer based outcomes of previous sale interactions of said customer and a test of new offers; and wherein said transaction manager is operable to present a new enterprise offering to said customer on a reduced scale at terms different from previous enterprise offering to said customer or below a maximum expected value, or which results in non-optimal maximum choice probability, thereby guaranteeing minimum levels of exposure for said new offering to the customers so information gathered and derived from customers' choices to said new offering can be incorporated into said disaggregated customer choice model.

35. The system of claim 34, wherein said CCRM optimizer is operable to:
compute at a segment level, an information function for said each offer in said enterprise offering, according to formula:
Info(offer)=Min(ActExp(offer)/EXP_MIN,1),
where ActExp(offer) is a number of exposures (or percent of total exposures) recorded for said each offer of said enterprise offering during a predetermined period of time, EXP_MIN is a minimum number of exposures necessary to obtain a reliable estimation of said choice probability, and info(offer) is equal to 0 if said each offer has not been exposed during said predetermined period and is equal to 1 if said each offer has been exposed at a minimum exposure level EXP_MIN; and
compute a value of learning function VoL(offer) for said each offer of said enterprise offering having one of the following values:
$$\{ \begin{matrix}VOL\_MAX + ( \begin{matrix}VOL\_MIN - \\ VOL\_MAX\end{matrix} ) * Info ( offer ) & if 0 \leq Info ( offer ) < 1 \\ 0 & if Info ( offer ) = 1\end{matrix}$$
where VOL_MIN is an analyst defined monetary coefficient reflecting a value that the analyst grants to increase said information function of said each offer when Info(offer)=1, VOL_MAX is a monetary coefficient defined by the analyst reflecting a value that the analyst grants to increase said information function of said each offer when Info(offer)=0, and VoL(offer) is equal to VOL_MAX if said each offer has not been exposed during said predetermined period and approaches VOL_MIN if said each offer has been exposed near the minimum exposure level EXP_MIN.

36. The system of claim 35, wherein said CCRM optimizer is operable to compute a value of said each offer as a function of a price of said each offer, a cost of said each offer, and said choice probability of said each offer plus said learning function.

37. The system of claim 35, wherein said CCRM optimizer is operable to compute a value of said each offer as a function of a price of said each offer, a cost of said each offer, and said choice probability of said each offer multiplied by said learning function.

38. The system of claim 30, wherein said products or services comprise a portfolio of products/services for said customer that has requirements or preferences that can be satisfied by a set of different offers, and wherein said transaction manager is operable to provide a set of possible offers that said customer can choose from, thereby accounting for substitution effects and cross-elasticity.

39. The system of claim 30, wherein said CCRM optimizer is operable to compute an opportunity cost of a product or service by accounting for substitution effects, including at least recapture and buy up, thereby enabling said transaction to provide or improve offers with substitute goods/services to said customer even when inventories of goods/services are constrained.

40. The system of claim 39, wherein said CCRM optimizer is operable to compute said opportunity cost by:
computing a first value depending on (i) a recapture or buy up rate between said product and a list of substitute products, (ii) prices of said substitute products on said list, and (iii) a forecasted availability rate of said substitute products on said list;
computing a second value depending on a probability of a displacement of marginal demand; and
subtracting a result of a multiplication of said first value by said second value to a bid price of said product, wherein said bid price is computed based on no substitution effect for said product.

41. The system of claim 40, wherein said CCRM optimizer is operable to calculate said opportunity cost (OCi,j) of selling a product (i,j) according to the following formula:
$${OC}_{i , j} = {BP}_{i , j} - {\sum }_{k , l ∈ {Φ}_{i , j}} {PD}_{k , l} * [ {\sum }_{{m , n ∈ {Ω}^{*}}_{m , n \neq k , l}} {RE}_{( k , l \to m , n )} * {PR}_{m , n} * {AR}_{( m , n \vert k , l )} ]$$
where BP_{i,j} is a bid price based on independent demand for said product (i,j) without substitution (buy-up/recapture) effects; PD_{k,l} (probability of displacement of marginal demand) is a probability that a future marginal demand that would be displaced for a given product (k,l) by a sale of said product (i,j), where said given product (k,l) in a set Φi,j shares at least one resource with said product (i,j), Ω* is a list of substitute products substitutable for product (k,l), RE(k,l→m,n) is a recapture or buy-up rate between said given product (k,l) and said substitute product (m,n); PR_{m,n} is a price of said substitute product (m,n); AR_{(m,n|k,l)} is a forecasted availability rate of said substitute product (m,n) given a known arrival distribution of demand for said given product (k,l) and an expected availability curve of substitute product (m,n) depending on time.

42. The system of claim 41, wherein said CCRM optimizer is operable to calculate said probability of displacement of marginal demand PD_{k,l} as a frequency of a marginal demand MD_{k,l} for said given product (k,l) to total marginal demand for said substitute products in the set Φi,j sharing at least one resource with said product (i,j), according to the following formula:
$${PD}_{k , l} = \frac{{MD}_{k , l}}{{\sum }_{m , n ∈ {Φ}_{i , j}} {MD}_{m , n}} .$$

43. The system of claim 41, wherein said CCRM optimizer is operable to compute for an offer OD_{i,j}, a buy-up rate BU corresponding to a probability that a customer (n) who was turned-away or unable to participate in said offer OD_{i,j} will choose an alternate offer OD_{i,j-1} according to the following formula:
$${BU}_{n} ( {OD}_{i , j } ) = \frac{\begin{matrix}{P}_{n} ( {OD}_{i , j - 1} \vert {OD}_{i , j} ∉ Ω ) - \\ {P}_{n} ( {OD}_{i , j - 1} \vert {OD}_{i , j} ∈ Ω )\end{matrix}}{{P}_{n} ( {OD}_{i , j} \vert {OD}_{i , j} ∈ Ω )}$$
where Ω is a set alternate offers proposed to said customer (n).

44. The system of claim 41, wherein said CCRM optimizer is operable to compute a recapture ratio as a fraction of rejections on said offer OD_{i,j} that are recaptured onto an alternate offer OD_{k,l} according to the following formula:
$${RE}_{n} ( {OD}_{i , j} \to {OD}_{k , l} ) = \frac{\begin{matrix}{P}_{n} ( {OD}_{k , l} \vert {OD}_{i , j} ∉ Ω ) - \\ {P}_{n} ( {OD}_{k . l} \vert {OD}_{i , j} ∈ Ω )\end{matrix}}{{P}_{n} ( {OD}_{i , j} \vert {OD}_{i , j} ∈ Ω )}$$
where the term Pₙ(OD_{k,l}|OD_{i,j}∉Ω) denotes a probability of choosing said alternate offer OD_{k,l} given that a choice set Ω contains said alternate offer OD_{k,l} but not said offer OD_{i,j.}

45. The system of claim 43, wherein said CCRM optimizer is operable to:
determine two scenarios for every customer in a segment used to build said disaggregated customer choice model and every offer OD_{i,j}, wherein OD_{i,j} belongs to a first choice set in a first scenario and OD_{i,j} does not belong to a second choice set in a second scenario;
forecast two choice probabilities corresponding to each said first and second scenarios; and
compute buy-up and recapture rates for any potential future customer as an aggregate of buy-up and recapture rates calculated for past and current customers having similar preferences and requirements.

46. The system of claim 30, wherein said transaction manager is operable to display offers with potential availability restrictions as being available if prices of said offers are superior to opportunity costs associated with said offers.

47. The system of claim 32, wherein said CCRM analyzer is operable to segment said customers according to choice behavior of the customers to identify customer characteristics that have a highest influence on choices or offer acceptances by the customers.

48. The system of claim 32, wherein said CCRM analyzer is operable to validate and refine a segmentation based on actual choices or offer acceptances by the customers oil an analyst request in real-time mode or periodically in a scheduled mode.

49. The system of claim 32, wherein said CCRM analyzer is operable to refine a segmentation based on choices of said customer by:
defining a plurality of primary segments (Sₗ, . . . , Sₘ, . . . , S_{M}) based on an analyst priorities, wherein said plurality of segments are built as a segmentation tree Using known characteristics of said customer to sub-segment;
selecting several of said characteristics (Cₗ, . . . , Cₖ, . . . , C_{K}) of said customer influencing a choice behavior of said customer for a given segment
marking in a list said characteristics of said customer used in a primary segmentation;
adding to said list a plurality of basic offer attributes; and
defining a secondary segmentation for said segment Sₘ comprising the following data:
a reference of said segment Sₘ and a definition of said segment comprising characteristics, categories, breakpoints defining the categories, and sub-segments; and
a list of chosen characteristics of said customer and offer attributes defining a discrete choice model for refining said segmentation.

50. The system of claim 49, wherein said CCRM analyzer is operable to expand said segmentation tree by:
defining deterministic utilities of each J+1 alternatives in a universal choice set corresponding to J offers in addition to a Loss alternative for a customer (n) as follows:
U_{1,n}=α₁+β₁C₁ₙ+γ₁C₂ₙ+ . . . +φ1C_{Kn}+θX₁ₙ
U_{2,n}=α₂+β₂C₁ₙ+γ₁C₂ₙ+ . . . +φ₂C_{Kn}+θX₂ₙ
U_{J,n}=α_{J}+β_{J}C₁ₙ+γ_{J}C₂ₙ+ . . . +φ_{J}C_{Kn}+θX_{Jn}
U_{Loss,n}=+θX_{(J+1)n},
wherein there is only one offer attribute Xᵢₙ, a weight associated with said offer attribute does not vary across alternatives, each customer characteristic being either continuous or discrete/dummy, J different weights existing for each customer characteristic, and each weight being related to one alternative;
building an Influence Index InfIndex(Cₖ) for each characteristic (Cₖ) corresponding to a rate of significant weights: InfIndex(Cₖ)=(# significant weights of Cₖ/J)*100, wherein # significant weights of Cₖ is a number of weights of Cₖ for which a p-value is less than 5%;
sorting said customer characteristics by said Influence Index, a customer characteristic having a greatest Influence Index is the one influencing said customer to accept or participate in an offer; and
finding, for each segment Sₘ, an ordered list of predictive characteristics used to expand said segmentation tree.

51. The system of claim 50, wherein said CCRM analyzer is operable to calculate said Influence Index (InfIndex) according to the following formula:
InfIndex(Cₖ)=(Σⱼ[if(pval^{k}ⱼ<pvalLimit)*abs(β^{k}ⱼ*ΔCₖ)*100/MaxInfIndex,
where if (expression) is equal to 1 if the expression is “true” or otherwise is equal to 0, pval^{k}ⱼ is a p-value of a customer characteristic Cₖ for an alternative j; pvalLimit is a limit value for pval, β^{k}ⱼ is a weight of said customer characteristic Cₖ for said alternative j, ΔCₖ is a typical variation of said customer characteristic across the customers equal to 1 for a dummy variable or ΔCₖ is a variation given by a distribution of said variable for a Continuous variable, and MaxInfIndex is a maximum value of InfIndex across the customer characteristics.

52. The system of claim 30, wherein said CCRM optimizer is operable to:
estimate an anticipated revenue, cost and profitability of a negotiated contract governing recurring sale orders;
determining a revenue and costs based on a modeling of a projected sales using (a) sales profiles representing a distribution of sales/orders of said customer and built as tree data structures whose nodes correspond to order lines attribute values and contain aggregates of price variables or cost variables for different units of time, and (b) sales cubes representing multidimensional aggregates of invoice lines per said customer and a product, service, or offer; and
monitor an actual contract realization versus an initial forecast by comparing initial orders with actual orders invoiced.

53. The system of claim 30, wherein said CCRM optimizer is operable to compute an expected revenue generated by a contract governing recurring sale orders by:
defining a price plan from a library of different price plans, said price plans being applied to a customer segment during a specific period of application;
defining pricing methods for said price plan from a library of pricing methods, a pricing method corresponding to a predetermined pricing formula involving price variables;
finding a reference sales cube representing a multidimensional aggregate of invoice lines per said customer and a product or service;
disaggregating a user defined sales profile using said reference sales cube;
applying a pricing formula utilizing said price variables for each cell of said sales cube; and
aggregating revenues across cells of said sales cube to obtain said expected revenue and an average price.

54. The system of claim 30, wherein said CCRM optimizer is operable to compute an incremental cost by:
defining different cost categories;
defining different cost types for each cost category;
defining different cost models comprising different periods of application, each cost model being defined at an offer level for a crossing of 0 to n sales profiles corresponding to registered sales cubes, and a cost model for a given cost type being related to one cost variable calculated for said sales cubes and being composed of a multiplier parameter applicable to said one cost variable;
finding a reference sales cube;
disaggregating a sales profile using said reference sales cube;
applying a costing formula utilizing cost variables for each cell of said sales cube; and
aggregating costs found across cells of said sales cube for said different cost types to obtain said incremental cost.

55. The system of claim 23, further comprising a CCRM database; and
wherein said CCRM optimizer is operable to compute and store said sales cubes in said CCRM database by:
configuring said sales cubes as crossings or elementary tree data structures referred to as sales profiles comprising nodes corresponding to categories of invoice line attributes, actual sales cubes being populated by an aggregation of invoice lines, and each cell of said sales cube containing aggregates of price variables and cost variables for different periods;
computing aggregates said price variable used in a formulation of said price and cost variables used in said costing models for each cell in said sales cube and cells corresponding to a crossing of upper nodes of related sales profiles; and
storing said cost and price variables in a sales cube table arranged by customer for each customer with sales activity during a period of time.

56. The system of claim 55, wherein said CCRM optimizer is operable to compares said actual sales cubes to negotiated sales cubes and to generate compliance alerts when actual values differ from expected values.

57. The system of claim 30, wherein said CCRM optimizer is operable to monitor sales by comparing initial orders with actual sale invoices in terms of quantities of product sold, revenue, or sales cubes in a batch mode with a frequency defined by an analyst.

58. The system of claim 32, wherein said CCRM optimizer is operable to:
compute realization rates for an offer category, offer and customer segment by processing actual sales activity variables of each customer for a pre-defined period of time; and
generate compliance alerts when actual sales deviate from expected sales.
